(19) United States
(12) Patent Application Publication
(10) Pub. No.: US 2024/0428970 A1
(43) Pub. Date: Dec. 26, 2024

(54) SYSTEM AND METHOD OF FLUX BIAS FOR SUPERCONDUCTING QUANTUM CIRCUITS

(71) Applicant: SeeQC, Inc., Elmsford, NY (US)

(72) Inventors: Alex F. Kirichenko, Pleasantville, NY (US); Amir Jafari-Salim, Monroe, NY (US); Patrick Truitt, Harrison, NY (US); Naveen Kumar Katam, Ossining (IN); Caleb Jordan, Peekskill, NY (US); Oleg A. Mukhanov, Putnam Valley, NY (US)

(21) Appl. No.: 18/829,112

(22) Filed: Sep. 9, 2024

Related U.S. Application Data
(63) Continuation of application No. 17/838,207, filed on Jun. 11, 2022, now Pat. No. 12,087,503.
(60) Provisional application No. 63/209,937, filed on Jun. 11, 2021.

(51) Int. Cl. H01F 6/00

(52) U.S. Cl. CPC H01F 6/006

(57) ABSTRACT

Quantum computing systems require methods to control energies of qubits and couplers for quantum operations. Flux biasing of qubits and quantum couplers is provided for a superconducting quantum computer using single-flux-quantum (SFQ) technology. This method is applicable to a wide range of superconducting qubit structures and couplers, including transmons, fluxoniums, flux qubits, phase qubits and other superconducting qubits. This method enables arbitrary-amplitude time-varying flux biasing of qubits and couplers, due to a sequence of high-speed SFQ pulses. Several preferred embodiments are disclosed which provide high-fidelity control of fast single-qubit and multi-qubit operations.

### CROSS REFERENCE TO RELATED APPLICATIONS

The present application is a Continuation of U.S. patent application Ser. No. 17/838,207, filed Jun. 11, 2022, now U.S. Pat. No. 12,087,503, issued Sep. 10, 2024, which is a non-provisional of and claims benefit of priority from U.S. Provisional Patent Application No. 62/209,937, filed Jun. 11, 2021, the entirety of which are expressly incorporated herein by reference.

### FIELD OF THE INVENTION

The present invention relates to the field of superconducting circuits, and more particularly superconducting circuits for application to quantum computing.

### BACKGROUND OF THE INVENTION

Each patent, patent publication, and other cited reference cited herein is expressly incorporated herein by reference in its entirety for all purposes.

Superconducting integrated circuits based on Josephson junctions (JJs) are capable of operation with very low power and high speed, well beyond those possible using conventional semiconducting circuits. It has long been known that superconducting integrated circuits may be used for digital logic circuits based on single-flux-quantum (SFQ) pulses. These SFQ pulses are voltage pulses with time-integrated voltage of Φ₀=h/2e=2.07 mV-ps, each comprising one fluxon of magnetic flux, corresponding typically to a pulse height about 1 mV and a pulse width about 2 ps. Several logic families based on SFQ pulses are known in the prior art, including Rapid Single Flux Quantum (RSFQ), Energy-Efficient RSFQ (EERSFQ), Reciprocal Quantum Logic (RQL), and Quantum Flux Parametron (QFP). Despite the word “quantum”, all of these logic families comprise classical digital computing with classical bits. See, for example, the following U.S. Pat. Nos. 8,571,614; 9,473,124; 9,853,645; 10,917,096; 10,528,886; 10,748,079; 7,969,178; 8,138,784; 9,646,682; 10,084,454.

Recently, superconducting integrated circuits comprised of a plurality of JJs have also been applied to true quantum computing using quantum bits (qubits), which may enable computations that are unachievable using classical computers. There are several types of superconducting qubits disclosed in the prior art, such as flux qubits, phase qubits, charge qubits, topological qubits, fluxonium qubits, and transmon qubits, among others. See, for example, US patent and Published Application Nos.: U.S. Pat. Nos. 6,459,097; 6,504,172; 6,576,951; 6,627,915; 6,784,451; 6,838,694; 6,984,846; 7,268,576; 7,335,909; 7,843,209; 8,648,331; 8,654,578; 9,524,470; 9,685,935; 10,068,184; 10,176,432; 10,255,557; 10,256,392; 10,622,998; 10,789,123; 10,840,295; 10,949,769; and 2020/0280316.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. A Hilbert space is an abstract vector space possessing the structure of an inner product that allows length and angle to be measured. Furthermore, Hilbert spaces are complete: there are enough limits in the space to allow the techniques of calculus to be used.

A quantum circuit may be specified as a sequence of quantum gates. The term “quantum gate,” may refer to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2ⁿ×2ⁿ complex matrix representing the same overall state change on n qubits. A quantum circuit may thus be expressed as a single resultant operator. However, designing a quantum circuit in terms of constituent gates allows the design to conform to a standard set of gates, and thus enable greater case of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Each superconducting qubit is characterized by a ground quantum state and an excited quantum state, separated by an energy E, such that E=hf. The transition between the ground and excited states is mediated by a narrowband microwave signal with frequency f that is typically of order 10 GHz. Such a microwave signal may have a shaped envelope with a width that may be of order 100 cycles, which may sometimes be referred to as a “microwave pulse”. However, such a “microwave pulse” is quite different from the SFQ pulse mentioned above, which has broadband spectral content up to hundreds of GHz. Most prior-art control systems are based on these narrowband microwave pulses; see U.S. Pat. Nos. 7,932,514; 8,294,138; 8,872,360; 10,572,816; and 10,650,319.

It is known in the prior art that any quantum computing system will require an interface with a classical computer for control and readout. In most of the prior art, the classical control computer may comprise a conventional semiconductor computer at room temperature, with control lines down to the cryogenic qubits. However, it may be advantageous to employ cryogenic control circuits close to the quantum computer, for at least the first stage of control of the quantum computer. Such a control system in close proximity to the quantum computer would reduce latency, enabling more rapid and flexible control of the quantum computer. Furthermore, superconducting quantum computing requires ultra-low temperatures about 0.01 K, typically using a helium dilution refrigerator, where the available cooling capacity is very small. A major heat load in a cryogenic computer comprises the set of input/output (I/O) lines, which would become impractically large for a quantum computer of a significant scale. Including a local source of classical control circuits could reduce the number of I/O lines, thus making a large-scale system more practical, provided that the dissipation of the cryogenic classical control circuits is also very small.

Some prior art discloses use of conventional semiconductor circuits at cryogenic temperatures to control the cryogenic qubits. See, for example, US patent and Published Application Nos: 10,671,559; 2020/0394548; and 2020/0160205. However, the power levels for semiconductor control circuits are generally far higher than is compatible with the deep cryogenic environment of the quantum computer.

One type of superconducting circuit that may be used to control superconducting qubits is an inductive circuit that applies magnetic flux, including circuits based on superconducting quantum interference devices or SQUIDs. See, for example, US patent and Published Application Nos: U.S. Pat. Nos. 7,847,615; 7,932,514; 8,854,074; 9,996,801; 10,665,635; 10,969,443; and 2021/0033683. These control methods are generally quite slow.

Although all superconducting logic circuits are low in dissipation, some variants are especially low in energy, such as those identified as ERSFQ, eSFQ, RQL, and QFP. These are based on SFQ pulses, which is quite different from the resonant narrowband microwave signal that is more commonly used. Such a circuit may be placed close to the superconducting qubits, given a common cryogenic environment and low-power dissipation. There have been several previous proposals for SFQ logic circuits to control or read out superconducting qubits. For example, a properly timed train of SFQ pulses may be used to induce a quantum transition in a superconducting qubit, or to measure the quantum state of a qubit. See, for example, U.S. Pat . Nos. 7.969.178; 8,138,784; 8,508,280; 9,425,804; 9,787,312; 10,726,351; and 10,748,079.

While SFQ pulses are themselves quite fast, the prior art does not teach methods for rapid, programmable SFQ control of over the very large number of qubits that will be needed for a practical quantum computer. In particular, the prior art does not teach methods to tune the parameters of the various qubits and the couplings between them, using SFQ circuits.

Quantum computers (QC), comprising qubits promise exponential speed-up in solving certain problems. A qubit can be implemented in a physical system with two distinct energy levels representing the |0) and |1) states, e.g., the up and down spin states of an electron. The qubit states can be manipulated with microwave pulses, whose frequency f matches the energy level spacing E=hf. Qubit operations can be represented as rotations in the Bloch sphere. The rotation axis is set by the phase of the microwave signal relative to the qubit phase, which must be tracked for coherent operations. The pulse amplitude and duration determine the rotation angle.

A singular value decomposition allows visualization of a two-qubit state through a pair of Bloch spheres, one per subsystem. The Bloch vectors u and v are inscribed in their respective spheres, representing 6 degrees of freedom detectable through local measurements. The 9 degrees of freedom that can only be detected nonlocally are contained in Σ, M, and N, or equivalently, in the two matrix products MΣ and NΣ. The columns of these two products are the scaled correlation axes, given by x_{i\hat{m}i} and x_{i\hat{n}i} respectively. To complete the geometric representation of the quantum state, the three scaled correlation axes for each system can be added to their respective Bloch sphere, where they represent the magnitude and direction of the correlation. The scaled correlation axes in the two systems are paired off by a shared index i.

Spin in the directions of two such axes with the same index are correlated, proportional to their shared length xᵢ, while spin along axes with different indices are uncorrelated. That is, simultaneously measuring the two spins on multiple copies of the system, each along the direction of its scaled correlation axis i, yields an expectation value equal to the axis length. Measuring the two spins simultaneously along correlation axes with different indices, i≠j, yields zero expectation value.

Quantum channels and operations are described by completely positive trace preserving maps, and lie at the heart of investigations in quantum information science. The single quantum bit (qubit) case has a particularly attractive geometric interpretation in terms of certain deformations of the Bloch sphere. This geometric picture to a large extent guides the intuition for higher-dimensional cases.

Viewing quantum operations as operators acting on operators leads to a clean geometric decomposition in the single qubit case; that is, completely positive trace preserving maps. Given an arbitrary 2×2 complex matrix, we can identify eight degrees of freedom through the real and imaginary parts of the four entries for example. In the case of Hermitian matrices, these eight degrees of freedom are reduced to four, as specification of any one of the off-diagonal terms fixes one of the others and each of the diagonal terms must be real. As a result, a linear map from 2×2 Hermitian matrices to 2×2 Hermitian matrices can be completely characterized by sixteen parameters. It is easily verified that any Hermitian matrix can be written as a linear combination of the identity and the three Pauli matrices, with real coefficients. Thus we can express any Hermitian 2×2 matrix as a 4-component real vector in the Pauli basis, {1, σx, σy, σz}, and we can express a linear map on the 2×2 Hermitian matrices as a 4×4 real matrix in the same basis.

Shifting attention to a subset of the 2×2 Hermitian matrices, namely density matrices for a single qubit, we add the conditions that the matrices must be positive and have trace equal to one. The trace condition forces the coefficient of the identity to be ½, reducing the characterization to a 3-dimensional real subspace. Positivity then tells us that all density matrices are represented by points within a radius of ½ from the origin in this 3-dimensional real subspace. Using the standard convention that ½ is factored out of each component, we have the familiar Bloch vector representation of a density matrix, wherein the set of permissible density matrices are represented by the ball Irl²≤1, the Bloch sphere. When considering density matrices and quantum operations thereon, we can further refine the form of our linear map since a quantum operation will be described by a completely positive trace-preserving map. (Equivalently, the Hilbert-Schmidt dual of the map is completely positive and unital.)

We can therefore characterize the effect of an arbitrary completely positive trace-preserving map on the Bloch sphere as the composition of a rotation with a possible inversion, a compression to an ellipsoid, a second rotation with a possible inversion, and a translation.

See:

Abrams, Deanna M., Nicolas Didier, Blake R. Johnson, Marcus P. da Silva, and Colm A. Ryan. “Implementation of the XY interaction family with calibration of a single pulse.” arXiv preprint arXiv: 1912.04424 (2019).

Abrams, Deanna M., Nicolas Didier, Shane A. Caldwell, Blake R. Johnson, and Colm A. Ryan. “Methods for measuring magnetic flux crosstalk between tunable transmons.” Physical Review Applied 12, no. 6 (2019): 064022.

Ahmad, Meraj, Christos Giagkoulovits, Sergey Danilin, Martin Weides, and Hadi Heidari. “Scalable Cryoelectronics for Superconducting Qubit Control and Readout.” Advanced Intelligent Systems (2022): 2200079.

Antonov, I. V., R. S. Shaikhaidarov, V. N. Antonov, and O. V. Astafiev. “Superconducting ‘twin’ qubit.” Physical Review B 102, no. 11 (2020): 115422.

Ash-Saki, Abdullah, Mahabubul Alam, and Swaroop Ghosh. “Experimental characterization, modeling, and analysis of crosstalk in a quantum computer.” IEEE Transactions on Quantum Engineering 1 (2020): 1-6.

Bækkegaard, Thomas, L. B. Kristensen, Niels JS Loft, Christian Kraglund Andersen, David Petrosyan, and Nikolaj T. Zinner. “Realization of efficient quantum gates with a superconducting qubit-qutrit circuit.” Scientific reports 9, no. 1 (2019): 1-10.

Bardin, Joseph C. “Analog/Mixed-Signal Integrated Circuits for Quantum Computing.” In 2020 IEEE BiCMOS and Compound Semiconductor Integrated Circuits and Technology Symposium (BCICTS), pp. 1-8. IEEE, 2020.

Bardin, Joseph C., Daniel Sank, Ofer Naaman, and Evan Jeffrey. “Quantum computing: An introduction for microwave engineers.” IEEE Microwave Magazine 21, no. 8 (2020): 24-44.

Bardin, Joseph C., Evan Jeffrey, Erik Lucero, Trent Huang, Ofer Naaman, Rami Barends, Ted White et al. “29.1 A 28 nm bulk-CMOS 4-to-8 GHz; 2 mW cryogenic pulse modulator for scalable quantum computing.” In 2019 IEEE International Solid-State Circuits Conference-(ISSCC), pp. 456-458. IEEE, 2019.

Barends, Rami, C. M. Quintana, A. G. Petukhov, Yu Chen, Dvir Kafri, Kostyantyn Kechedzhi, Roberto Collins et al. “Diabatic gates for frequency-tunable superconducting qubits.” Physical Review Letters 123, no. 21 (2019): 210501.

Berke, Christoph, Evangelos Varvelis, Simon Trebst, Alexander Altland, and David P. DiVincenzo. “Transmon platform for quantum computing challenged by chaotic fluctuations.” arXiv preprint arXiv: 2012.05923 (2020).

Besedin, Il′ya Stanislavovich, Gleb Petrovich Fedorov, A. Yu Dmitriev, and Valerii Vladimirovich Ryazanov. “Superconducting qubits in Russia.” Quantum Electronics 48, no. 10 (2018): 880.

Bhattacharyya, Shaman, and Somnath Bhattacharyya. “Demonstrating geometric phase acquisition in multi-path tunnel systems using a near-term quantum computer.” Journal of Applied Physics 130, no. 3 (2021): 034901.

Bocko, Mark F., Andrea M. Herr, and Marc J. Feldman. “Prospects for quantum coherent computation using superconducting electronics.” IEEE Transactions on Applied Superconductivity 7, no. 2 (1997): 3638-3641.

Brink, Markus, Jerry M. Chow, Jared Hertzberg, Easwar Magesan, and Sami Rosenblatt. “Device challenges for near term superconducting quantum processors: frequency collisions.” In 2018 IEEE International Electron Devices Meeting (IEDM), pp. 6-1. IEEE, 2018.

Cai, T-Q., X-Y. Han, Y-K. Wu, Y-L. Ma, J-H. Wang, Z-L. Wang, H-Y. Zhang, H-Y. Wang, Y-P. Song, and L-M. Duan. “Impact of Spectators on a Two-Qubit Gate in a Tunable Coupling Superconducting Circuit.” Physical Review Letters 127, no. 6 (2021): 060505.

Caldwell, S. A., N. Didier, C. A. Ryan, E. A. Sete, A. Hudson, P. Karalekas, R. Manenti et al. “Parametrically activated entangling gates using transmon qubits.” Physical Review Applied 10, no. 3 (2018): 034050.

Castellano, Maria Gabriella, Leif Grönberg, Pasquale Carelli, Fabio Chiarello, Carlo Cosmelli, Roberto Leoni, Stefano Poletto, Guido Torrioli, Juha Hassel, and Panu Helistö. “Characterization of a fabrication process for the integration of superconducting qubits and rapid-single-flux-quantum circuits.” Superconductor Science and Technology 19, no. 8 (2006): 860.

Christensen, B. G., C. D. Wilen, A. Opremcak, J. Nelson, F. Schlenker, C. H. Zimonick, L. Faoro et al. “Anomalous charge noise in superconducting qubits.” Physical Review B 100, no. 14 (2019): 140503.

Coffey, Mark W. “Quantum computing based on a superconducting quantum interference device: Exploiting the flux basis.” Journal of Modern Optics 49, no. 14-15 (2002): 2389-2398.

Crankshaw, Donald Shane. “Measurement and on-chip control of a niobium persistent current qubit.” PhD diss., Massachusetts Institute of Technology, 2003.

de Albornoz, Alejandro Cros Carrillo, John Taylor, and Vlad Cărare. “Time-optimal implementations of quantum algorithms.” Physical Review A 100, no. 3 (2019): 032329.

Dragoman, Mircea, and Daniela Dragoman. “Quantum Computing.” In Atomic-Scale Electronics Beyond CMOS, pp. 157-186. Springer, Cham, 2021.

Espinós, Hilario, Iván Panadero, Juan José García-Ripoll, and Erik Torrontegui. “Quantum control of tunable-coupling transmons using dynamical invariants of motion.” arXiv preprint arXiv: 2205.06555 (2022).

Fedorov, Kirill G., Anastasia V. Shcherbakova, Michael J. Wolf, Detlef Beckmann, and Alexey V. Ustinov. “Fluxon readout of a superconducting qubit.” Physical review letters 112, no. 16 (2014): 160502.

Feng, Guanru, Shi-Yao Hou, Hongyang Zou, Wei Shi, Sheng Yu, Zikai Sheng, Xin Rao et al. “SpinQ Triangulum: a commercial three-qubit desktop quantum computer.” arXiv preprint arXiv: 2202.02983 (2022).

Foss-Feig, Michael, Stephen Ragole, Andrew Potter, Joan Dreiling, Caroline Figgatt, John Gaebler, Alex Hall et al. “Entanglement from Tensor Networks on a Trapped-Ion Quantum Computer.” Physical Review Letters 128, no. 15 (2022): 150504.

Ganzhorn, Marc, Daniel J. Egger, Panagiotis Barkoutsos, Pauline Ollitrault, Gian Salis, Nikolaj Moll, M. Roth et al. “Gate-efficient simulation of molecular eigenstates on a quantum computer.” Physical Review Applied 11, no. 4 (2019): 044092.

García-Ripoll, J. J., A. Ruiz-Chamorro, and E. Torrontegui. “Quantum control of transmon superconducting qubits.” arXiv preprint arXiv: 2002.10320 (2020).

García-Ripoll, Juan José, Andrés Ruiz-Chamorro, and E. Torrontegui. “Quantum Control of Frequency-Tunable Transmon Superconducting Qubits.” Physical Review Applied 14, no. 4 (2020): 044035.

Graham, T. M., Y. Song, J. Scott, C. Poole, L. Phuttitarn, K. Jooya, P. Eichler et al. “Multi-qubit entanglement and algorithms on a neutral-atom quantum computer.” Nature 604, no. 7906 (2022): 457-462.

Graham, T. M., Y. Song, J. Scott, C. Poole, L. Phuttitarn, K. Jooya, P. Eichler et al. “Demonstration of multi-qubit entanglement and algorithms on a programmable neutral atom quantum computer.” arXiv preprint arXiv: 2112.14589 (2021).

Hahn, Henning, Giorgio Zarantonello, Marius Schulte, Amado Bautista-Salvador, Klemens Hammerer, and Christian Ospelkaus. “Integrated 9Be+multi-qubit gate device for the ion-trap quantum computer.” npj Quantum Information 5, no. 1 (2019): 1-5.

Hill, Charles D., Muhammad Usman, and Lloyd CL Hollenberg. “An exchange-based surface-code quantum computer architecture in silicon.” arXiv preprint arXiv: 2107.11981 (2021).

Hou, Shi-Yao, Guanru Feng, Zipeng Wu, Hongyang Zou, Wei Shi, Jinfeng Zeng, Chenfeng Cao et al. “SpinQ Gemini: a desktop quantum computer for education and research.” arXiv preprint arXiv: 2101.10017 (2021).

Huang, Ziwen, Yao Lu, Eliot Kapit, David I. Schuster, and Jens Koch. “Universal stabilization of single-qubit states using a tunable coupler.” Physical Review A 97, no. 6 (2018): 062345.

Humble, Travis S., Himanshu Thapliyal, Edgard Munoz-Coreas, Fahd A. Mohiyaddin, and Ryan S. Bennink. “Quantum computing circuits and devices.” IEEE Design & Test 36, no. 3 (2019): 69-94.

Hutchings, M. D., Jared B. Hertzberg, Yebin Liu, Nicholas T. Bronn, George A. Keefe, Markus Brink, Jerry M. Chow, and B. L. T. Plourde. “Tunable superconducting qubits with flux-independent coherence.” Physical Review Applied 8, no. 4 (2017): 044003.

Johnson, Philip R., Frederick W. Strauch, Alex J. Dragt, James R. Anderson, Christopher J. Lobb, and Frederick C. Wellstood. “Quantum control of superconducting phase qubits.” In Quantum Information and Computation II, vol. 5436, pp. 232-241. International Society for Optics and Photonics, 2004.

Khabipov, M. I., D. V. Balashov, F. Maibaum, A. B. Zorin, V. A. Oboznov, V. V. Bolginov, A. N. Rossolenko, and V. V. Ryazanov. “A single flux quantum circuit with a ferromagnet-based Josephson x-junction.” Superconductor Science and Technology 23, no. 4 (2010): 045032.

Klenov, N. V., A. V. Kuznetsov, I. I. Soloviev, S. V. Bakurskiy, M. V. Denisenko, and A. M. Satanin. “Flux qubit interaction with rapid single-flux quantum logic circuits: Control and readout.” Low Temperature Physics 43, no. 7 (2017): 789-798.

Krantz, Philip, Morten Kjaergaard, Fei Yan, Terry P. Orlando, Simon Gustavsson, and William D. Oliver. “A quantum engineer's guide to superconducting qubits.” Applied Physics Reviews 6, no. 2 (2019): 021318.

Landig, Andreas J., Jonne V. Koski, Pasquale Scarlino, Clemens Müller, José C. Abadillo-Uriel, Benedikt Kratochwil, Christian Reichl et al. “Virtual-photon-mediated spin-qubit-transmon coupling.” Nature communications 10, no. 1 (2019): 1-7.

Larsen, Thorvald Wadum, Karl David Petersson, Ferdinand Kuemmeth, Thomas Sand Jespersen, Peter Krogstrup, Jesper Nygård, and Charles M. Marcus. “Semiconductor-nanowire-based superconducting qubit.” Physical review letters 115, no. 12 (2015): 127001.

Leonard Jr, Edward, Matthew A. Beck, J. Nelson, Brad G. Christensen, Ted Thorbeck, Caleb Howington, Alexander Opremcak et al. “Digital coherent control of a superconducting qubit.” Physical Review Applied 11, no. 1 (2019): 014009.

Li, Kangbo, R. McDermott, and Maxim G. Vavilov. “Hardware-efficient qubit control with single-flux-quantum pulse sequences.” Physical Review Applied 12, no. 1 (2019): 014044.

Liebermann, Per J., and Frank K. Wilhelm. “Optimal qubit control using single-flux quantum pulses.” Physical Review Applied 6, no. 2 (2016): 024022.

Lu, Yao, Srivatsan Chakram, Ngainam Leung, Nathan Earnest, Ravi K. Naik, Ziwen Huang, Peter Groszkowski, Eliot Kapit, Jens Koch, and David I. Schuster. “Universal stabilization of a parametrically coupled qubit.” Physical review letters 119, no. 15 (2017): 150502.

Machnes, Shai, Elie Assemat, David Tannor, and Frank K. Wilhelm. “Tunable, flexible, and efficient optimization of control pulses for practical qubits.” Physical review letters 120, no. 15 (2018): 150401.

Mališ, Momir, P. KI Barkoutsos, Marc Ganzhorn, Stefan Filipp, Daniel J. Egger, Sara Bonella, and Ivano Tavernelli. “Local control theory for superconducting qubits.” Physical Review A 99, no. 5 (2019): 052316. Marques, J. F., B. M. Varbanov, M. S. Moreira, Hany Ali, Nandini Muthusubramanian, Christos Zachariadis, Francesco Battistel et al. “Logical-qubit operations in an error-detecting surface code.” Nature Physics 18, no. 1 (2022): 80-86.

McConkey, T. G., J. H. Béjanin, C. T. Earnest, C. R. H. McRae, Z. Pagel, J. R. Rinehart, and M. Mariantoni. “Mitigating leakage errors due to cavity modes in a superconducting quantum computer.” Quantum Science and Technology 3, no. 3 (2018): 034004.

McDermott, R., and M. G. Vavilov. “Accurate qubit control with single flux quantum pulses.” Physical Review Applied 2, no. 1 (2014): 014007.

McDermott, R., M. G. Vavilov, B. L. T. Plourde, F. K. Wilhelm, P. J. Liebermann, O. A. Mukhanov, and T. A. Ohki. “Quantum-classical interface based on single flux quantum digital logic.” Quantum science and technology 3, no. 2 (2018): 024004.

McKay, David C., Christopher J. Wood, Sarah Sheldon, Jerry M. Chow, and Jay M. Gambetta. “Efficient Z gates for quantum computing.” Physical Review A 96, no. 2 (2017): 022330.

Mukhanov, Oleg A, A. Kirichenko, C. Howington, J. Walter, M. Hutchings, I. Vernik, D. Yohannes, K. Dodge, A. Ballard, B. L.T. Plourde, A. Opremcak, C.-H. Liu, R. McDermott, “Scalable Quantum Computing Infrastructure Based on Superconducting Electronics,” 2019 IEEE International Electron Devices Meeting (IEDM), San Francisco, CA, USA (2019): 31.2.1-31.2.4.

Mukhanov, Oleg A. “Energy-efficient single flux quantum technology.” IEEE Transactions on Applied Superconductivity 21, no. 3 (2011): 760-769.

Mundada, Pranav, Gengyan Zhang, Thomas Hazard, and Andrew Houck. “Suppression of qubit crosstalk in a tunable coupling superconducting circuit.” Physical Review Applied 12, no. 5 (2019): 054023.

Murch, K. W., S. J. Weber, Christopher Macklin, and Irfan Siddiqi. “Observing single quantum trajectories of a superconducting quantum bit.” Nature 502, no. 7470 (2013): 211-214.

Negîrneac, V., H. Ali, N. Muthusubramanian, F. Battistel, R. Sagastizabal, M. S. Moreira, J. F. Marques, W. J. Vlothuizen, M. Beekman, C. Zachariadis, N. Haider, A. Bruno, and L. DiCarlo, “High-fidelity controlled-Z gate with maximal intermediate leakage operating at the speed limit in a superconducting quantum processor,” Phys. Rev. Letters 126 (2021): 220502.

Nguyen, Long Bao. “Toward the Fluxonium Quantum Processor.” PhD diss., University of Maryland, College Park, 2020.

Niskanen, A. O., K. Harrabi, F. Yoshihara, Y. Nakamura, S. Lloyd, and Jaw Shen Tsai. “Quantum coherent tunable coupling of superconducting qubits.” Science 316, no. 5825 (2007): 723-726.

Ohki, Thomas A., Michael Wulf, and Marc J. Feldman. “Low-Jc rapid single flux quantum (RSFQ) qubit control circuit.” IEEE transactions on applied superconductivity 17, no. 2 (2007): 154-157.

Patra, Bishnu, Jeroen PG van Dijk, Sushil Subramanian, Andrea Corna, Xiao Xue, Charles Jeon, Farhana Sheikh et al. “19.1 a scalable cryo-CMOS 2-to-20 GHz digitally intensive controller for 4×32 frequency multiplexed spin qubits/transmons in 22 nm FinFET technology for quantum computers.” In 2020 IEEE International Solid-State Circuits Conference-(ISSCC), pp. 304-306. IEEE, 2020.

Pezzagna, Sébastien, and Jan Meijer. “Quantum computer based on color centers in diamond.” Applied Physics Reviews 8, no. 1 (2021): 011308.

Rol, M. A., F. Battistel, F. K. Malinowski, C. C. Bultink, B. M. Tarasinski, R. Vollmer, N. Haider et al. “A fast, low-leakage, high-fidelity two-qubit gate for a programmable superconducting quantum computer.” arXiv preprint arXiv: 1903.02492 (2019).

Schrade, Constantin, and Liang Fu. “Majorana superconducting qubit.” Physical Review Letters 121, no. 26 (2018): 267002.

Sete, Eyob A., Matthew J. Reagor, Nicolas Didier, and Chad T. Rigetti. “Charge-and flux-insensitive tunable superconducting qubit.” Physical Review Applied 8, no. 2 (2017): 024004.

Sheldon, Sarah, Easwar Magesan, Jerry M. Chow, and Jay M. Gambetta. “Procedure for systematically tuning up cross-talk in the cross-resonance gate.” Physical Review A 93, no. 6 (2016): 060302.

Sirois, Adam, Manuel Castellanos-Beltran, Anna Fox, Samuel Benz, and Peter Hopkins. “Josephson Microwave Sources Applied to Quantum Information Systems.” IEEE Transactions on Quantum Engineering (2020).

Song, Chao, Kai Xu, Hekang Li, Yu-Ran Zhang, Xu Zhang, Wuxin Liu, Qiujiang Guo et al. “Generation of multicomponent atomic Schrödinger cat states of up to 20 qubits.” Science 365, no. 6453 (2019): 574-577.

Stassi, Roberto, Mauro Cirio, and Franco Nori. “Scalable quantum computer with superconducting circuits in the ultrastrong coupling regime.” npj Quantum Information 6, no. 1 (2020): 1-6.

Stenger, John, Gilad Ben-Shach, David Pekker, and Nicholas T. Bronn. “Simulating spectroscopic detection of Majorana zero modes with a superconducting quantum computer.” arXiv preprint arXiv: 2202.12910 (2022).

Uilhoorn, Willemijntje. “Hybrid Josephson junction-based quantum devices in magnetic field.” (2021).

Versluis, Richard, Stefano Poletto, Nader Khammassi, Brian Tarasinski, Nadia Haider, David J. Michalak, Alessandro Bruno, Koen Bertels, and Leonardo DiCarlo. “Scalable quantum circuit and control for a superconducting surface code.” Physical Review Applied 8, no. 3 (2017): 034021.

Wang, Joel, Daniel Rodan Legrain, Charlotte Boettcher, Landry Bretheau, Daniel Campbell, Bharath Kannan, David Kim et al. “Quantum coherent control of graphene-based transmon qubit.” In APS March Meeting Abstracts, vol. 2019, pp. C29-010. 2019.

Wendin, Göran. “Quantum information processing with superconducting circuits: a review.” Reports on Progress in Physics 80, no. 10 (2017): 106001.

Xin, Tao, Shilin Huang, Sirui Lu, Keren Li, Zhihuang Luo, Zhangqi Yin, Jun Li, Dawei Lu, Guilu Long, and Bei Zeng. “NMRCloudQ: a quantum cloud experience on a nuclear magnetic resonance quantum computer.” Science Bulletin 63, no. 1 (2018): 17-23.

Yamanashi, Yuki, Takanobu Nishigai, and Nobuyuki Yoshikawa. “Study of LR-loading technique for low-power single flux quantum circuits.” IEEE Transactions on applied superconductivity 17, no. 2 (2007): 150-153.

Yoshikawa, Nobuyuki. “Superconducting digital electronics for controlling quantum computing systems.” IEICE Transactions on Electronics 102, no. 3 (2019): 217-223.

Zhang, Helin, Srivatsan Chakram, Tanay Roy, Nathan Earnest, Yao Lu, Ziwen Huang, Daniel Weiss, Jens Koch, and David I. Schuster, “Universal fast flux control of a coherent, low-frequency qubit,” Phys. Rev. X 11 (2021): 011010.

Zhang, Xian-Peng, Li-Tuo Shen, Zhang-Qi Yin, Luyan Sun, Huai-Zhi Wu, and Zhen-Biao Yang. “Multi-Resonator-Assisted Multi-Qubit Resetting in a Network.” arXiv preprint arXiv: 1604.08393 (2016).

Zhou, Jian, Sai Li, Guo-Zhu Pan, Gang Zhang, Tao Chen, and Zheng-Yuan Xuc. “Nonadiabatic geometric quantum gates that are insensitive to qubit-frequency drifts.” Physical Review A 103, no. 3 (2021): 032609.

Zhu, Daoquan, Tuomas Jaako, Qiongyi He, and Peter Rabl. “Quantum computing with superconducting circuits in the picosecond regime.” arXiv preprint arXiv: 2101.05810 (2021).

See, U.S. patent and Published patent Application Nos.: U.S. Pat. Nos. 5,170,080; 5,233,242; 5,233,243; 5,289,400; 5,388,068; 5,389,837; 5,598,105; 5,629,889; 5,781,009; 5,793,055; 5,818,373; 5,936,458; 5,963,351; 5,982,219; 6,023,161; 6,175,749; 6,188,236; 6,217,165; 6,242,939; 6,315,200; 6,317,192; 6,331,805; 6,345,189; 6,345,190; 6,353,330; 6,356,715; 6,362,868; 6,362,869; 6,415,054; 6,431,669; 6,442,525; 6,459,097; 6,459,495; 6,476,863; 6,479,139; 6,486,694; 6,495,854; 6,504,172; 6,507,234; 6,509,853; 6,518,786; 6,526,491; 6,537,847; 6,542,645; 6,563,310; 6,563,311; 6,573,202; 6,576,951; 6,580,102; 6,605,822; 6,608,581; 6,614,047; 6,626,995; 6,627,915; 6,627,916; 6,630,426; 6,636,216; 6,649,929; 6,665,454; 6,670,630; 6,703,857; 6,724,216; 6,725,248; 6,728,131; 6,734,699; 6,750,901; 6,750,944; 6,753,546; 6,756,925; 6,773,836; 6,781,435; 6,784,451; 6,786,420; 6,788,336; 6,791,109; 6,797,341; 6,803,599; 6,809,734; 6,812,484; 6,813,056; 6,822,255; 6,826,662; 6,831,681; 6,838,694; 6,838,749; 6,850,274; 6,865,639; 6,879,341; 6,885,325; 6,897,468; 6,900,454; 6,900,456; 6,905,887; 6,909,109; 6,911,664; 6,917,537; 6,918,542; 6,919,579; 6,926,921; 6,930,318; 6,930,320; 6,936,841; 6,943,368; 6,946,428; 6,948,661; 6,960,780; 6,979,836; 6,984,846; 6,987,282; 7,002,174; 7,007,852; 7,015,499; 7,018,852; 7,042,005; 7,050,143; 7,073,713; 7,078,694; 7,083,108; 7,089,099; 7,090,889; 7,092,011; 7,093,104; 7,095,227; 7,097,104; 7,100,834; 7,103,460; 7,110,139; 7,113,967; 7,124,259; 7,129,870; 7,135,701; 7,139,882; 7,155,395; 7,187,404; 7,201,319; 7,230,266; 7,231,500; 7,233,421; 7,233,998; 7,234,645; 7,236,998; 7,253,654; 7,268,576; 7,268,713; 7,280,623; 7,283,162; 7,287,702; 7,289,142; 7,289,156; 7,304,646; 7,307,275; 7,313,199; 7,313,467; 7,321,958; 7,332,738; 7,335,909; 7,360,102; 7,362,125; 7,362,971; 7,364,923; 7,365,663; 7,373,083; 7,377,706; 7,379,800; 7,386,687; 7,389,508; 7,391,435; 7,392,511; 7,395,411; 7,408,453; 7,409,570; 7,415,703; 7,418,283; 7,428,562; 7,428,619; 7,437,536; 7,439,208; 7,440,490; 7,443,719; 7,444,210; 7,444,525; 7,444,632; 7,453,492; 7,456,861; 7,457,939; 7,460,152; 7,461,931; 7,467,034; 7,468,630; 7,475,257; 7,475,825; 7,478,390; 7,483,050; 7,496,673; 7,496,917; 7,498,832; 7,502,928; 7,505,310; 7,508,230; 7,509,457; 7,511,744; 7,516,334; 7,516,456; 7,523,157; 7,524,045; 7,526,608; 7,527,288; 7,533,068; 7,546,405; 7,547,648; 7,549,145; 7,549,327; 7,550,759; 7,554,369; 7,559,472; 7,565,653; 7,570,075; 7,598,897; 7,602,423; 7,603,894; 7,605,600; 7,613,764; 7,613,765; 7,613,886; 7,614,053; 7,619,437; 7,624,088; 7,629,999; 7,630,802; 7,631,966; 7,639,035; 7,644,255; 7,650,210; 7,653,908; 7,654,626; 7,672,756; 7,676,683; 7,680,474; 7,680,972; 7,685,601; 7,687,938; 7,689,068; 7,689,783; 7,689,784; 7,689,814; 7,693,053; 7,693,626; 7,694,306; 7,698,473; 7,701,286; 7,701,506; 7,707,385; 7,714,605; 7,719,453; 7,720,982; 7,724,020; 7,724,083; 7,728,748; 7,730,456; 7,732,804; 7,733,253; 7,748,006; 7,749,922; 7,750,664; 7,760,080; 7,768,287; 7,772,871; 7,774,512; 7,782,077; 7,786,748; 7,786,786; 7,786,864; 7,788,192; 7,788,467; 7,800,395; 7,802,023; 7,805,756; 7,814,166; 7,816,940; 7,818,507; 7,818,724; 7,826,088; 7,829,377; 7,837,115; 7,843,209; 7,844,656; 7,847,615; 7,852,106; 7,858,966; 7,863,892; 7,868,645; 7,870,087; 7,875,876; 7,876,145; 7,876,248; 7,876,869; 7,877,333; 7,880,529; 7,880,594; 7,882,310; 7,882,379; 7,886,112; 7,889,096; 7,889,992; 7,893,708; 7,898,282; 7,899,852; 7,903,456; 7,911,265; 7,912,656; 7,917,667; 7,917,798; 7,920,102; 7,921,151; 7,924,313; 7,926,023; 7,928,875; 7,931,200; 7,932,514; 7,932,515; 7,936,395; 7,942,332; 7,944,253; 7,956,640; 7,958,371; 7,969,178; 7,969,805; 7,977,668; 7,982,646; 7,984,012; 7,984,965; 7,990,662; 7,991,013; 7,991,814; 7,999,813; 8,001,294; 8,001,377; 8,001,390; 8,001,592; 8,008,942; 8,008,991; 8,010,716; 8,018,244; 8,022,012; 8,024,084; 8,028,288; 8,028,292; 8,032,474; 8,035,540; 8,045,660; 8,050,648; 8,055,235; 8,055,318; 8,063,657; 8,068,151; 8,068,741; 8,073,808; 8,077,207; 8,089,286; 8,091,078; 8,098,179; 8,108,564; 8,130,880; 8,138,784; 8,138,880; 8,148,715; 8,159,313; 8,159,825; 8,169,231; 8,169,311; 8,175,995; 8,176,481; 8,179,133; 8,188,901; 8,190,548; 8,195,596; 8,195,726; 8,208,288; 8,219,871; 8,219,981; 8,224,639; 8,228,688; 8,234,103; 8,244,650; 8,244,662; 8,247,799; 8,249,540; 8,260,143; 8,260,144; 8,260,145; 8,271,805; 8,283,943; 8,284,585; 8,290,553; 8,291,485; 8,294,138; 8,301,104; 8,301,214; 8,312,529; 8,315,969; 8,321,866; 8,328,101; 8,332,924; 8,401,509; 8,401,600; 8,405,468; 8,416,109; 8,434,091; 8,437,168; 8,437,818; 8,441,329; 8,462,889; 8,494,993; 8,504,497; 8,508,280; 8,514,986; 8,521,117; 8,547,732; 8,549,521; 8,555,370; 8,565,345; 8,571,614; 8,582,687; 8,593,141; 8,604,944; 8,611,974; 8,618,799; 8,619,242; 8,627,444; 8,654,578; 8,655,828; 8,670,807; 8,686,751; 8,726,041; 8,735,964; 8,738,105; 8,744,541; 8,745,850; 8,748,196; 8,751,212; 8,755,220; 8,766,630; 8,769,495; 8,772,759; 8,786,476; 8,787,873; 8,804,358; 8,811,536; 8,812,066; 8,841,764; 8,854,074; 8,861,619; 8,867,931; 8,872,360; 8,872,690; 8,874,629; 8,892,857; 8,922,239; 8,928,391; 8,933,695; 8,936,196; 8,937,255; 8,951,808; 8,970,217; 8,971,977; 8,975,912; 8,977,223; 8,977,576; 8,986,646; 9,015,215; 9,020,079; 9,020,362; 9,021,011; 9,026,574; 9,040,959; 9,041,427; 9,058,164; 9,059,674; 9,059,707; 9,065,452; 9,069,928; 9,072,894; 9,077,577; 9,129,224; 9,130,116; 9,134,047; 9,152,923; 9,152,924; 9,160,593; 9,162,881; 9,170,278; 9,178,154; 9,183,051; 9,183,508; 9,192,085; 9,203,654; 9,207,672; 9,208,446; 9,218,567; 9,235,811; 9,240,773; 9,252,825; 9,252,986; 9,256,834; 9,261,573; 9,270,385; 9,275,011; 9,276,615; 9,312,878; 9,312,895; 9,331,875; 9,335,385; 9,344,069; 9,344,092; 9,350,460; 9,355,364; 9,355,365; 9,361,169; 9,369,133; 9,379,303; 9,384,827; 9,385,293; 9,385,294; 9,396,440; 9,400,499; 9,401,823; 9,405,876; 9,406,026; 9,412,074; 9,424,526; 9,425,377; 9,425,804; 9,425,838; 9,432,024; 9,437,800; 9,438,246; 9,455,391; 9,460,397; 9,461,588; 9,471,880; 9,473,124; 9,476,950; 9,490,296; 9,495,644; 9,501,747; 9,501,748; 9,503,063; 9,503,258; 9,509,274; 9,509,315; 9,514,415; 9,520,180; 9,524,470; 9,531,671; 9,537,575; 9,547,826; 9,548,878; 9,552,862; 9,554,303; 9,559,284; 9,565,045; 9,577,690; 9,588,191; 9,588,940; 9,594,726; 9,595,969; 9,607,270; 9,614,532; 9,618,591; 9,627,045; 9,633,314; 9,641,372; 9,647,194; 9,647,662; 9,661,596; 9,663,358; 9,665,539; 9,680,452; 9,685,935; 9,686,112; 9,692,423; 9,697,473; 9,699,266; 9,703,516; 9,710,586; 9,710,758; 9,712,238; 9,727,527; 9,727,823; 9,727,824; 9,735,776; 9,741,918; 9,741,920; 9,742,429; 9,747,968; 9,748,937; 9,748,976; 9,753,102; 9,755,133; 9,761,305; 9,768,371; 9,768,771; 9,779,360; 9,780,765; 9,787,312; 9,793,913; 9,793,933; 9,806,711; 9,812,836; 9,818,064; 9,836,699; 9,838,051; 9,853,645; 9,859,981; 9,865,648; 9,870,277; 9,875,215; 9,875,444; 9,881,256; 9,882,112; 9,887,000; 9,892,365; 9,906,191; 9,906,248; 9,909,460; 9,917,580; 9,922,289; 9,928,948; 9,929,978; 9,935,252; 9,940,586; 9,948,254; 9,953,268; 9,953,269; 9,966,720; 9,971,970; 9,978,020; 9,978,809; 9,982,935; 9,984,333; 9,991,864; 9,996,801; 9,998,122; 9,998,187; 10,002,107; 10,013,657; 10,014,859; 10,020,438; 10,031,887; 10,037,493; 10,042,805; 10,044,638; 10,050,630; 10,051,591; 10,056,540; 10,056,908; 10,062,828; 10,062,829; 10,068,180; 10,068,181; 10,074,056; 10,074,792; 10,074,793; 10,097,186; 10,097,221; 10,097,281; 10,103,730; 10,108,071; 10,121,754; 10,122,350; 10,122,351; 10,127,500; 10,128,878; 10,133,984; 10,134,972; 10,140,248; 10,140,404; 10,141,493; 10,141,928; 10,147,865; 10,148,360; 10,157,842; 10,158,343; 10,164,606; 10,168,501; 10,169,714; 10,170,680; 10,170,681; 10,171,077; 10,171,086; 10,176,432; 10,177,297; 10,177,749; 10,187,065; 10,192,168; 10,193,729; 10,197,497; 10,199,553; 10,210,460; 10,222,416; 10,224,475; 10,229,355; 10,229,366; 10,230,038; 10,230,389; 10,230,558; 10,235,634; 10,235,635; 10,236,432; 10,236,869; 10,242,968; 10,243,132; 10,255,557; 10,256,206; 10,262,276; 10,262,727; 10,263,170; 10,268,622; 10,268,968; 10,275,422; 10,275,556; 10,275,718; 10,276,771; 10,276,772; 10,281,278; 10,282,675; 10,283,693; 10,283,694; 10,289,960; 10,290,798; 10,291,227; 10,304,004; 10,304,005; 10,305,015; 10,311,369; 10,318,880; 10,318,881; 10,319,896; 10,320,331; 10,320,383; 10,326,526; 10,332,023; 10,332,024; 10,333,046; 10,333,047; 10,333,048; 10,333,049; 10,333,503; 10,340,438; 10,345,678; 10,346,348; 10,346,349; 10,346,508; 10,346,760; 10,346,761; 10,348,245; 10,348,343; 10,352,992; 10,353,844; 10,354,198; 10,355,193; 10,355,677; 10,355,681; 10,366,340; 10,367,132; 10,367,133; 10,373,928; 10,374,612; 10,379,420; 10,380,494; 10,380,495; 10,380,496; 10,381,206; 10,381,541; 10,381,542; 10,382,132; 10,389,336; 10,396,269; 10,396,782; 10,396,801; 10,398,031; 10,403,808; 10,403,809; 10,404,214; 10,411,321; 10,411,804; 10,417,574; 10,418,540; 10,423,888; 10,424,711; 10,424,712; 10,424,713; 10,452,991; 10,453,894; 10,454,015; 10,454,016; 10,454,459; 10,460,796; 10,461,385; 10,467,543; 10,467,544; 10,467,545; 10,468,578; 10,468,740; 10,475,983; 10,482,388; 10,483,980; 10,488,469; 10,489,477; 10,490,600; 10,491,178; 10,491,221; 10,496,933; 10,496,934; 10,497,853; 10,502,802; 10,504,842; 10,505,097; 10,505,524; 10,509,084; 10,510,015; 10,510,943; 10,511,276; 10,516,486; 10,528,885; 10,528,886; 10,528,887; 10,529,003; 10,530,435; 10,535,013; 10,535,809; 10,540,603; 10,540,604; 10,541,659; 10,546,992; 10,546,993; 10,547,160; 10,552,755; 10,552,756; 10,552,757; 10,553,775; 10,554,207; 10,560,076; 10,560,103; 10,565,515; 10,567,100; 10,572,816; 10,573,093; 10,578,891; 10,586,908; 10,586,909; 10,586,911; 10,593,858; 10,593,879; 10,599,988; 10,599,990; 10,601,623; 10,614,372; 10,615,223; 10,615,783; 10,616,025; 10,621,140; 10,621,502; 10,622,032; 10,622,977; 10,622,998; 10,628,752; 10,628,753; 10,629,978; 10,630,326; 10,635,988; 10,635,989; 10,635,990; 10,637,142; 10,637,449; 10,637,479; 10,643,143; 10,644,217; 10,644,809; 10,650,319; 10,650,320; 10,650,322; 10,650,323; 10,651,361; 10,651,808; 10,657,198; 10,657,455; 10,657,456; 10,658,424; 10,659,018; 10,659,075; 10,665,635; 10,665,701; 10,665,769; 10,665,918; 10,666,238; 10,671,559; 10,671,937; 10,680,617; 10,686,007; 10,686,115; 10,691,633; 10,692,010; 10,693,566; 10,700,256; 10,700,257; 10,705,163; 10,706,366; 10,707,402; 10,707,812; 10,707,873; 10,708,046; 10,712,408; 10,713,584; 10,715,083; 10,719,775; 10,719,776; 10,720,562; 10,720,563; 10,720,887; 10,725,131; 10,725,361; 10,726,351; 10,726,353; 10,735,003; 10,740,688; 10,741,742; 10,748,078; 10,748,079; 10,748,082; 10,748,960; 10,748,961; 10,749,095; 10,749,096; 10,755,190; 10,755,194; 10,755,775; 10,756,004; 10,756,712; 10,763,420; 10,769,545; 10,769,546; 10,770,638; 10,775,173; 10,776,709; 10,784,432; 10,789,123; 10,789,329; 10,789,541; 10,790,566; 10,797,684; 10,803,396; 10,804,874; 10,809,177; 10,810,506; 10,810,507; 10,811,276; 10,811,588; 10,813,219; 10,817,463; 10,817,796; 10,819,281; 10,826,845; 10,832,155; 10,832,156; 10,833,016; 10,833,121; 10,833,242; 10,833,243; 10,833,680; 10,839,305; 10,839,306; 10,840,295; 10,847,705; 10,847,706; 10,852,346; 10,852,366; 10,858,239; 10,858,240; 10,862,465; 10,868,540; 10,872,021; 10,879,202; 10,879,446; 10,879,906; 10,884,033; 10,885,459; 10,886,049; 10,886,454; 10,886,585; 10,887,013; 10,891,554; 10,891,555; 10,892,725; 10,892,751; 10,897,069; 10,901,062; 10,903,411; 10,903,809; 10,914,969; 10,915,832; 10,916,690; 10,916,821; 10,917,096; 10,922,381; 10,922,617; 10,922,619; 10,924,095; 10,927,076; 10,929,576; 10,931,267; 10,937,941; 10,938,346; 10,942,804; 10,943,180; 10,944,362; 10,949,769; 10,950,299; 10,950,654; 10,950,778; 10,956,267; 10,957,841; 10,958,253; 10,958,274; 10,964,997; 10,969,443; 10,971,672; 10,978,425; 10,978,632; 10,984,335; 10,984,336; 10,985,308; 10,985,701; 10,985,739; 10,989,767; 10,990,017; 10,991,755; 10,992,106; 10,996,979; 10,998,869; 11,004,009; 11,005,023; 11,005,024; 11,006,527; 11,010,145; 11,010,686; 11,011,693; 11,012,960; 11,017,310; 11,018,290; 11,033,981; 11,037,068; 11,038,095; 11,049,037; 11,050,009; 11,050,010; 11,055,627; 11,056,583; 11,063,201; 11,069,790; 11,070,210; 11,075,435; 11,088,679; 11,095,489; 11,100,418; 11,105,866; 11,106,980; 11,106,993; 11,108,120; 11,108,380; 11,108,398; 11,112,442; 11,112,842; 11,115,011; 11,115,012; 11,115,027; 11,115,131; 11,119,385; 11,120,357; 11,121,239; 11,121,301; 11,121,302; 11,126,062; 11,126,926; 11,127,892; 11,128,045; 11,133,450; 11,133,451; 11,138,354; 11,139,424; 11,152,707; 11,157,827; 11,163,209; 11,164,100; 11,164,102; 11,164,103; 11,164,104; 11,169,801; 11,170,317; 11,170,318; 11,170,846; 11,177,428; 11,177,912; 11,178,771; 11,182,230; 11,182,690; 11,183,989; 11,188,843; 11,194,573; 11,194,659; 11,197,365; 11,200,508; 11,210,600; 11,210,601; 11,210,602; 11,211,482; 11,218,471; 11,223,005; 11,223,355; 11,240,223; 11,245,389; 11,245,390; 11,245,486; 11,245,519; 11,258,415; 11,264,089; 11,264,554; 11,271,280; 11,271,533; 11,281,524; 11,283,002; 11,283,445; 11,288,121; 11,289,156; 11,289,639; 11,293,851; 11,294,986; 11,300,853; 11,301,770; 11,302,856; 11,303,281; 11,307,242; 11,308,416; 11,309,478; 11,317,519; 11,320,588; 11,321,627; 11,329,638; 11,334,811; 11,341,426; 11,342,493; 11,342,905; 20010020701; 20010023943; 20010025012; 20010035524; 20010040447; 20010055669; 20010055775; 20020060635; 20020066936; 20020075057; 20020095765; 20020097047; 20020102674; 20020105948; 20020115571; 20020117467; 20020117656; 20020117738; 20020118903; 20020119243; 20020119805; 20020121636; 20020128156; 20020130313; 20020130315; 20020135582; 20020138637; 20020138701; 20020138707; 20020152810; 20020156993; 20020169079; 20020177529; 20020177769; 20020179937; 20020179939; 20020188578; 20020189533; 20020190381; 20030005010; 20030011398; 20030016010; 20030016069; 20030017949; 20030027724; 20030028338; 20030034794; 20030038285; 20030039138; 20030040440; 20030042481; 20030054960; 20030057441; 20030058026; 20030068832; 20030071246; 20030071258; 20030076251; 20030077224; 20030094606; 20030098455; 20030102470; 20030107033; 20030111659; 20030111661; 20030115401; 20030117496; 20030121028; 20030134089; 20030141868; 20030146429; 20030146430; 20030146746; 20030169041; 20030169142; 20030173498; 20030173997; 20030179831; 20030183935; 20030189203; 20030193097; 20030199395; 20030207766; 20030207767; 20030219911; 20030224944; 20030229765; 20030230732; 20040000666; 20040004129; 20040004698; 20040008262; 20040012388; 20040012407; 20040014077; 20040016883; 20040016918; 20040022332; 20040027125; 20040041018; 20040056105; 20040065738; 20040075747; 20040077503; 20040080620; 20040090553; 20040095803; 20040098443; 20040099861; 20040104410; 20040119061; 20040119827; 20040120299; 20040125209; 20040125212; 20040126304; 20040129789; 20040130311; 20040134967; 20040135139; 20040140537; 20040145366; 20040150458; 20040151321; 20040154704; 20040165454; 20040167036; 20040170047; 20040173787; 20040173792; 20040173793; 20040183914; 20040201400; 20040215931; 20040220057; 20040223380; 20040232405; 20040232912; 20040234785; 20040239319; 20040266497; 20040266627; 20050001209; 20050023518; 20050029512; 20050035368; 20050040843; 20050043185; 20050045869; 20050045872; 20050047245; 20050052181; 20050057248; 20050062131; 20050071404; 20050071513; 20050071526; 20050071578; 20050071651; 20050071828; 20050074220; 20050078022; 20050078117; 20050081181; 20050081182; 20050081201; 20050081202; 20050081203; 20050081209; 20050081213; 20050082519; 20050086655; 20050088174; 20050091473; 20050092849; 20050095011; 20050097231; 20050097280; 20050097302; 20050098773; 20050101489; 20050106313; 20050107262; 20050109879; 20050116204; 20050116719; 20050120185; 20050120187; 20050120254; 20050122399; 20050123674; 20050134262; 20050138325; 20050143791; 20050145701; 20050146613; 20050146614; 20050149002; 20050149169; 20050151819; 20050160097; 20050162302; 20050171421; 20050179781; 20050180095; 20050185198; 20050185461; 20050188372; 20050188373; 20050192727; 20050197254; 20050202572; 20050206376; 20050215436; 20050216222; 20050216775; 20050218236; 20050224784; 20050228967; 20050231196; 20050241394; 20050243708; 20050247793; 20050250651; 20050251659; 20050251667; 20050255680; 20050256007; 20050258248; 20050268038; 20050268048; 20050273652; 20060022671; 20060025897; 20060038821; 20060049891; 20060050286; 20060055782; 20060056728; 20060069879; 20060072030; 20060075397; 20060076423; 20060079402; 20060091881; 20060092957; 20060093861; 20060095220; 20060097746; 20060097747; 20060104889; 20060107122; 20060112213; 20060126770; 20060129786; 20060129999; 20060143509; 20060145694; 20060147154; 20060148514; 20060149861; 20060151775; 20060155792; 20060155955; 20060155964; 20060158519; 20060161741; 20060164081; 20060176054; 20060177122; 20060179179; 20060179198; 20060179255; 20060179275; 20060179277; 20060179278; 20060179436; 20060180371; 20060186881; 20060190614; 20060190942; 20060195824; 20060206731; 20060206732; 20060212193; 20060212194; 20060212643; 20060214012; 20060220641; 20060225165; 20060231627; 20060234419; 20060237660; 20060243043; 20060244581; 20060247131; 20060248618; 20060251070; 20060255987; 20060259733; 20060259743; 20060270173; 20060275958; 20060284839; 20060290553; 20070005202; 20070007956; 20070011023; 20070018643; 20070038067; 20070046955; 20070049097; 20070052441; 20070057781; 20070069339; 20070075729; 20070075752; 20070075919; 20070077906; 20070080341; 20070083870; 20070085534; 20070096565; 20070096730; 20070114994; 20070116629; 20070126561; 20070139216; 20070156312; 20070156320; 20070158791; 20070167723; 20070168538; 20070174227; 20070176625; 20070180041; 20070180586; 20070186077; 20070194225; 20070194958; 20070197900; 20070201845; 20070201846; 20070205881; 20070212794; 20070236245; 20070240013; 20070241746; 20070241747; 20070254375; 20070258329; 20070263432; 20070277000; 20070283103; 20070288701; 20070293160; 20080001599; 20080024126; 20080024642; 20080040805; 20080047367; 20080048762; 20080048902; 20080049885; 20080051291; 20080051292; 20080052055; 20080052504; 20080065290; 20080065573; 20080074110; 20080074113; 20080077721; 20080077815; 20080084898; 20080086240; 20080086438; 20080091886; 20080098260; 20080100175; 20080101444; 20080101501; 20080101503; 20080103708; 20080107213; 20080108503; 20080109500; 20080112313; 20080116448; 20080116449; 20080122434; 20080126601; 20080129475; 20080146449; 20080155203; 20080156406; 20080162613; 20080162834; 20080162877; 20080165254; 20080168443; 20080176750; 20080186064; 20080209156; 20080215850; 20080216567; 20080218519; 20080229143; 20080231353; 20080235679; 20080238531; 20080250414; 20080256275; 20080258753; 20080260257; 20080271003; 20080274898; 20080276232; 20080279370; 20080282063; 20080282084; 20080282093; 20080282341; 20080282342; 20080284413; 20080284575; 20080290938; 20080297230; 20080301695; 20080313114; 20080313430; 20090002014; 20090008632; 20090014714; 20090015317; 20090031412; 20090033369; 20090034657; 20090043441; 20090057652; 20090068355; 20090070402; 20090072828; 20090073017; 20090075825; 20090077001; 20090078931; 20090078932; 20090082209; 20090086533; 20090102580; 20090121215; 20090122508; 20090125717; 20090135215; 20090135232; 20090143665; 20090153180; 20090153381; 20090167342; 20090168286; 20090173936; 20090189633; 20090192041; 20090206871; 20090227044; 20090232191; 20090232507; 20090232510; 20090233798; 20090237106; 20090241013; 20090242636; 20090244215; 20090244292; 20090244958; 20090256561; 20090259905; 20090261319; 20090267635; 20090274609; 20090289638; 20090299947; 20090302844; 20090319757; 20090321720; 20090322374; 20090324484; 20100006825; 20100026447; 20100026537; 20100033206; 20100033252; 20100066576; 20100079600; 20100085827; 20100091116; 20100094796; 20100097056; 20100102904; 20100109638; 20100109669; 20100133514; 20100148841; 20100148853; 20100149011; 20100164536; 20100170951; 20100176840; 20100182039; 20100194466; 20100207622; 20100207657; 20100207754; 20100237899; 20100239489; 20100281885; 20100301855; 20100301856; 20100301857; 20100303731; 20100303733; 20100306142; 20100312969; 20100315516; 20100327861; 20100327865; 20100329401; 20100329962; 20100330704; 20110004930; 20110009274; 20110010412; 20110018612; 20110022820; 20110031994; 20110047201; 20110049475; 20110054236; 20110054450; 20110054876; 20110055520; 20110057169; 20110060710; 20110060711; 20110060780; 20110063016; 20110065585; 20110065586; 20110068789; 20110085381; 20110087909; 20110089405; 20110098623; 20110102068; 20110122261; 20110125460; 20110133770; 20110152104; 20110167241; 20110175061; 20110175062; 20110175628; 20110210738; 20110231462; 20110238607; 20110241765; 20110254583; 20110267878; 20110278355; 20110285393; 20110288823; 20110298489; 20110302591; 20110303153; 20120005456; 20120012818; 20120019242; 20120023053; 20120030386; 20120042372; 20120045136; 20120053059; 20120088674; 20120089299; 20120094838; 20120096873; 20120108434; 20120112168; 20120135867; 20120144159; 20120157319; 20120157321; 20120172233; 20120184445; 20120187378; 20120187872; 20120210111; 20120212375; 20120215821; 20120225411; 20120238860; 20120252678; 20120254586; 20120258861; 20120265718; 20120266174; 20120274494; 20120278057; 20120294424; 20120302446; 20120314490; 20120319684; 20120320668; 20120324563; 20120324564; 20120326130; 20120326720; 20120328301; 20130004180; 20130005580; 20130007087; 20130009677; 20130015885; 20130038330; 20130040818; 20130043945; 20130079230; 20130096825; 20130117200; 20130144925; 20130186953; 20130190185; 20130196855; 20130201316; 20130221960; 20130231249; 20130233077; 20130245402; 20130258595; 20130271142; 20130272453; 20130278265; 20130278283; 20130282636; 20130303379; 20130313526; 20130324832; 20140000630; 20140025606; 20140050475; 20140056385; 20140089374; 20140097405; 20140113828; 20140167811; 20140167836; 20140175380; 20140187427; 20140203838; 20140223224; 20140228222; 20140229705; 20140229722; 20140232400; 20140235450; 20140245249; 20140245314; 20140246763; 20140249033; 20140250288; 20140253111; 20140264285; 20140286465; 20140296076; 20140303931; 20140314419; 20140315723; 20140324933; 20140329687; 20140343397; 20140344322; 20140354326; 20140368234; 20150006443; 20150028970; 20150032991; 20150032993; 20150032994; 20150043273; 20150046681; 20150055961; 20150070131; 20150078290; 20150087945; 20150092465; 20150094207; 20150111754; 20150119252; 20150119253; 20150125155; 20150143817; 20150146805; 20150146806; 20150161524; 20150178432; 20150179913; 20150179914; 20150179915; 20150179916; 20150179918; 20150184286; 20150187840; 20150195248; 20150205759; 20150212166; 20150219730; 20150229343; 20150241481; 20150242758; 20150254571; 20150262073; 20150263736; 20150269124; 20150288476; 20150288542; 20150300719; 20150310350; 20150318095; 20150332164; 20150346291; 20150349780; 20150357550; 20150358022; 20150363708; 20150372217; 20150379418; 20160012346; 20160012347; 20160012882; 20160013791; 20160019468; 20160023906; 20160028402; 20160028403; 20160032904; 20160034609; 20160035404; 20160036612; 20160042294; 20160044647; 20160045841; 20160065693; 20160071021; 20160071903; 20160079968; 20160080189; 20160085616; 20160087599; 20160093420; 20160103192; 20160112031; 20160127073; 20160132785; 20160139213; 20160148112; 20160149111; 20160154068; 20160156357; 20160164505; 20160191060; 20160197628; 20160221825; 20160233405; 20160233860; 20160233965; 20160248582; 20160254434; 20160267032; 20160267964; 20160276570; 20160283857; 20160292586; 20160292587; 20160296145; 20160308502; 20160314407; 20160321559; 20160335558; 20160335559; 20160351306; 20160364653; 20160371227; 20160380636; 20170000375; 20170012862; 20170017742; 20170017894; 20170026095; 20170038123; 20170039481; 20170045592; 20170045800; 20170061317; 20170062107; 20170069367; 20170069415; 20170070290; 20170071082; 20170072504; 20170077381; 20170077382; 20170077665; 20170078400; 20170085231; 20170086281; 20170089961; 20170091647; 20170091649; 20170091650; 20170098682; 20170104491; 20170104493; 20170104695; 20170116159; 20170116542; 20170117901; 20170117994; 20170123171; 20170133336; 20170133576; 20170133577; 20170134091; 20170141286; 20170141287; 20170141769; 20170146618; 20170162778; 20170163301; 20170168123; 20170177534; 20170177751; 20170178017; 20170178018; 20170179973; 20170184689; 20170186934; 20170186935; 20170193388; 20170199036; 20170201224; 20170212860; 20170213143; 20170228483; 20170229167; 20170229631; 20170229632; 20170229633; 20170230050; 20170237144; 20170237594; 20170241953; 20170250796; 20170255629; 20170255871; 20170255872; 20170262765; 20170265158; 20170265287; 20170276827; 20170286859; 20170294965; 20170295048; 20170296169; 20170296177; 20170296178; 20170296179; 20170296180; 20170296183; 20170296184; 20170296185; 20170296189; 20170296213; 20170300454; 20170300808; 20170300827; 20170301444; 20170316487; 20170317262; 20170323195; 20170324019; 20170329883; 20170331899; 20170337155; 20170343750; 20170344898; 20170345990; 20170351974; 20170359072; 20170366270; 20170373044; 20170373369; 20180005809; 20180005887; 20180012932; 20180013052; 20180013426; 20180019737; 20180025775; 20180026633; 20180032893; 20180033944; 20180034425; 20180034912; 20180040935; 20180054201; 20180062765; 20180067182; 20180069288; 20180069631; 20180076777; 20180090661; 20180091115; 20180091141; 20180091142; 20180091143; 20180091440; 20180092313; 20180101784; 20180101785; 20180101786; 20180101787; 20180102166; 20180102469; 20180102470; 20180107092; 20180114568; 20180118573; 20180123544; 20180124181; 20180131376; 20180137428; 20180137429; 20180137430; 20180138987; 20180145631; 20180145664; 20180145753; 20180150579; 20180150760; 20180150761; 20180157775; 20180164385; 20180188107; 20180196780; 20180198427; 20180211158; 20180218279; 20180218280; 20180218281; 20180219150; 20180225586; 20180226974; 20180226975; 20180232652; 20180232653; 20180232654; 20180232655; 20180240033; 20180240034; 20180240035; 20180246848; 20180247974; 20180248103; 20180248104; 20180260245; 20180260729; 20180260730; 20180260731; 20180260732; 20180261752; 20180262243; 20180267116; 20180267933; 20180275057; 20180276550; 20180277733; 20180278693; 20180278694; 20180285761; 20180287041; 20180294401; 20180294815; 20180300286; 20180301612; 20180301613; 20180308007; 20180308896; 20180309452; 20180314968; 20180314970; 20180322408; 20180323364; 20180330264; 20180330266; 20180330267; 20180331274; 20180335683; 20180336153; 20180337138; 20180337324; 20180341874; 20180342663; 20180343304; 20180348310; 20180350411; 20180350749; 20180351521; 20180359718; 20180365587; 20180366634; 20180373996; 20180375790; 20180375940; 20190005403; 20190006572; 20190007051; 20190013065; 20190019098; 20190019099; 20190019938; 20190027672; 20190034819; 20190036515; 20190042264; 20190042962; 20190042963; 20190042964; 20190042967; 20190042968; 20190042970; 20190042971; 20190042972; 20190042973; 20190043822; 20190043919; 20190044044; 20190044046; 20190044047; 20190044051; 20190044668; 20190049495; 20190058105; 20190065981; 20190065982; 20190073439; 20190079145; 20190081629; 20190082997; 20190087385; 20190095811; 20190098090; 20190102691; 20190104614; 20190109273; 20190109904; 20190122133; 20190123743; 20190123744; 20190131511; 20190131683; 20190131944; 20190147359; 20190149139; 20190156237; 20190156238; 20190158098; 20190164077; 20190164959; 20190165239; 20190165240; 20190165242; 20190165245; 20190165246; 20190173708; 20190182995; 20190187075; 20190188596; 20190188597; 20190190463; 20190190474; 20190204372; 20190204753; 20190205784; 20190207075; 20190207076; 20190207794; 20190212147; 20190214561; 20190214789; 20190214971; 20190215952; 20190220771; 20190227439; 20190228331; 20190228332; 20190229094; 20190229690; 20190236476; 20190237648; 20190237649; 20190238137; 20190245538; 20190245544; 20190251466; 20190252754; 20190259931; 20190266508; 20190266510; 20190266512; 20190267154; 20190267532; 20190267692; 20190270635; 20190273196; 20190273197; 20190288174; 20190288176; 20190288178; 20190288367; 20190294025; 20190294991; 20190296212; 20190296214; 20190296743; 20190302194; 20190303242; 20190303788; 20190305037; 20190305038; 20190305206; 20190317167; 20190317978; 20190321039; 20190324846; 20190324941; 20190326501; 20190332965; 20190337894; 20190339339; 20190341540; 20190341668; 20190343002; 20190343003; 20190347576; 20190348597; 20190354890; 20190362260; 20190362780; 20190363239; 20190363688; 20190369171; 20190370679; 20190370680; 20190372192; 20190378874; 20190385088; 20190385673; 20190391214; 20190392344; 20190392878; 20190393401; 20200000468; 20200005178; 20200005186; 20200006421; 20200006619; 20200006620; 20200006621; 20200007235; 20200008800; 20200012961; 20200018803; 20200023462; 20200027502; 20200028480; 20200028512; 20200033511; 20200036330; 20200036331; 20200036332; 20200036333; 20200044137; 20200044632; 20200044656; 20200046348; 20200049776; 20200050026; 20200050958; 20200050959; 20200050961; 20200052101; 20200052183; 20200052359; 20200057957; 20200058702; 20200062583; 20200064412; 20200065696; 20200074345; 20200075093; 20200075832; 20200075833; 20200075834; 20200078015; 20200081075; 20200081076; 20200082291; 20200083424; 20200090738; 20200091396; 20200091397; 20200091867; 20200099116; 20200104740; 20200106149; 20200106444; 20200106445; 20200111016; 20200111944; 20200112310; 20200115372; 20200116623; 20200118025; 20200118026; 20200119251; 20200119254; 20200119737; 20200120812; 20200125625; 20200127186; 20200127678; 20200134502; 20200134503; 20200136008; 20200136223; 20200136626; 20200138434; 20200138437; 20200142225; 20200144476; 20200144690; 20200145065; 20200152696; 20200152851; 20200152853; 20200152854; 20200156955; 20200160204; 20200161446; 20200161531; 20200162047; 20200162078; 20200166586; 20200167683; 20200167684; 20200167685; 20200169396; 20200176409; 20200176662; 20200183768; 20200184364; 20200186132; 20200193320; 20200204181; 20200206344; 20200210879; 20200215131; 20200219001; 20200220064; 20200220757; 20200226487; 20200227617; 20200234171; 20200234173; 20200235277; 20200242452; 20200242500; 20200242501; 20200242503; 20200243132; 20200243133; 20200244253; 20200250564; 20200250567; 20200250569; 20200250570; 20200251419; 20200257644; 20200258003; 20200259066; 20200259483; 20200264130; 20200264213; 20200265334; 20200266234; 20200272910; 20200272925; 20200272929; 20200274049; 20200274050; 20200274526; 20200274703; 20200274929; 20200278308; 20200278903; 20200279013; 20200279184; 20200279186; 20200279990; 20200280316; 20200280317; 20200280607; 20200284855; 20200284859; 20200285539; 20200287118; 20200287122; 20200287525; 20200287540; 20200287550; 20200287631; 20200293486; 20200293937; 20200293938; 20200294401; 20200294557; 20200299146; 20200301244; 20200301874; 20200311591; 20200320420; 20200320423; 20200320424; 20200320426; 20200321506; 20200321508; 20200327440; 20200327441; 20200328339; 20200333263; 20200334101; 20200334104; 20200334107; 20200335683; 20200342296; 20200342345; 20200344051; 20200349326; 20200349458; 20200349459; 20200350083; 20200350880; 20200352918; 20200356889; 20200356890; 20200358187; 20200359501; 20200362384; 20200363206; 20200364600; 20200364602; 20200365397; 20200371974; 20200372094; 20200373351; 20200373475; 20200379768; 20200380396; 20200381608; 20200381609; 20200393738; 20200394524; 20200394537; 20200394546; 20200394547; 20200395405; 20200395448; 20200401649; 20200401922; 20200401927; 20200403137; 20200403289; 20200410343; 20200410382; 20200411937; 20200411938; 20200412369; 20210004708; 20210005249; 20210013391; 20210013570; 20210018575; 20210019223; 20210019646; 20210019647; 20210021245; 20210026162; 20210027188; 20210028138; 20210028343; 20210028345; 20210028346; 20210033683; 20210034998; 20210035004; 20210035005; 20210036206; 20210036692; 20210043824; 20210047913; 20210056454; 20210056455; 20210057135; 20210057484; 20210057631; 20210064350; 20210065036; 20210066570; 20210067146; 20210068320; 20210072139; 20210073667; 20210073668; 20210075860; 20210075861; 20210081816; 20210083167; 20210083168; 20210083676; 20210085316; 20210085317; 20210085675; 20210089954; 20210091062; 20210091755; 20210099129; 20210099201; 20210103012; 20210103018; 20210104656; 20210110290; 20210110291; 20210110868; 20210111469; 20210114864; 20210116499; 20210117512; 20210117845; 20210119101; 20210125096; 20210132969; 20210133614; 20210133617; 20210133618; 20210139315; 20210142203; 20210142205; 20210142215; 20210143804; 20210143805; 20210151844; 20210157877; 20210159384; 20210167272; 20210175095; 20210182724; 20210182725; 20210182728; 20210184329; 20210190885; 20210193270; 20210202573; 20210208509; 20210218367; 20210226113; 20210226597; 20210226635; 20210230674; 20210232960; 20210232963; 20210233617; 20210233896; 20210234086; 20210234087; 20210247329; 20210255856; 20210256351; 20210256409; 20210257177; 20210257969; 20210257995; 20210263390; 20210264309; 20210265964; 20210271545; 20210272002; 20210279134; 20210279624; 20210279625; 20210280701; 20210280704; 20210280766; 20210281252; 20210288611; 20210294680; 20210296558; 20210296749; 20210302513; 20210304052; 20210304053; 20210304054; 20210305958; 20210313973; 20210325368; 20210326737; 20210326739; 20210326740; 20210334081; 20210336032; 20210336121; 20210336319; 20210341411; 20210341979; 20210342161; 20210342726; 20210342727; 20210342729; 20210343923; 20210350266; 20210350268; 20210351075; 20210357798; 20210359666; 20210359670; 20210365622; 20210367065; 20210374550; 20210374595; 20210384401; 20210384402; 20210384406; 20210384896; 20210390440; 20210390442; 20210391851; 20210391852; 20210399044; 20210399199; 20210399763; 20210406746; 20210408112; 20210408355; 20220003676; 20220004079; 20220011384; 20220012622; 20220014408; 20220019927; 20220019929; 20220020912; 20220021391; 20220028927; 20220029083; 20220036943; 20220045416; 20220045425; 20220051123; 20220052662; 20220057261; 20220058508; 20220059919; 20220065954; 20220076154; 20220083488; 20220083891; 20220083892; 20220083893; 20220084085; 20220085527; 20220087012; 20220087022; 20220092461; 20220092462; 20220094320; 20220094338; 20220094341; 20220094342; 20220101171; 20220103172; 20220115577; 20220116208; 20220121978; 20220121979; 20220123449; 20220129779; 20220131064; 20220135409; 20220136895; 20220137390; 20220138609; 20220138611; 20220140223; 20220140820; 20220140927; 20220146905; 20220147358; 20220147859; 20220149841; 20220156444; 20220156621; 20220164501; 20220164694; 202102580109; and 202103904449.

See patent and Publication Nos.: AU-2002248800; AU-2003250608; AU-2004266178; AU-2005242881; AU-2007209712; AU-2008200506; AU-2012236227; AU-2012271422; AU-2012279307; AU-2014354845; AU-2015267491; AU-2015275326; AU-2015283229; AU-2015347258; AU-2015361113; AU-2015417667; AU-2015417766; AU-2016215234; AU-2016215236; AU-2016287262; AU-2016335554; AU-2016351374; AU-2016357098; AU-2016423167; AU-2016423191; AU-2016432064; AU-2016432315; AU-2017215201; AU-2017219169; AU-2017280880; AU-2017345039; AU-2017360505; AU-2017386234; AU-2017387796; AU-2017404530; AU-2017404536; AU-2017429630; AU-2017429631; AU-2017430443; AU-2017431392; AU-2017431764; AU-2017432161; AU-2017432809; AU-2017434905; AU-2017442682; AU-2017442703; AU-2017443043; AU-2017443044; AU-2018230440; AU-2018230642; AU-2018247327; AU-2018278348; AU-2018282100; AU-2018362084; AU-2018406532; AU-2018415721; AU-2018434686; AU-2019203536; AU-2019206299; AU-2019206300; AU-2019209295; AU-2019210496; AU-2019283688; AU-2019289070; AU-2019321613; AU-2019333268; AU-2019365240; AU-2019389858; AU-2019420732; AU-2019426405; AU-2019430032; AU-2019446426; AU-2020202779; AU-2020217399; AU-2020235374; AU-2020250769; AU-2020255132; AU-2020256387; AU-2020259653; AU-2020274007; AU-2020292425; AU-2020294362; AU-2020297857; AU-2020324398; AU-2020340968; AU-2020349591; AU-2020354489; AU-2020376131; AU-2021201028; AU-2021201029; AU-2021201519; AU-2021201695; AU-2021202981; AU-2021203130; AU-2021204723; AU-2021225173; AU-2021232777; AU-2021257928; AU-763277; CA-2225803-C; CA-2381109; CA-2396201; CA-2444659; CA-2448682; CA-2482792; CA-2493592; CA-2530942-C; CA-2637071; CA-2662604; CA-2662604-C; CA-2667640; CA-2667640-C; CA-2681147; CA-2751897; CA-2763134; CA-2765898; CA-2814865; CA-2836156; CA-2837896; CA-2849589; CA-2860516; CA-2868986; CA-2898598; CA-2898608; CA-2927326; CA-2931398; CA-2950133; CA-2953185; CA-2960483; CA-2968827; CA-2968830; CA-2974106; CA-2977662; CA-2977780; CA-2981493; CA-2987426; CA-2988829; CA-2996620; CA-2998363; CA-3003272; CA-3004750; CA-3008796; CA-3008825; CA-3009887; CA-3010686; CA-3012700; CA-3012853; CA-3026499; CA-3032557; CA-3034528; CA-3036054; CA-3036059; CA-3036478; CA-3036489; CA-3036501; CA-3036945; CA-3040583; CA-3043201; CA-3046173; CA-3046616; CA-3047541; CA-3049097; CA-3054796; CA-3056595; CA-3056596; CA-3058725; CA-3058731; CA-3065337; CA-3065859; CA-3074067; CA-3074121; CA-3074722; CA-3075163; CA-3075253; CA-3076182; CA-3076743; CA-3078581; CA-3080318; CA-3085717; CA-3085827; CA-3085866; CA-3085954; CA-3085955; CA-3086919; CA-3087071; CA-3087257; CA-3087539; CA-3088133; CA-3088135; CA-3088650; CA-3089263; CA-3090429; CA-3093134; CA-3093358; CA-3096026; CA-3096490; CA-3096897; CA-3101170; CA-3102199; CA-3102773; CA-3102866; CA-3103471; CA-3104518; CA-3109380; CA-3109599; CA-3109604; CA-3109643; CA-3112351; CA-3112444; CA-3112594; CA-3112596; CA-3114773; CA-3117223; CA-3125749; CA-3125824; CA-3125917; CA-3125986; CA-3127307; CA-3132092; CA-3132152; CA-3133917; CA-3135530; CA-3135532; CA-3137517; CA-3137657; CA-3139157; CA-3140970; CA-3141547; CA-3142865; CA-3143227; CA-3143363; CA-3143581; CA-3143661; CA-3143691; CA-3147698; CA-3147706; CA-3149305; CA-3150036; CA-3150374; CA-3151055; CA-3151510; CA-3154738; CN-100382014; CN-100409222; CN-100412848; CN-100419638; CN-100432956; CN-100451996; CN-100504790; CN-100524270; CN-100549984; CN-100555174; CN-100572590; CN-101040268; CN-101057223; CN-101080701; CN-101084505; CN-101091147; CN-101099140; CN-101099141; CN-101203939; CN-101326500; CN-101375302; CN-101401128; CN-101615233; CN-101626233; CN-101626234; CN-101657827; CN-101705469; CN-101838844; CN-102334206; CN-102449481; CN-102460196; CN-102687169; CN-102687476; CN-102959750; CN-103069421; CN-103451265; CN-103582949; CN-103781918; CN-104081464; CN-104576914; CN-104838590; CN-105190656; CN-105264680; CN-105814074; CN-105814856; CN-105914219; CN-105980615; CN-105984840; CN-106267902; CN-106461287; CN-106575667; CN-106662707; CN-106664194; CN-106767944; CN-106953000; CN-107004755; CN-107075559; CN-107251435; CN-107302512; CN-107393941; CN-107580752; CN-107636699; CN-107704649; CN-107924490; CN-107925146; CN-107980145; CN-107994307; CN-108028293; CN-108108151; CN-108259014; CN-108290733; CN-108342385; CN-108349725; CN-108352841; CN-108475353; CN-108778345; CN-108780119; CN-108780129; CN-108796058; CN-109075186; CN-109238775; CN-109285760; CN-109313725; CN-109314174; CN-109376870; CN-109389223; CN-109450555; CN-109477061; CN-109508303; CN-109626323; CN-109643710; CN-109643730; CN-109685216; CN-109715802; CN-109716650; CN-109764960; CN-109783054; CN-109791944; CN-109792840; CN-109804477; CN-109841645; CN-109844637; CN-109844642; CN-109845107; CN-109863249; CN-109874327; CN-109889318; CN-109891252; CN-109891591; CN-109997156; CN-110024146; CN-110024282; CN-110024292; CN-110034228; CN-110050383; CN-110069238; CN-110073375; CN-1101083-C; CN-110176532; CN-110235150; CN-110249343; CN-110257430; CN-110289256; CN-110289312; CN-110311662; CN-110383303; CN-110383485; CN-110402446; CN-110431568; CN-110462836; CN-110472740; CN-110494998; CN-110520873; CN-110622297; CN-110646503; CN-110692067; CN-110709934; CN-110739010; CN-110741391; CN-110945536; CN-110998853; CN-111033773; CN-111049503; CN-111095306; CN-111095307; CN-111095584; CN-111108687; CN-111133459; CN-111149439; CN-111164618; CN-111180848; CN-111183434; CN-111213280; CN-111213281; CN-111247741; CN-111260066; CN-111260068; CN-111328432; CN-111344875; CN-111344896; CN-111417966; CN-111417967; CN-111427810; CN-111460749; CN-111465947; CN-111465948; CN-111480170; CN-111523672; CN-111542842; CN-111542935; CN-111598248; CN-111613716; CN-111630531; CN-111656374; CN-111712842; CN-111723936; CN-111725382; CN-111727248; CN-111755587; CN-111788588; CN-111868755; CN-111868756; CN-111868757; CN-111902358; CN-111903057; CN-111914500; CN-111914507; CN-111950215; CN-111950216; CN-111967603; CN-111969100; CN-112114875; CN-112116094; CN-112149832; CN-112236785; CN-112262398; CN-112313677; CN-112313796; CN-112331693; CN-112368721; CN-112368940; CN-112385140; CN-112397862; CN-112400178; CN-112444715; CN-112449704; CN-112514158; CN-112514246; CN-112534448; CN-112567397; CN-112585627; CN-112602205; CN-112633506; CN-112640200; CN-112654970; CN-112673486; CN-112771553; CN-112771717; CN-112789629; CN-112819170; CN-112823361; CN-112861463; CN-112868135; CN-112930491; CN-112949229; CN-112956129; CN-112990468; CN-112990470; CN-113037294; CN-113056752; CN-113065301; CN-113095033; CN-113128165; CN-113128172; CN-113168579; CN-113168581; CN-113193311; CN-113206364; CN-113215326; CN-113255921; CN-113257552; CN-113261156; CN-113302631; CN-113328759; CN-113330465; CN-113361718; CN-113421600; CN-113424205; CN-113424441; CN-113449870; CN-113452326; CN-113454656; CN-113490731; CN-113516248; CN-113557666; CN-113627614; CN-113646779; CN-113646781; CN-113661502; CN-113725208; CN-113725349; CN-113826124; CN-113839644; CN-113853619; CN-113890513; CN-113906449; CN-113934680; CN-113939833; CN-113987993; CN-114021519; CN-114077897; CN-114122249; CN-114127900; CN-114175058; CN-114175059; CN-114186516; CN-114200282; CN-114207630; CN-114221629; CN-114223003; CN-114239838; CN-114254754; CN-114296685; CN-114297976; CN-114335318; CN-114373635; CN-114386610; CN-114399054; CN-114429215; CN-114444703; CN-114450697; CN-114450698; CN-114497113; CN-114503019; CN-114503027; CN-114503431; CN-114514192; CN-114528806; CN-1189934; CN-1279469-C; CN-1279470-C; CN-1291327-C; CN-1292366-C; CN-1300723-C; CN-1494690; CN-1496511; CN-1496516; CN-1496517; CN-1496518; CN-1601468; CN-1601511; CN-1601512; CN-1806231; CN-1808400; CN-1811745; CN-1815438; CN-1834852; CN-1839093; CN-1890400; CN-1906576; CN-1906586; CN-1906587; CN-1910554; CN-1914600; CN-1938687; CN-1942858; CN-1989769; CN-201479114; CN-201667647; CN-207399151; CN-209930215; CN-209930216; CN-210327515; CN-211404707; CN-213069884; CN-213426111; CN-214378496; CN-215008192; CN-215186652; CN-215729853; CN-215895506; CN-216083004; CN-216083732; CN-216086610; CN-216134457; CN-216285581; CN-216286750; CN-216286751; DE-102004005243; DE-102008036993; DE-102009025716; DE-102010026098; DE-1020100260989; DE-102010053575; DE-102016204201; DE-102017129364; DE-102017129365; DE-102019101054; DE-102019104312; DE-102019112893; DE-102020007977; DE-102020122245; DE-102020125169; DE-102020125171; DE-102020125172; DE-102020125173; DE-102020125174; DE-102020125175; DE-102020125176; DE-102020125177; DE-102020125178; DE-102020125179; DE-102020125180; DE-102020125181; DE-102020125182; DE-102020125183; DE-102020125185; DE-102020125186; DE-102020125187; DE-102020125188; DE-102020125189; DE-102020125190; DE-102020125191; DE-102020201688; DE-102021005497; DE-102021121877; DE-10218695; DE-112012001735; DE-112012003764; DE-112012005798; DE-112014000501; DE-112016001769; DE-112016003215; DE-112016004439; DE-112016005278; DE-112017003036; DE-112017003044; DE-112017003719; DE-112017004725; DE-112017004860; DE-112017007187; DE-112017007873; DE-112017007921; DE-112020002985; DE-19634808; DE-19649500; DE-19705239; DE-19741483; DE-19927661; DE-19954265; DE-19964555; DE-202017105268; DE-202020005427; DE-4441766; DE-602005005035; DE-60212967; EP-0835555; EP-0922333; EP-0985939; EP-1001473; EP-1030380; EP-1069687; EP-1245002; EP-1324549; EP-1370948; EP-1370961; EP-1370968; EP-1370969; EP-1370971; EP-1395947; EP-1468303; EP-1518208; EP-1561277; EP-1620800; EP-1623317; EP-1639463; EP-1658564; EP-1660403; EP-1669911; EP-1677193; EP-1690218; EP-1696318; EP-1697558; EP-1702264; EP-1716486; EP-1725935; EP-1730635; EP-1733296; EP-1769347; EP-1779668; EP-1800214; EP-1803062; EP-1805575; EP-1805626; EP-1805627; EP-1834245; EP-1836635; EP-1839165; EP-1842227; EP-1846820; EP-1846829; EP-1846895; EP-1851637; EP-1854016; EP-1861790; EP-1884791; EP-1974315; EP-1975590; EP-19755909; EP-2021929; EP-2097936; EP-2143044; EP-2149196; EP-2263332; EP-2296090; EP-2304654; EP-2309562; EP-2397004; EP-2401776; EP-2425609; EP-2443469; EP-2446069; EP-2457354; EP-2476119; EP-2504777; EP-2519870; EP-2585987; EP-2591514; EP-2609541; EP-2638448; EP-2659365; EP-2691996; EP-2707832; EP-2707903; EP-2710471; EP-2730029; EP-2774077; EP-2797038; EP-2803211; EP-2904540; EP-2919172; EP-29191729; EP-2945160; EP-2946413; EP-2946414; EP-3039174; EP-3058618; EP-3075123; EP-3098865; EP-3111379; EP-3111380; EP-3111381; EP-3113084; EP-3114618; EP-3127266; EP-3130031; EP-3132209; EP-3164889; EP-3170259; EP-3195377; EP-3217336; EP-3224640; EP-3231092; EP-3248210; EP-3250792; EP-3254241; EP-3254375; EP-3262573; EP-3262762; EP-3266063; EP-3284115; EP-3296932; EP-3300004; EP-3304363; EP-3332363; EP-3344576; EP-3360253; EP-3378162; EP-3380995; EP-3380996; EP-3383793; EP-3391415; EP-3394905; EP-3398213; EP-3411080; EP-3414583; EP-3422412; EP-3427310; EP-3475217; EP-3475760; EP-3476048; EP-3488474; EP-3491586; EP-3497726; EP-3513249; EP-3513434; EP-3513443; EP-3513631; EP-3514723; EP-3516407; EP-3516596; EP-3520039; EP-3539061; EP-3542320; EP-3542321; EP-3542463; EP-3545563; EP-3563308; EP-3563309; EP-3563310; EP-3568128; EP-3574455; EP-3576025; EP-3576142; EP-3577700; EP-3580701; EP-3580702; EP-3583626; EP-3589581; EP-3593296; EP-3593297; EP-3593298; EP-3596669; EP-3610519; EP-3613141; EP-3619655;

EP-3634442; EP-3635726; EP-3639295; EP-3642959; EP-3660179; EP-3662515; EP-3673487; EP-3676882; EP-3682381; EP-3682382; EP-3685321; EP-3685322; EP-3685323; EP-3685451; EP-3689113; EP-3692476; EP-3703141; EP-3704794; EP-3707649; EP-3711004; EP-3718059; EP-3718166; EP-3718207; EP-3718208; EP-3724827; EP-3724828; EP-3724829; EP-3724933; EP-3735392; EP-3735710; EP-3735711; EP-3735712; EP-3738206; EP-3738209; EP-3738210; EP-3740910; EP-3744001; EP-3745481; EP-3746953; EP-3746954; EP-3759659; EP-3769271; EP-3769347; EP-3776390; EP-3782089; EP-3785185; EP-3785186; EP-3788562; EP-3788563; EP-3788565; EP-3788657; EP-3789932; EP-3791334; EP-3795950; EP-3803719; EP-3805423; EP-3807825; EP-3807972; EP-3814905; EP-3815006; EP-3818173; EP-3822871; EP-3824415; EP-3827381; EP-3828782; EP-3830625; EP-3830867; EP-3830953; EP-3835916; EP-3836038; EP-3837646; EP-3837647; EP-3844684; EP-3844687; EP-3844688; EP-3847701; EP-3850478; EP-3852021; EP-3853943; EP-3857619; EP-3861488; EP-3861489; EP-3861588; EP-3864110; EP-3864403; EP-3864586; EP-3867829; EP-3867972; EP-3869420; EP-3871162; EP-3886003; EP-3886321; EP-3888018; EP-3888019; EP-3888020; EP-3895078; EP-3899814; EP-3903375; EP-3903415; EP-3907669; EP-3908988; EP-3908989; EP-3910415; EP-3912107; EP-3912200; EP-3918538; EP-3928260; EP-3931765; EP-3935583; EP-3939160; EP-3939165; EP-3942362; EP-3948697; EP-3948698; EP-3948953; EP-3956770; EP-3956824; EP-3959666; EP-3963518; EP-3966751; EP-3970084; EP-3970272; EP-3971793; EP-3983958; EP-3983961; EP-3983962; EP-3983963; EP-3983964; EP-3987462; EP-3989130; EP-3991104; EP-3992868; ES-2346045; ES-2849257; ES-2850151; FI-128904; FI-129128; FI-129520; FI-20195045; FI-20205115; FR-2855921; FR-2862151; FR-3021163; FR-3090891; GB-2482008; GB-2524039; GB-2553848; GB-2592935; GB-2598059; IL-245788; IL-260859; IL-283799; IL-2837990; IL-286336; IL-2863360; IL-286366; IL-2863660; IL-286404; IL-2864040; IL-286612; IL-2866120; IL-288973; IL-2889730; IN-2006KN00539; IN-2006KN01207; IN-2008CN03914; IN-2011DN10030; IN-201847025509; IN-201847025527; IN-201947035669; IN-202047029322; IN-242559; JP-2000150973; JP-2000244308; JP-2000260187; JP-2001060862; JP-2001068995; JP-2001119300; JP-2001504647; JP-2002135111; JP-2002237749; JP-2002342165; JP-2002344307; JP-2002351850; JP-2002358289; JP-2002366533; JP-2002366534; JP-2003069418; JP-2003271570; JP-2003281107; JP-2003303134; JP-2003519927; JP-2004015151; JP-2004032481; JP-2004046861; JP-2004071630; JP-2004072141; JP-2004072305; JP-2004078979; JP-2004252990; JP-2004533061; JP-2005079749; JP-2005093511; JP-2005100405; JP-2005166056; JP-2005235228; JP-2005235229; JP-2005259812; JP-2005260364; JP-2005267635; JP-2005285123; JP-2005285124; JP-2005322232; JP-2005322240; JP-2005332402; JP-2005339557; JP-2005346327; JP-2005513600; JP-2005527902; JP-2006040451; JP-2006065864; JP-2006092541; JP-2006092542; JP-2006099774; JP-2006107513; JP-2006107514; JP-2006120147; JP-2006139785; JP-2006146921; JP-2006165812; JP-2006172468; JP-2006172474; JP-2006178987; JP-2006190299; JP-2006190301; JP-2006196004; JP-2006202287; JP-2006216058; JP-2006216060; JP-2006221638; JP-2006221639; JP-2006221642; JP-2006221643; JP-2006221644; JP-2006221645; JP-2006260555; JP-2006260556; JP-2006268928; JP-2006286002; JP-2006318470; JP-2006318477; JP-2006323824; JP-2006323829; JP-2006506010; JP-2006512270; JP-2007042074; JP-2007049009; JP-20070490095; JP-2007053247; JP-2007104332; JP-2007214885; JP-2007250771; JP-2007287933; JP-2007516610; JP-2007521397; JP-2007534144; JP-2008047678; JP-2008077640; JP-2008108927; JP-2008182157; JP-2008526682; JP-2009003946; JP-2009016767; JP-2009049631; JP-2009182745; JP-2009194646; JP-2009217845; JP-2009225213; JP-2009302219; JP-2009503624; JP-2009508179; JP-2009524857; JP-2010092499; JP-2010109697; JP-2010199343; JP-2010213210; JP-2010271087; JP-2010511293; JP-2010525431; JP-2011082515; JP-2011197875; JP-2011523747; JP-2012015878; JP-2012026738; JP-2012064622; JP-2012519379; JP-2012530674; JP-2012530895; JP-2012531876; JP-2013058705; JP-2013058997; JP-2013058998; JP-2013535805; JP-2014166956; JP-2014215985; JP-2014216596; JP-2014241073; JP-2014504057; JP-2014523705; JP-2014525161; JP-2015015590; JP-2015035129; JP-2015155377; JP-2015167176; JP-2015508253; JP-2015511067; JP-2016042521; JP-2016045001; JP-2016058441; JP-2016151561; JP-2016509800; JP-2016510497; JP-2016511534; JP-2016518637; JP-2016539607; JP-2016541146; JP-2017073106; JP-2017175155; JP-2017511463; JP-2017517918; JP-2017518629; JP-2017529695; JP-2017532841; JP-2017533572; JP-2018129535; JP-2018136316; JP-2018503249; JP-2018511848; JP-2018512729; JP-2018514094; JP-2018514104; JP-2018516456; JP-2018524667; JP-2018529142; JP-2018532177; JP-2018533253; JP-2018536324; JP-2018538681; JP-2019003975; JP-2019036625; JP-20190366255; JP-2019041088; JP-2019041121; JP-2019047126; JP-2019050399; JP-2019145800; JP-2019186418; JP-2019501581; JP-2019504511; JP-2019504527; JP-2019505989; JP-2019508819; JP-2019508876; JP-2019511562; JP-2019512112; JP-2019513249; JP-2019525452; JP-2019530051; JP-2019530336; JP-2019532505; JP-2019532506; JP-2019532507; JP-2019532520; JP-2019534551; JP-2019534555; JP-2019537241; JP-2019537882; JP-2020010337; JP-2020038976; JP-2020047999; JP-2020065261; JP-2020074351; JP-2020127032; JP-2020501216; JP-2020502551; JP-2020503690; JP-2020503694; JP-2020503706; JP-2020504466; JP-2020509608; JP-2020510309; JP-2020511794; JP-2020513610; JP-2020519005; JP-2020520084; JP-2020522120; JP-2020522128; JP-2020522805; JP-2020522892; JP-2020532099; JP-2020532865; JP-2020532866; JP-2020533705; JP-2020533804; JP-2020534607; JP-2020535461; JP-2020535690; JP-2020535747; JP-2020536376; JP-2020536397; JP-2021087004; JP-2021090075; JP-2021103093; JP-2021118342; JP-2021121946; JP-2021141318; JP-2021141319; JP-2021157798; JP-2021175178; JP-2021500737; JP-2021500781; JP-2021500783; JP-2021501499; JP-2021504956; JP-2021504964; JP-2021506045; JP-2021509244; JP-2021509748; JP-2021509771; JP-2021509982; JP-2021511657; JP-2021511659; JP-2021512395; JP-2021512396; JP-2021515395; JP-2021516389; JP-2021518655; JP-2021519459; JP-2021521550; JP-2021524198; JP-2021530040; JP-2021530042; JP-2021531544; JP-2021531578; JP-2021532396; JP-2021532514; JP-2021532629; JP-2021533345; JP-2021535592; JP-2021535593; JP-2021536666; JP-2022003576; JP-2022010223; JP-2022069496; JP-2022069525; JP-2022500776; JP-2022501802; JP-2022501885; JP-2022502836; JP-2022509003; JP-2022509907; JP-2022511331; JP-2022511376; JP-2022512281; JP-2022513533; JP-2022517773; JP-2022518863; JP-2022520689; JP-2022522757; JP-2022525909; JP-2022525910; JP-2679610; JP-2688011; JP-2768276; JP-2931787; JP-2962251; JP-3107034; JP-3325545; JP-3411273; JP-3454808; JP-3483877; JP-3488663; JP-3515985; JP-3519303; JP-3647795; JP-3648551; JP-3696563; JP-3705252; JP-3802042; JP-3821405; JP-3936889; JP-3983250; JP-4015159; JP-4023546; JP-4024271; JP-4044807; JP-4053547; JP-4113077; JP-4116978; JP-4134182; JP-4176787; JP-4183712; JP-4219369; JP-4243318; JP-4246204; JP-4255457; JP-4286826; JP-4316574; JP-4322259; JP-4334521; JP-4334901; JP-4339307; JP-4346612; JP-4364202; JP-4386373; JP-4386883; JP-4408079; JP-4421561; JP-4451397; JP-4455822; JP-4489399; JP-4507791; JP-4524126; JP-4524784; JP-4526412; JP-4527029; JP-4578366; JP-4583327; JP-4597553; JP-4609733; JP-4645973; JP-4681755; JP-4712328; JP-4733085; JP-4756718; JP-4768386; JP-4769938; JP-4777718; JP-4792328; JP-4805341; JP-4836028; JP-4855255; JP-4913501; JP-4925012; JP-4955961; JP-5020181; JP-5048350; JP-5062659; JP-5078979; JP-5092596; JP-5093515; JP-5167504; JP-5414031; JP-5432073; JP-5497596; JP-5513188; JP-5520939; JP-5567669; JP-5579563; JP-5638770; JP-5669832; JP-5674603; JP-5750194; JP-5766350; JP-5877428; JP-5956392; JP-5976641; JP-6028307; JP-6029070; JP-6030591; JP-6042777; JP-6066314; JP-6087716; JP-6230123; JP-6247177; JP-6326379; JP-6347489; JP-6360499; JP-6379298; JP-6395736; JP-6396726; JP-6397509; JP-6415737; JP-6437607; JP-6461009; JP-6498752; JP-6530326; JP-6534741; JP-6553287; JP-6556952; JP-6590446; JP-6609066; JP-6617197; JP-6656273; JP-6678102; JP-6684366; JP-6704086; JP-6706391; JP-6734873; JP-6742028; JP-6742433; JP-6744379; JP-6749382; JP-6771009; JP-6771660; JP-6776187; JP-6779278; JP-6785219; JP-6788734; JP-6789385; JP-6790245; JP-6802266; JP-6802383; JP-6810280; JP-6831452; JP-6840237; JP-6840818; JP-6845238; JP-6849858; JP-6852187; JP-6853141; JP-6861245; JP-6864812; JP-6877050; JP-6882533; JP-6884273; JP-6894378; JP-6912559; JP-6931071; JP-6936313; JP-6941166; JP-6941230; JP-6947408; JP-6964079; JP-6974470; JP-6974473; JP-6977176; JP-6986627; JP-6998459; JP-7005748; JP-7005786; JP-7033658; JP-7035169; JP-7039689; JP-7047230; JP-7050153; JP-70501536; JP-7052042; JP-7058014; JP-7064057; JP-7064599; JP-H07235699; JP-H08172352; JP-H08340136; JP-H09198876; JP-H09219542; JP-H09237923; JP-H09246608; JP-H10269783; JP-H11261384; JP-H11311663; JP-H11312971; JP-H1140866; JP-H11508747; JP-WO2006011451; JP-WO2007077984; JP-WO20070779846; JP-WO2008029815; JP-WO2020179554; JP-WO2020213596; KR-100282356; KR-100388497; KR-100724098; KR-100777600; KR-100829287; KR-100832192; KR-100840113; KR-100841864; KR-100847982; KR-100866739; KR-100875030; KR-100878424; KR-100881539; KR-100881810; KR-100890134; KR-100891063; KR-100933389; KR-100938942; KR-100959748; KR-101052209; KR-101189972; KR-101309677; KR-101747455; KR-101822326; KR-101899842; KR-101901166; KR-101929207; KR-101936533; KR-102031584; KR-102035149; KR-102063563; KR-102088675; KR-102098081; KR-102109070; KR-102116277; KR-102158678; KR-102173099; KR-102174976; KR-102193846; KR-102196240; KR-102208348; KR-102211013; KR-102217205; KR-102241971; KR-102247626; KR-102250154; KR-102250155; KR-102252438; KR-102279157; KR-102283357; KR-102318773; KR-102319393; KR-102389777; KR-102390936; KR-102400989; KR-19990028555; KR-19990065792; KR-20020092038; KR-20030081532; KR-20030085037; KR-20030085038; KR-20030086319; KR-20030086320; KR-20060063977; KR-20060096109; KR-20060121266; KR-20060127120; KR-20060127859; KR-20060132852; KR-20070007775; KR-20070052311; KR-20070073825; KR-20070085411; KR-20070089998; KR-20070098900; KR-20070100336; KR-20080106911; KR-20080108588; KR-20100056622; KR-20110002020; KR-20110040705; KR-20110046390; KR-20130045831; KR-20140140474; KR-20160072187; KR-20160089410; KR-20160140913; KR-20160147988; KR-20170013224; KR-20170048470; KR-20170085533; KR-20170089880; KR-20170103866; KR-20170106364; KR-20170127476; KR-20170134399; KR-20180004132; KR-20180022925; KR-20180043802; KR-20180069026; KR-20180090857; KR-20180102581; KR-20180112833; KR-20180122596; KR-20190015330; KR-20190035819; KR-20190042720; KR-20190043170; KR-20190045362; KR-20190047022; KR-20190052109; KR-20190077518; KR-20190094418; KR-20190100344; KR-20190113923; KR-20190116452; KR-20190123313; KR-20200016336; KR-20200038546; KR-20200040839; KR-20200040862; KR-20200051769; KR-20200052367; KR-20200065032; KR-20200097787; KR-20200103786; KR-20200104374; KR-20200105510; KR-20200105517; KR-20200106535; KR-20200127052; KR-20210011433; KR-20210024638; KR-20210054034; KR-20210055806; KR-20210095784; KR-20210106452; KR-20210113669; KR-20210118459; KR-20210120869; KR-20210123400; KR-20210125035; KR-20210129186; KR-20210130209; KR-20210134031; KR-20210134688; KR-20210136986; KR-20210138678; KR-20220002366; KR-20220031998; KR-20220041156; KR-20220042440; KR-20220043190; KR-20220044944; KR-20220047753; NL-2016442; NL-2018253; NL-2024742; Publication Number; RU-177295; RU-2599904; RU-2612847; RU-2682559; RU-2716028; RU-2742504; SE-512591; TW-200525428; TW-200532471; TW-200540705; TW-201731071; TW-201814902; TW-201930633; TW-202007091; TW-202011286; TW-202107744; TW-202107837; TW-202115625; TW-202121267; TW-202123097; TW-202205159; TW-202215309; TW-461105; TW-574653; TW-594492; TW-1227401; TW-1274283; TW-1291656; TW-1292880; TW-I293157; TW-1306552; TW-1314285; TW-1314286; TW-1321414; TW-1326426; TW-1338844; TW-1345155; TW-1352905; TW-1361981; TW-1713194; UA-104982; WO-1997002661; WO-1998008307; WO-19980083079; WO-1999017449; WO-2001010027; WO-2001039283; WO-2001050534; WO-2002063430; WO-2002069498; WO-2002077826; WO-2002077838; WO-2002077845; WO-2002077846; WO-2002077848; WO-2002084337; WO-2002086813; WO-2002097725; WO-2003019685; WO-2003025725; WO-2003052438; WO-2003052687; WO-2003082482; WO-2003090162; WO-2004013808; WO-2004013965; WO-2004019270; WO-2004045063; WO-2004086295; WO-2004102470; WO-2004109924; WO-2005010953; WO-2005019095; WO-2005048183; WO-2005055057; WO-2005069392; WO-2005081104; WO-2005081105; WO-2005088443; WO-2005089092; WO-2005093564; WO-2005093649; WO-2005096150; WO-2005106647; WO-2005106662; WO-2005111799; WO-2005116839; WO-2006011451; WO-2006019188; WO-2006033419; WO-2006033423; WO-2006035989; WO-2006038714; WO-2006038717; WO-2006041218; WO-2006043300; WO-2006052017; WO-2006064961; WO-2006064962; WO-2006073204; WO-2006076354; WO-2006078002; WO-2006083043; WO-2006083045; WO-2006083046; WO-2006085636; WO-2006085639; WO-2006085641; WO-2006085665; WO-2006098499; WO-2006121175; WO-2006121211; WO-2006127495; WO-2007077617; WO-2007077984; WO-2007085074; WO-2007086542; WO-2007129786; WO-2007135783; WO-2008006217; WO-2008024368; WO-2008029815; WO-2008064491; WO-2008128338; WO-2008147769; WO-2008150341; WO-2009019040; WO-2009114738; WO-2009117003; WO-2010011409; WO-2010051580; WO-2010092545; WO-2010099312; WO-2010125233; WO-2010145631; WO-2010149775; WO-2011064440; WO-2011088399; WO-2012003821; WO-2012007736; WO-2012025665; WO-2012030319; WO-2012064974; WO-2012089904; WO-2012113983; WO-2012123642; WO-2012135683; WO-2012153000; WO-2012173712; WO-2012174366; WO-2013006375; WO-2013034801; WO-2013035512; WO-2013104822; WO-2013126120; WO-2013160531; WO-2013180780; WO-2014006567; WO-2014053697; WO-2014075296; WO-2014092819; WO-2014140943; WO-2014163728; WO-2014168665; WO-2014197047; WO-2014197048; WO-2014197095; WO-2015014549; WO-2015036266; WO-2015057839; WO-2015081107; WO-2015127498; WO-2015153056; WO-2015159258; WO-2015178990; WO-2015178991; WO-2015178992; WO-2015183535; WO-2016000836; WO-2016003626; WO-2016020648; WO-2016022689; WO-2016025598; WO-2016049446; WO-2016061114; WO-2016076935; WO-2016083140; WO-2016094045; WO-2016118821; WO-2016126979; WO-2016126981; WO-2016138395; WO-2016138406; WO-2016168642; WO-2016183213; WO-2016199029; WO-2016200845; WO-2017001404; WO-2017015432; WO-2017015532; WO-2017021714; WO-2017040598; WO-2017055946; WO-2017059104; WO-2017062143; WO-2017065934; WO-2017079394; WO-20170793949; WO-2017079417; WO-2017079424; WO-2017082983; WO-2017087070; WO-2017089891; WO-2017100078; WO-2017103694; WO-2017105429; WO-2017105524; WO-2017111949; WO-2017115008; WO-2017115160; WO-2017116442; WO-2017131831; WO-2017136450; WO-2017139683; WO-2017151200; WO-2017152287; WO-2017155531; WO-2017158134; WO-2017217958; WO-2017217959; WO-2017217960; WO-2017217961; WO-2017222806; WO-2018004578; WO-2018004634; WO-2018004635; WO-2018004636; WO-2018009240; WO-2018030977; WO-2018034638; WO-2018035448; WO-2018038707; WO-2018051123; WO-2018052397; WO-2018052399; WO-2018052414; WO-2018052424; WO-2018052427; WO-2018052465; WO-2018052466; WO-2018055467; WO-2018055607; WO-2018057024; WO-2018060981; WO-2018062991; WO-2018063139; WO-2018063168; WO-2018063205; WO-2018063206; WO-2018069908; WO-2018073668; WO-2018075106; WO-2018089850; WO-2018093545; WO-2018106215; WO-2018106222; WO-2018111242; WO-2018125026; WO-2018125513; WO-2018125543; WO-2018125604; WO-2018132769; WO-2018139928; WO-2018144601; WO-2018159832; WO-2018160184; WO-2018160185; WO-2018160187; WO-2018160674; WO-2018162965; WO-2018165021; WO-2018165500; WO-2018165607; WO-2018169579; WO-2018169585; WO-2018182571; WO-2018182584; WO-2018185306; WO-2018191041; WO-2018192674; WO-2018217351; WO-2018219484; WO-2018223037; WO-2018226586; WO-2018231212; WO-2018231241; WO-2018236374; WO-2018236922; WO-2019004991; WO-2019025019; WO-2019032114; WO-2019032115; WO-2019038409; WO-2019040098; WO-2019045762; WO-2019045763; WO-2019050525; WO-2019054990; WO-2019054995; WO-2019055002; WO-2019055038; WO-2019055048; WO-2019057317; WO-2019059879; WO-2019063113; WO-2019063116; WO-2019070228; WO-2019070265; WO-2019077397; WO-2019077398; WO-2019077399; WO-2019084286; WO-2019086943; WO-2019089141; WO-2019089603; WO-2019105630; WO-2019106416; WO-2019108512; WO-2019116103; WO-2019117883; WO-2019117922; WO-2019117929; WO-2019117930; WO-2019117949; WO-2019117954; WO-2019117955; WO-2019117972; WO-2019117973; WO-2019117974; WO-2019117975; WO-2019118442; WO-2019125423; WO-2019125498; WO-2019126396; WO-2019132963; WO-2019136213; WO-2019139799; WO-2019139800; WO-2019143680; WO-2019152019; WO-2019152020; WO-2019156759; WO-2019156760; WO-2019164591; WO-2019168721; WO-2019173651; WO-2019173799; WO-2019178009; WO-2019179732; WO-2019179740; WO-2019183602; WO-2019190460; WO-2019204680; WO-2019217772; WO-2019222514; WO-2019224789; WO-2019229527; WO-2019236137; WO-2019241570; WO-2019245740; WO-2020005963; WO-2020010147; WO-2020010214; WO-2020018797; WO-2020019015; WO-2020025458; WO-2020025460; WO-2020027779; WO-2020028325; WO-2020028650; WO-2020033807; WO-2020033974; WO-2020036673; WO-2020036707; WO-2020037253; WO-2020037300; WO-2020037301; WO-2020043415; WO-2020043596; WO-2020043597; WO-2020046928; WO-2020048842; WO-2020055450; WO-2020056176; WO-2020058002; WO-2020068237; WO-20200682379; WO-2020069623; WO-2020069883; WO-2020072661; WO-2020072819; WO-2020074742; WO-2020077288; WO-20200772889; WO-2020078777; WO-2020078849; WO-2020081805; WO-2020083618; WO-2020086867; WO-2020104206; WO-2020106313; WO-2020106955; WO-2020109106; WO-2020109107; WO-2020109869; WO-2020112185; WO-2020120183; WO-2020127299; WO-2020139407; WO-2020142122; WO-2020145854; WO-2020146025; WO-20201460259; WO-2020146083; WO-2020146794; WO-2020148565; WO-2020150348; WO-2020152393; WO-2020156680; WO-2020169224; WO-2020178640; WO-2020179554; WO-2020180442; WO-2020180902; WO-2020183060; WO-2020186076; WO-2020197575; WO-2020200782; WO-2020200801; WO-2020212092; WO-2020213596; WO-2020214910; WO-2020219578; WO-2020222044; WO-2020227385; WO-2020231378; WO-2020231795; WO-2020236587; WO-2020252157; WO-2020252425; WO-2020253292; WO-2020254055; WO-2020257772; WO-2020259813; WO-2020263255; WO-2020263278; WO-2021007153; WO-2021008796; WO-2021011765; WO-2021015789; WO-2021016542; WO-2021018466; WO-2021019294; WO-2021021398; WO-2021022217; WO-2021022375; WO-2021022376; WO-2021026070; WO-2021029095; WO-2021034404; WO-2021044210; WO-2021044212; WO-2021046184; WO-2021046495; WO-2021050541; WO-2021051163; WO-2021055000; WO-2021055507; WO-2021056115; WO-2021059013; WO-2021061776; WO-2021062331; WO-2021067023; WO-2021076221; WO-2021076808; WO-2021077691; WO-2021080789; WO-2021083448; WO-2021087206; WO-2021091600; WO-2021092351; WO-2021093977; WO-2021096955; WO-2021101829; WO-2021102321; WO-2021102344; WO-2021105100; WO-2021107949; WO-2021108487; WO-2021111961; WO-2021113513; WO-2021118867; WO-2021123903; WO-2021132009; WO-2021140995; WO-2021146028; WO-2021148311; WO-2021150101; WO-2021155289; WO-2021156538; WO-2021162981; WO-2021163032; WO-2021163487; WO-2021165639; WO-2021168019; WO-2021168096; WO-2021176974; WO-2021178042; WO-2021178562; WO-2021181059; WO-2021181155; WO-2021183344; WO-2021185595; WO-2021188193; WO-2021191501; WO-2021195368; WO-2021201954; WO-2021202405; WO-2021202409; WO-2021202687; WO-2021211657; WO-2021216497; WO-2021223964; WO-2021223983; WO-2021224551; WO-2021229388; WO-2021231224; WO-2021236725; WO-2021237362; WO-2021247125; WO-2021247540; WO-2021247656; WO-2021247878; WO-2021249759; WO-2021253404; WO-2021255055; WO-2021259711; WO-2021262741; WO-2022002881; WO-2022003450; WO-2022004921; WO-2022015399; WO-2022018038; WO-2022018170; WO-2022020951; WO-2022023913; WO-2022031348; WO-2022036422; WO-2022037958; WO-2022038205; WO-2022043020; WO-2022043297; WO-2022048399; WO-2022051030; WO-2022053561; WO-2022054992; WO-2022058025; WO-2022058285; WO-2022058381; WO-2022060897; WO-2022060950; WO-2022060954; WO-2022060957; WO-2022060959; WO-2022060962; WO-2022060964; WO-2022073380; WO-2022074041; WO-2022081675; WO-2022084350; WO-2022084778; WO-2022086751; WO-2022087143; WO-2022092815; WO-2022093575; WO-2022093618; and ZA-200207825.

### SUMMARY OF THE INVENTION

A quantum computer requires many qubits and couplers with well-defined and precise energies. Superconducting quantum computers are fabricated from integrated circuits comprising a plurality of Josephson junctions. In practice, due to the spread in the fabrication processes of Josephson junctions, the fabricated qubits will possess energies that are slightly different from the design parameters. Such variations in the energy of qubits and coupler make it difficult to accurately perform single and multi-qubit operations in the quantum computer, particularly as the number of coupled qubits increase. An external energy tuning of the qubits through flux biasing may compensate for the inherent variation of the fabrication process, and permit additional degrees of control. Precisely controlled flux biasing of superconducting circuits is necessary to achieve the desired quantum behavior in scalable quantum computing systems.

In addition to compensation for the fabrication variation, the controllability of the energy of the quantum circuit such as qubits and quantum coupler enables certain functions and properties. As an example, by changing the energy of the qubits and quantum couplers, we can increase or decrease the interaction with other components in a quantum circuit. This enables deliberate coupling and decoupling of different quantum components based on the desired functionality. For example, to enable two-qubit or multi-qubit gate operation, the energies of the coupler or the qubits may be tuned to enable interaction among them. Similarly, a qubit may be decoupled from other qubits or couplers by detuning the energy through the flux biasing. Change of flux biasing to increase coupling enables multi-qubit and coupler gate operations, whereas the change of flux biasing to decouple quantum components enables preserving the quantum coherence by decreasing interaction.

Finally, one can execute single or two-qubit gate operations by applying the generated fast flux bias pulses to execute high-fidelity qubit control. Such control can be done using a universal set of flux pulses, in which qubit gates are completed within a single or multiple Larmor periods. The basic principle of SFQ flux biasing according to the present invention is as follows. A superconducting storage loop is magnetically coupled to the quantum circuit. To change the amount of the flux biasing of the qubits or couplers, SFQ pulses are added or removed from the storage loop as shown in FIG. 1.

The resolution, amount of coupling, and the speed of the change of flux biasing can be controlled through different design parameters of the transformer, i.e., Lin, Lout, M, and SFQ circuits and/or the qubit/coupler.

Li, X., T. Cai, H. Yan, Z. Wang, X. Pan, Y. Ma, W. Cai et al. “Tunable coupler for realizing a controlled-phase gate with dynamically decoupled regime in a superconducting circuit.” Physical Review Applied 14, no. 2 (2020): 024070, discloses a tunable and switchable qubit coupler. Controllable interaction between superconducting qubits is desirable for large-scale quantum computation and simulation. Based on Yan et al. [Phys. Rev. Appl. 10, 054061 (2018)], a flux-controlled tunable coupler with a continuous tunability by adjusting the coupler frequency, which can completely turn off adjacent superconducting qubit coupling was tested. Utilizing the tunable interaction between two qubits via the coupler, a controlled-phase (CZ) gate with dynamically decoupled regime, which allows the qubit-qubit coupling to be only “on” at the usual operating point while dynamically “off” during the tuning process of one qubit frequency into and out of the operating point. This efficiently suppresses the leakage out of the computational subspace, but also allows for the acquired two-qubit phase being geometric at the operating point. See also:

Sung, Youngkyu, Leon Ding, Jochen Braumüller, Antti Vepsäläinen, Bharath Kannan, Morten Kjaergaard, Ami Greene et al. “Realization of High-Fidelity CZ and Z Z-Free iSWAP Gates with a Tunable Coupler.” Physical Review X 11, no. 2 (2021): 021058.

Allman, Michael S., Fabio Altomare, Jed D. Whittaker, Katarina Cicak, Dale Li, Adam Sirois, Joshua Strong, John D. Teufel, and Raymond W. Simmonds. “rf-SQUID-mediated coherent tunable coupling between a superconducting phase qubit and a lumped-element resonator.” Physical review letters 104, no. 17 (2010): 177004.

Han, X. Y., T. Q. Cai, X. G. Li, Y. K. Wu, Y. W. Ma, Y. L. Ma, J. H. Wang, H. Y. Zhang, Y. P. Song, and L. M. Duan. “Error analysis in suppression of unwanted qubit interactions for a parametric gate in a tunable superconducting circuit.” Physical Review A 102, no. 2 (2020): 022619.

Harris, R., A. J. Berkley, M. W. Johnson, P. Bunyk, S. Govorkov, M. C. Thom, S. Uchaikin et al. “Sign-and magnitude-tunable coupler for superconducting flux qubits.” Physical review letters 98, no. 17 (2007): 177001.

Xu, Huikai, Weiyang Liu, Zhiyuan Li, Jiaxiu Han, Jingning Zhang, Kehuan Linghu, Yongchao Li et al. “Realization of adiabatic and diabatic CZ gates in superconducting qubits coupled with a tunable coupler.” Chinese Physics B 30, no. 4 (2021): 044212.

Yang, Chui-Ping, Qi-Ping Su, Shi-Biao Zheng, and Siyuan Han. “One-step transfer or exchange of arbitrary multipartite quantum states with a single-qubit coupler.” Physical Review B 92, no. 5 (2015): 054509.

Van der Ploeg, S. H. W., A. Izmalkov, Alec Maassen van den Brink, U. Hübner, M. Grajcar, E. Il′Ichev, H-G. Meyer, and A. M. Zagoskin. “Controllable coupling of superconducting flux qubits.” Physical review letters 98, no. 5 (2007): 057004.

Zajac, D. M., J. Stehlik, D. L. Underwood, T. Phung, J. Blair, S. Carnevale, D. Klaus et al. “Spectator errors in tunable coupling architectures.” arXiv preprint arXiv: 2108.11221 (2021).

McKay, David C., Stefan Filipp, Antonio Mezzacapo, Easwar Magesan, Jerry M. Chow, and Jay M. Gambetta. “Tunable coupling between fixed-frequency superconducting transmon qubits, Part II: Implementing a two-qubit XX-90 gate.” In APS March Meeting Abstracts, vol. 2016, pp. F48-008. 2016.

Jin, Lijing. “Implementing High-fidelity Two-Qubit Gates in Superconducting Coupler Architecture with Novel Parameter Regions.” arXiv preprint arXiv: 2105.13306 (2021).

Quintana, Chris, Yu Chen, D. Sank, D. Kafri, A. Megrant, T. C. White, A. Shabani et al. “Coplanar waveguide flux qubit suitable for quantum annealing.” In APS March Meeting Abstracts, vol. 2016, pp. K48-010. 2016.

Kafri, Dvir, Chris Quintana, Yu Chen, Alireza Shabani, John M. Martinis, and Hartmut Neven. “Tunable inductive coupling of superconducting qubits in the strongly nonlinear regime.” Physical Review A 95, no. 5 (2017): 052333.

Wulschner, Friedrich, Jan Goetz, Fabian R. Koessel, Elisabeth Hoffmann, Alexander Baust, Peter Eder, Michael Fischer et al. “Tunable coupling of transmission-line microwave resonators mediated by an rf SQUID.” EPJ Quantum Technology 3, no. 1 (2016): 1-10.

Xu, Xuexin, and M. H. Ansari. “Parasitic-free gate: A protected switch between idle and entangled states.” arXiv preprint arXiv: 2202.05208 (2022).

Xu, Yuan, Ji Chu, Jiahao Yuan, Jiawei Qiu, Yuxuan Zhou, Libo Zhang, Xinsheng Tan et al. “High-fidelity, high-scalability two-qubit gate scheme for superconducting qubits.” Physical Review Letters 125, no. 24 (2020): 240503.

Groszkowski, Peter, Austin G. Fowler, Felix Motzoi, and Frank K. Wilhelm. “Tunable coupling between three qubits as a building block for a superconducting quantum computer.” Physical Review B 84, no. 14 (2011): 144516.

Di Paolo, Agustin, Catherine Leroux, Thomas M. Hazard, Kyle Serniak, Simon Gustavsson, Alexandre Blais, and William D. Oliver. “Extensible circuit-QED architecture via amplitude-and frequency-variable microwaves.” arXiv preprint arXiv: 2204.08098 (2022).

Nägele, Maximilian, Christian Schweizer, Federico Roy, and Stefan Filipp. “Effective non-local parity-dependent couplings in qubit chains.” arXiv preprint arXiv: 2203.07331 (2022).

McCourt, Trevor, Charles Neill, Kenny Lee, Chris Quintana, Yu Chen, Julian Kelly, V. N. Smelyanskiy et al. “Learning Noise via Dynamical Decoupling of Entangled Qubits.” arXiv preprint arXiv: 2201.11173 (2022).

He, Yongcheng, Jianshe Liu, Changhao Zhao, Rutian Huang, Genting Dai, and Wei Chen. “Control System of Superconducting Quantum Computers.” Journal of Superconductivity and Novel Magnetism (2022): 1-21.

The circuit to add or remove flux could be designed in many ways. The simplest approach is using Josephson Transmission lines (JTLs) as shown in FIG. 2. In FIG. 2, the chain of JTLs could be amplifying JTLs to increase the number of fluxons that can be stored in Lin.

A more scalable approach uses parallel JTLs to increase the capacity of stored fluxons in the loop and, therefore, the induced current through inductor Lin as shown in FIG. 3. In the circuit shown in FIG. 4, the number of parallel JTLs could be arbitrary large from 1 to n, depending on the specifics of the flux biasing design. The circuit simulation of this circuit is shown in FIG. 4.

It is possible to create different profiles of the flux biasing over time using this technique. In FIG. 5, a sample time and amplitude-varying flux biasing is shown. The flux biasing can be either positive or negative. The SFQ circuit to add or remove flux to the flux biasing circuit in FIG. 1 could be designed for a specific profile or time dependence of the flux biasing. The slew rate of the rising and falling edges of the flux biasing waveforms or flux bias pulses (FBP) can be achieved by changing SFQ pulse repetition rates set by SFQ circuit clock, its submultiples, and or special on-chip SFQ pulse generator circuits (flux pumps). In general case, the SFQ pulse repetition rates can be non-uniform.

As an example, a flux pump could be used for a fast change in the flux biasing by injection or removal of a fast train of pulses for coarse flux biasing, as shown in FIG. 6. An example of a flux pump is a relaxation oscillator circuit using an under-damped Josephson junction. When an underdamped Josephson junction switches it creates a train of SFQ pulses with the number of pulses determined by the resistance and inductance load of the circuit.

Flux biasing using SFQ pulses can be further refined for specific purposes including fast but high-resolution biasing over large intervals by combining coarse and fine tune biasing as shown in FIG. 7. In FIG. 7, the coarse biasing could be used for fast steps in biasing, and fine-tune biasing for the initial and/or final high-resolution tuning. In general, the specific sequence, duration, pulse rates, and other parameters of the coarse and fine biasing and, therefore, generated flux bias pulse shapes, their number and polarities are selected based on the specific function and optimization to achieve the highest gate fidelity.

The initial flux stored in the flux biasing storage loop can be reset by adding a reset circuit as shown in FIG. 8. In FIG. 8, the SQUID in series with the input transformer can be used as a reset mechanism. When the critical current of the SQUID is suppressed by applying the reset current to the input transformer, the flux stored in Lin is completely removed.

SFQ pulse control can be used not only for tuning of a qubit, but also for initiating quantum transitions between qubit states, as was proposed in the prior art. In this scheme, SFQ pulse is applied resonantly (uniformly) over many qubit Larmor periods or using more complex, non-uniform pulse patterns derived using the optimal control theory methods.

With a central control unit (which may also be an SFQ digital logic circuit), the combination and timing of these two control mechanisms can be coordinated and synchronized, as suggested in the block diagram of FIG. 9A. Fast flux biasing of the qubits and couplers also enables new and improved multi-qubit operations, as shown in FIG. 10A. This could be used to increase the speed of multi-qubit gate operation or improve the fidelity of the gate operation by exploiting new modes of multi-qubit interaction.

Here, the central control unit is capable of precise timing and control of a train of SFQ pulses acting on each qubit, and the flux biasing of all the qubits and coupler to achieve faster multi-qubit operation with higher fidelity.

Alternatively, quantum transitions can be executed using FBP waveforms generated by SFQ circuits, as shown in FIG. 9B. In this case, qubit rotations are driven exclusively by flux biasing applied to a qubit, while SFQ circuits are used to generate specific FBPs corresponding to the desired gate. This method can potentially lead to a faster gate execution, since the applied FBP can perform gate within a single or a few Larmor periods in contrast to SFQ pulse trains or microwave pulses typically applied over many qubit Larmor periods.

FIG. 10B shows a block diagram of multi-qubit operations using only flux biasing controls. In this case, separate FBPs are generated to control qubits and a coupler connecting qubits. The SFQ flux bias to adjust qubit energy (qubit frequency) is combined with the qubit control flux biasing, see the SFQ flux bias offset in FIG. 10B.

An example of the application of SFQ flux biasing to change the energy of the qubit during SFQ single qubit operation as shown in FIG. 11. In this example, the energy of the qubit can be reduced quickly during a single qubit operation, which enables faster single qubit operation. At the end of the single qubit rotation, the flux biasing can change the energy of the qubit again to decouple it from the rest of the circuit.

This type of flux bias control can be applied to change the superconducting critical current of a SQUID loop incorporated in qubit in place of a single Josephson junction (sometimes called a split junction) that is a central component of a superconducting qubit or coupler, which in turn affects the energy and coupling strength of the quantum device. Applicable qubits include flux qubits, phase qubits, and transmons, among others. For fluxoniums and similar qubits having large inductors (superinductors), flux bias can be applied to the superinductor which can be made using a Josephson junction array. Other applications of the rapid time-varying superconducting digital flux control to quantum computing are described in more detail below, or may become clear to those skilled in the art.

It is therefore an object to provide a magnetic flux control system, comprising: a superconducting circuit configured to convert each of successive single-flux-quantum pulses into a magnetic flux; a superconducting inductor configured to integrate the magnetic flux from the superconducting circuit to define an integrated magnetic flux; and a control system comprising a plurality of Josephson junctions, the control system being configured to generate at least one output control signal for controlling the superconducting circuit, the output control signal comprising at least one sequence of single-flux-quantum pulses adapted to selectively change the integrated magnetic flux.

It is also an object to provide a magnetic flux control system, comprising: at least one superconducting circuit configured to generate single-flux-quantum pulses; a coupling circuit configured to couple the single-flux-quantum pulses into a corresponding magnetic flux; a superconducting inductor configured to integrate the magnetic flux corresponding to the single-flux-quantum pulses to define an integrated magnetic flux; a qubit having a resonance frequency dependent on the integrated magnetic flux; and a sensor having a sensor output, the sensor being configured to determine at least one of the resonance frequency and the integrated magnetic flux; a control system comprising a plurality of Josephson junctions, the control system being configured to control a value of the integrated magnetic flux dependent on the sensor output.

It is a further object to provide a magnetic flux control method for controlling a superconducting system, comprising a superconducting circuit configured to convert each of successive single-flux-quantum pulses into a magnetic flux, and a superconducting inductor configured to integrate the magnetic flux from the superconducting circuit to define an integrated magnetic flux, and a control circuit comprising a plurality of Josephson junctions, the method comprising: defining a target magnetic flux; controlling the superconducting circuit to produce a sequence of single-flux-quantum pulses for monotonically changing the integrated magnetic flux to reduce a difference between the target magnetic flux and the integrated magnetic flux; and controlling the superconducting circuit to cease production of the sequence of single-flux-quantum pulses for monotonically changing the integrated magnetic flux and thereby cease monotonically changing the integrated magnetic flux, wherein said controlling superconducting circuit to cease production of the sequence of single-flux-quantum pulses is dependent on a value of the integrated magnetic flux.

The magnetic flux control system may further comprise a quantum computing circuit comprising at least one qubit having at last one physical property tunable dependent on at least the integrated magnetic flux, wherein the integrated magnetic flux is coupled with the at least one qubit. The at least one physical property may comprise a microwave resonance. The control system may be configured to control a dynamic variation of the at least one physical property of the at least one qubit over time. The at least one physical property may comprise at least one of a microwave resonance, an energy and a phase of the qubit, and may control each of a microwave resonance, an energy and a phase of the qubit. The control system may be configured to control a dynamic variation of the at least one physical property of the at least one of the qubit and the tunable qubit coupler. The at least one of the qubit and the tunable qubit coupler may comprise a switched qubit coupler configured to selectively control presence and absence of an interaction of a plurality of qubits.

The magnetic flux control system may be provided in a first integrated circuit and the at least one of the qubit and the tunable qubit coupler is provided in a second integrated circuit, therein the first integrated circuit and the second integrated circuit are provided on a common substrate.

The magnetic flux control system may further comprise at least one of a qubit and a tunable qubit coupler associated with a qubit, coupled to the integrated magnetic flux, wherein a qubit Bloch sphere state of the qubit is responsive to the at least one output control signal.

The magnetic flux control system may further comprising a qubit, whose state is represented by a phase and an amplitude a Bloch sphere, coupled to the integrated magnetic flux, wherein the phase and amplitude of the Bloch sphere are responsive to the at least one output control signal.

The magnetic flux control system may be provided in a first integrated circuit and the at least one of the qubit and the tunable qubit coupler is provided in a second integrated circuit, therein the first integrated circuit and the second integrated circuit are inductively coupled and provided on separate substrates having a flip chip geometry.

The control system may further comprise an input port configured to receive at least one feedback signal relating to a magnitude of the integrated magnetic flux.

The control system further may further comprise a pair of output ports configured to produce a first signal adapted to increase the integrated magnetic flux and a second signal adapted to decrease the integrated magnetic flux.

The control system may be configured to implement at least one of a phase locked loop control and a frequency locked loop control.

The control system may be configured to receive a photonic input control signal.

The magnetic flux control system may further comprise a frequency mixer and a detector configured to receive an output of at least one qubit and produce an input control signal for the control system.

The magnetic flux control system may further comprise a superconducting oscillator configured to generate a microwave signal which interacts with a qubit.

The superconducting inductor may be further configured to couple the integrated magnetic flux with a quantum computing circuit comprising a transmon qubit circuit having a microwave resonance tunable dependent on at least the integrated magnetic flux. The control system may be configured to, within a quantum calculation period of the transmon qubit, define a first microwave resonant frequency of the transmon qubit, and subsequently define a second microwave resonant frequency of the transmon qubit, wherein the first microwave resonant frequency and the second microwave resonant frequency are different.

The superconducting inductor may be further configured to couple the integrated magnetic flux with a quantum computing circuit comprising a transmon qubit circuit having a microwave resonance tunable dependent on at least the integrated magnetic flux, and the control system may be configured to tune the microwave resonance of the transmon qubit circuit with the integrated magnetic flux dependent on a microwave resonance state of the transmon qubit circuit.

The magnetic flux control system may further comprise a superconducting quantum interference device responsive to the integrated magnetic flux, adapted to produce a magnetometer output, wherein the control system comprises a control system input responsive to the magnetometer output.

The control system further may comprise a first input port configured to receive a reference frequency signal, a second input port configured to receive a microwave resonance signal, and a comparing circuit configured to produce a comparison output configured to control the integrated magnetic flux to selectively change the integrated magnetic flux in response to the comparison output.

The control system is further configured: to receive at least one input control signal selectively dependent on a signal from a qubit during a quantum computing calculation representing a calculation state of the qubit during a phase of quantum computing, and to control the integrated magnetic flux selectively dependent on the calculation state of the qubit during a subsequent phase of quantum computing.

The magnetic flux control system may further comprise an error input port configured to receive an error signal; and at least one memory configured to persistently store a calibration value dependent on the error signal, wherein the control system produces output control signal selectively dependent on the persistently stored calibration value.

The magnetic flux control system may further comprise a superconducting circuit configured to reset the integrated magnetic flux to a predetermine value.

The control system may be further configured to produce at least two types of the at least one sequence of single-flux-quantum pulses, comprising: a first type of the sequence adapted to change the integrated magnetic flux by a first amount; and a second type of the sequence adapted to change the integrated magnetic flux by a second amount, the first amount being different from the second amount; and the control system is configured to receive at least one input control signal representing an amount of change of the integrated magnetic flux, and to produce at least the first type of sequence and the second type of sequence selectively dependent on the at least one input control signal.

The control system may be further configured to produce at least two different types of the output control signal comprising the at least one sequence of single-flux-quantum pulses, comprising a first type of sequence associated with a first positive whole number of single single-flux-quantum pulses, and a second type of sequence associated with a second positive whole number of single-flux-quantum pulses, the first positive whole number and the second positive whole number being different.

The magnetic flux control system may further comprise a counter responsive to a target value, configured to count each single-flux-quantum pulse and selectively produce a signal when a cumulative value of the at least one sequence of single-flux-quantum pulses corresponds to the target value, wherein the superconducting circuit comprises a superconducting transformer primary inductor, coupled to the superconducting inductor as a superconducting transformer secondary inductor; and the at least one sequence of single-flux-quantum pulses comprise first pulses and second pulses; the superconducting transformer primary inductor has a first terminal and a second terminal, the first pulses enter the superconducting transformer primary inductor at the first terminal, and the second pulses enter the superconducting transformer primary inductor at the second terminal, such that the first pulses act with opposite polarity with respect to the second pulses with respect to changes in the integrated magnetic flux.

See, çelik, Mustafa Eren, Timur V. Filippov, Anubhav Sahu, Dmitri E. Kirichenko, Saad M. Sarwana, A. Erik Lehmann, and Deepnarayan Gupta. “Fast RSFQ and ERSFQ parallel counters.” IEEE Transactions on Applied Superconductivity 30, no. 7 (2020): 1-4; L. V. Filippenko, V. K. Kaplunenko, M. I. Khabipov, V. P. Koshelets, K. K. Likharev, O. A. Mukhanov, S. V. Rylov, V. K. Semenov, and A. N. Vystavkin, “Experimental Implementation of Analog-to-Digital Converter Based on the Reversible Ripple Counter,” IEEE Trans. Magn., vol. MAG-27, no. 2, pp. 2464-2467 Mar. 1991; Shukla, Ashish, Dmitry Kirichenko, Timur Filippov, Anubhav Sahu, Mustafa Eren Celik, Mingoo Seok, and Deepnarayan Gupta. “Pulse Interfaces and Current Management Techniques for Serially Biased RSFQ Circuits.” IEEE Transactions on Applied Superconductivity (2022); Amparo, Denis, Mustafa Eren çelik, Sagnik Nath, Joao P. Cerqueira, and Amol Inamdar. “Timing characterization for RSFQ cell library.” IEEE Transactions on Applied Superconductivity 29, no. 5 (2019): 1-9; Kito, Nobutaka, and Kazuyoshi Takagi. “An RSFQ flexible-precision multiplier utilizing bit-level processing.” In Journal of Physics: Conference Series, vol. 1975, no. 1, p. 012025. IOP Publishing, 2021; Qu, Pei-Yao, Guang-Ming Tang, Jia-Hong Yang, Xiao-Chun Ye, Dong-Rui Fan, Zhi-Min Zhang, and Ning-Hui Sun. “Design of an 8-bit Bit-Parallel RSFQ Microprocessor.” IEEE Transactions on Applied Superconductivity 30, no. 7 (2020): 1-6; Yamac, Taiki, Naoki Takeuchi, and Nobuyuki Yoshikawa. “Binary counters using adiabatic quantum-flux-parametron logic.” IEEE Transactions on Applied Superconductivity 31, no. 2 (2020): 1-5.

The control system may be configured to receive a feedback signal based on a magnitude of the integrated magnetic flux, further comprising a gate configured to cease the at least one sequence of single-flux-quantum pulses when the feedback signal indicates a sufficient correction in the integrated magnetic flux.

The magnetic flux control system may further comprise a control system input representing a feedback signal, wherein the control system is configured to produce the at least one output control signal selectively in dependence on the feedback signal, to produce: a continuous series of single-flux-quantum pulses of a first type for increasing the integrated magnetic flux; or a continuous series of single-flux-quantum pulses of a second type for decreasing the integrated magnetic flux; or an output representing no net single-flux-quantum pulses for maintaining the integrated magnetic flux.

The magnetic flux control system may further comprise a counter, wherein the control system is configured to receive a target value and in dependence thereon selectively: increment a counter based on a continuous series of single-flux-quantum pulses adapted to increase the integrated magnetic flux; decrement the counter based on a continuous series of single-flux-quantum pulses adapted to decrease the integrated magnetic flux; and suppress net single-flux-quantum pulses while a count value of the counter corresponds to an error margin of the target value.

The magnetic flux control system may further comprise a reset circuit configured to establish the magnetic flux at a predetermined value, the reset circuit comprising a reset inductor coupled to a superconducting quantum interference device (SQUID) having a critical current, in series with the superconducting inductor, wherein a current in the reset inductor is sufficient to drive the SQUID above the critical current and become resistive and dissipative of energy stored in the superconducting inductor.

It is another object of the invention to provide a method for controlling a superconducting quantum computing circuit, comprising generating different types of flux biasing pulses using a superconducting digital SFQ control circuit dependent on at least one control signal over time; converting the single-flux-quantum voltage pulses to a magnetic flux selectively dependent on a history of the at least one control signal, using the generated flux bias pulse with or without single-flux-quantum pulse control patterns applied to a superconducting quantum circuit, the different types of single-flux-quantum voltage pulses selectively causing increases and decreases in the magnetic flux; coupling the magnetic flux to a quantum computing circuit having a property tunable dependent on the coupled magnetic flux; and defining the at least one control signal over time dependent on a performance of the quantum computing circuit.

It is also an object of the invention to provide a method for controlling a superconducting quantum computing circuit, comprising: generating single-flux-quantum voltage pulses with a superconducting digital control circuit dependent on at least one control signal over time; converting the single-flux-quantum voltage pulses to a magnetic flux selectively dependent on a history of the at least one control signal; coupling the magnetic flux to a quantum computing circuit comprising at least one component having a property tunable dependent on the coupled magnetic flux; and defining the at least one control signal over time to selectively define the magnetic flux, to alter the property of the at least one component. The coupled magnetic flux may control a frequency, phase, rate, precision, or dynamic range of the at least one component, for example.

It is a further object to provide a magnetic flux control method, comprising: a control system comprising a plurality of Josephson junctions, the control system being configured to generate a sequence of single-flux-quantum pulses; a superconducting circuit configured to convert the sequence of single-flux-quantum pulses into a magnetic flux; and a superconducting inductor configured to couple the magnetic flux with a quantum computing circuit comprising at least one qubit coupler circuit having physical properties tunable dependent on the magnetic flux.

It is also an object to provide a magnetic flux control system, comprising: a control system comprising a plurality of Josephson junctions, configured to generate a sequence of single-flux-quantum pulses; a superconducting circuit configured to convert each pulse of the sequence of single-flux-quantum pulses into a magnetic flux; and a superconducting inductor configured to integrate the magnetic flux, wherein the integrated magnetic flux is controlled to increase and decrease corresponding to at least one control signal of the control system.

The superconducting inductor may be further configured to couple the integrated magnetic flux with a quantum computing circuit comprising at least one qubit circuit having physical properties tunable dependent on at least the magnetic flux.

The magnetic flux control system may further comprise the quantum computing circuit comprising at least one qubit circuit having physical properties tunable dependent on at least the magnetic flux.

The control system may have at least one control mode adapted to maintain a constant physical property of the at least one qubit.

The control system may have at least one control mode adapted to dynamically vary the physical property of the at least one qubit over time.

The superconducting inductor may be further configured to couple the integrated magnetic flux with a qubit circuit having physical properties tunable dependent on at least the magnetic flux.

The magnetic flux control system may be provided together with, or integrated with, the qubit circuit having physical properties tunable dependent on at least the magnetic flux.

The control system may have at least one control mode adapted to maintain a constant physical property of the qubit.

The control system may have at least one control mode adapted to dynamically vary the physical property of the qubit over time.

The control system may comprise an input configured to receive a feedback signal.

The control system may comprise a pair of inputs configured to receive feedback signals representing an excess of magnetic flux and a deficiency of magnetic flux.

The control system may comprise a pair of outputs configured to produce signals representing an increase of magnetic flux and a decrease of magnetic flux.

The control system may be configured to implement a phase locked loop control. See, en.wikipedia.org/wiki/Phase-locked_loop.

The control system may be configured to implement a frequency locked loop control. See, en.wikipedia.org/wiki/Frequency-locked_loop.

The control system may be configured to receive an optical control signal. See, e.g., Nakahara, K., H. Nagaishi, H. Hasegawa, S. Kominami, H. Yamada, and T. Nishino. “Optical input/output interface system for Josephson junction integrated circuits.” IEEE transactions on applied superconductivity 4, no. 4 (1994): 223-227; Van Zeghbroeck, B. “Optical data communication between Josephson-junction circuits and room-temperature electronics.” IEEE transactions on applied superconductivity 3, no. 1 (1993): 2881-2884; Karlsen, Bjørnar. “Optically operated pulse-driven Josephson junction arrays and range extension using voltage dividers and buffer amplifiers.” (2019); Karlsen, Bjørnar. “Optically operated pulse-driven Josephson junction arrays and range extension using voltage dividers and buffer amplifiers.” (2019).

The control system may be configured to receive a photonic control signal.

The control system may further comprise an optical output signal. See, e.g., Ireland, Jane, Oliver Kieler, Johannes Kohlmann, Helge Malmbekk, Jonathan M. Williams, Ralf Behr, Bjornar Karlsen et al. “Josephson arbitrary waveform system with optoelectronic drive.” In 2017 16th International Superconductive Electronics Conference (ISEC), pp. 1-4. IEEE, 2017; Youssefi, Amir, Itay Shomroni, Yash J. Joshi, Nathan R. Bernier, Anton Lukashchuk, Philipp Uhrich, Liu Qiu, and Tobias J. Kippenberg. “A cryogenic electro-optic interconnect for superconducting devices.” Nature Electronics (2021): 1-7.

The control system may further comprise a photonic output signal. See, Liu, Chenxu, Maria Mucci, Xi Cao, Michael Hatridge, and David Pekker. “Theory of an on-chip Josephson quantum micromaser.” Bulletin of the American Physical Society 65 (2020).

Modulation of signals may be detected by using receiver having a heterodyne or homodyne architecture. In a homodyne, the modulated signal is mixed in a mixer, typically a nonlinear device which produces modulation products of input frequencies f₁ and f₂ of f₁+f₂, f₁−f₂. etc. If f₁=f₂, the homodyne state, the modulating signal on the inputs will appear in the output as a baseband signal. If f₁≠f₂, the modulating signal will appear in the output biased with the offset frequency of f₁ and f₂, in which has the advantage of producing an intermediate frequency that may be bandpass filtered and subjected to other processes and transforms above baseband frequency. Even where modulation of one or both of the signals is immaterial, the mixer permits frequency translation of the output. The detector is a device that determines characteristics of a modulating signal.

The magnetic flux control system may further comprise a heterodyne detector. Sec, e.g., Ilves, Jesper, Shingo Kono, Yoshiki Sunada, Shota Yamazaki, Minkyu Kim, Kazuki Koshino, and Yasunobu Nakamura. “On-demand generation and characterization of a microwave time-bin qubit.” npj Quantum Information 6, no. 1 (2020): 1-7.

The magnetic flux control system may further comprise a homodyne detector. Sec, e.g., Fong, Kin Chung, Evan Walsh, Gil-Ho Lee, Dmitri Efetov, Jesse Crossno, Leonardo Ranzani, Thomas Ohki, Philip Kim, and Dirk Englund. “Graphene Josephson Junction Microwave Detector.” In APS March Mecting Abstracts, vol. 2017, pp. S51-011. 2017; Salmon, Neil A. “A quantum Bell Test homodyne interferometer at ambient temperature for millimetre wave entangled photons.” In Quantum Information Science and Technology IV, vol. 10803, p. 108030I. International Society for Optics and Photonics, 2018; Vrajitoarea, Andrei, Ziwen Huang, Peter Groszkowski, Jens Koch, and Andrew A. Houck. “Quantum control of an oscillator using a stimulated Josephson nonlinearity.” Nature Physics 16, no. 2 (2020): 211-217; Lüders, Carolin, and Marc Aßmann. “Distinguishing intrinsic photon correlations from external noise with frequency-resolved homodyne detection.” Scientific Reports 10, no. 1 (2020): 1-11.

The magnetic flux control system may further comprise a phase-sensitive amplifier configured to amplify a microwave signal which interacts with at least one qubit.

The magnetic flux control system may further comprise a Josephson parametric amplifier configured to amplify signals associated with at least one qubit. See, e.g., Boutin, Samuel, David M. Toyli, Aditya V. Venkatramani, Andrew W. Eddins, Irfan Siddiqi, and Alexandre Blais. “Effect of higher-order nonlinearities on amplification and squeezing in Josephson parametric amplifiers.” Physical Review Applied 8, no. 5 (2017): 054030; Sivak, V. V., Shyam Shankar, Gangqiang Liu, Jose Aumentado, and M. H. Devoret. “Josephson array-mode parametric amplifier.” Physical Review Applied 13, no. 2 (2020): 024014; Winkel, Patrick, Ivan Takmakov, Dennis Rieger, Luca Planat, Wiebke Hasch-Guichard, Lukas Grünhaupt, Nataliya Maleeva et al. “Nondegenerate parametric amplifiers based on dispersion-engineered josephson-junction arrays.” Physical Review Applied 13, no. 2 (2020): 024015; Planat, Luca, Arpit Ranadive, Rémy Dassonneville, Javier Puertas Martínez, Sébastien Léger, Cécile Naud, Olivier Buisson, Wiebke Hasch-Guichard, Denis M. Basko, and Nicolas Roch. “Photonic-crystal Josephson traveling-wave parametric amplifier.” Physical Review X 10, no. 2 (2020): 021021; Miano, Alessandro, and Oleg A. Mukhanov. “Symmetric traveling wave parametric amplifier.” IEEE Transactions on Applied Superconductivity 29, no. 5 (2019): 1-6; Aumentado, Jose. “Superconducting parametric amplifiers: The state of the art in Josephson parametric amplifiers.” IEEE Microwave Magazine 21, no. 8 (2020): 45-59.

The magnetic flux control system may further comprise a quadrature oscillator. Sec, Naaman, Ofer, J. A. Strong, D. G. Ferguson, J. Egan, N. Bailey, and R. T. Hinkey. “Josephson junction microwave modulators for qubit control.” Journal of Applied Physics 121, no. 7 (2017): 073904; Naaman, Ofer, Joshua Strong, David Ferguson, Jonathan Egan, Nancyjane Bailey, and Robert Hinkey. “Josephson Junction Microwave Modulators.” In 2018 IEEE/MTT-S International Microwave Symposium-IMS, pp. 1003-1005. IEEE, 2018.

The magnetic flux control system may further comprise a quadrature signal demodulator. Sec, e.g., Kono, Shingo, Kazuki Koshino, Yutaka Tabuchi, Atsushi Noguchi, and Yasunobu Nakamura. “Quantum non-demolition detection of an itinerant microwave photon.” Nature Physics 14, no. 6 (2018): 546-549.

The control system may be configured to, within a decoherence time of a qubit, maintain a first magnetic flux associated with the qubit, and maintain a second magnetic flux associated with the qubit, wherein the first magnetic flux and the second magnetic flux are different.

The superconducting inductor may be further configured to couple the integrated magnetic flux with a quantum computing circuit comprising at least one qubit circuit having a physical property tunable dependent on at least the magnetic flux, and the control system may be configured to, within a decoherence time of the at least one qubit, maintain a first state of the physical property of the at least one qubit, and subsequently maintain a second state of the physical property of the at least one qubit, wherein the first state and the second state are different.

The physical property may comprise a microwave resonance.

The superconducting inductor may be further configured to couple the integrated magnetic flux with a quantum computing circuit comprising a transmon qubit circuit having a microwave resonance tunable dependent on at least the magnetic flux, and the control system may be configured to, within a quantum calculation period of the transmon qubit, define a first microwave resonant frequency of the transmon qubit, and subsequently define a second microwave resonant frequency of the transmon qubit, wherein the first microwave resonant frequency and the second microwave resonant frequency are different.

The magnetic flux control system may further comprise a magnetometer configured to measure the integrated magnetic flux. The magnetometer may comprise a superconducting quantum interference detector (SQUID) magnetometer. The magnetometer may comprise a superconducting quantum interference filter (SQIF) magnetometer. The control system may further comprise an input for receiving a signal dependent on an output of the magnetometer.

The control system may further comprise an input for receiving a reference frequency signal, an input for receiving a microwave resonance signal, and a comparing circuit producing an output for controlling the magnetic flux to increase or decrease.

The control system may receive control signals comprising a reference frequency signal, and a microwave resonance signal, the control system further comprising a comparing circuit producing an output for controlling the magnetic flux to increase or decrease in dependence on an output of the comparing circuit.

The control system may receive at least one control signal selectively dependent on a signal from a qubit during a quantum computing calculation representing a calculation state of the qubit during a phase of quantum computing, and controls the magnetic flux selectively dependent on the calculation state of the qubit during a subsequent phase of quantum computing.

The magnetic flux control system may further comprise at least one memory configured to persistently store a calibration value, wherein the control system produces the sequence of single-flux-quantum pulses dependent on the persistently stored calibration value. An input may be provided to receive the calibration value. A circuit may be provided to determine the calibration value.

The magnetic flux control system may further comprise a circuit configured to reset the integrated magnetic flux to a predetermine value, e.g., by providing an element that temporarily transitions from a superconducting state to a non-superconducting state to dissipate energy stored in the superconducting inductor.

The control system may be configured to produce at least two types of the sequence of single-flux-quantum pulses, comprising a first type having a first number of single-flux-quantum pulses to change the integrated magnetic flux by a first amount, and second type having a second number of single-flux-quantum pulses to change the integrated magnetic flux by a second amount, the first number being different from the second number.

The control system may be configured to produce at least two types of the sequence of single-flux-quantum pulses, a first type which changes the integrated magnetic flux by a first amount, and second type which changes the integrated magnetic flux by a second amount, the first amount and the second amount being different.

The control system may be configured to produce at least four types of the sequence of single-flux-quantum pulses, comprising a first type having a first number of single-flux-quantum pulses to increase the integrated magnetic flux by a first amount, second type having a second number of single-flux-quantum pulses to increase the integrated magnetic flux by a second amount, a third type having a third number of single-flux-quantum pulses to decrease the integrated magnetic flux by a third amount, and fourth type having a fourth number of single-flux-quantum pulses to decrease the integrated magnetic flux by a second amount, the first number being different from the second number; and the third number being different from the fourth number.

The control system may be configured to produce at least four types of the sequence of single-flux-quantum pulses, a first type which increases the integrated magnetic flux by a first amount, second type which increases the integrated magnetic flux by a second amount, a third type which decreases the integrated magnetic flux by a third amount, and fourth type which decreases the integrated magnetic flux by a fourth amount, the first amount and the second amount being different, and the third amount and the fourth amount being different.

The control system may be configured to produce at least three respectively different types of the sequence of single-flux-quantum pulses, a first type which changes the integrated magnetic flux by a first amount, a second type which changes the integrated magnetic flux by a second amount, and a third type which changes the integrated magnetic flux by a third amount.

The control system may receive at least one control signal representing an amount of change of the integrated magnetic flux, and the control system may be configured to produce at least the first type, the second type, and the third type selectively dependent on the at least one control signal representing an amount of change of the integrated magnetic flux.

The control system may be configured to produce at least two different types of the sequence of single-flux-quantum pulses for increasing the integrated magnetic flux, a first type which produces a single single-flux-quantum pulse and a second type which produces a plurality of single-flux-quantum pulses.

The control system may be configured to produce at least two different types of the sequence of single-flux-quantum pulses for decreasing the integrated magnetic flux, a third type which produces a single single-flux-quantum pulse and a fourth type which produces a plurality of single-flux-quantum pulses.

The control system may be configured to produce at least three different types of the sequence of single-flux-quantum pulses for increasing the integrated magnetic flux, a first type which produces a single single-flux-quantum pulse, a second type which produces a plurality of single-flux-quantum pulses comprising a first range, and a third type which produces a plurality of single-flux-quantum pulses comprising a second range. The first range and the second range may be different. The control system may be configured to produce at least three additional different types of the sequence of single-flux-quantum pulses for decreasing the integrated magnetic flux, a fourth type which produces a single single-flux-quantum pulse, a fifth type which produces a plurality of single-flux-quantum pulses comprising a third range, and a sixth type which produces a plurality of single-flux-quantum pulses comprising a fourth range. The first range and the second range are different, and the third range and the fourth range are different.

It is also an object to provide a flux bias control method, comprising: generating a sequence of single-flux-quantum pulses with a control system having a plurality of Josephson junctions; converting each pulse of the sequence of single-flux-quantum pulses into a magnetic flux with a superconducting circuit; and integrating the magnetic flux with a superconducting inductor, wherein the integrated magnetic flux may be increased and decreased corresponding to at least one control signal of the control system.

The superconducting inductor may couple the integrated magnetic flux with a quantum computing circuit comprising at least one qubit circuit having physical properties tunable dependent on at least the magnetic flux.

The control system may maintain a constant physical property of the at least one qubit over a period.

The control system may dynamically vary the physical property of the at least one qubit over time.

The superconducting inductor may couple the integrated magnetic flux with a qubit circuit having physical properties tunable dependent on at least the magnetic flux.

The control system may maintain a constant physical property of the qubit over a period.

The control system may dynamically vary the physical property of the qubit over time.

A control system feedback signal may be received. A pair of feedback signals may be received representing respectively an excess of magnetic flux and a deficiency of magnetic flux.

A pair of outputs may be provided producing signals representing an increase of magnetic flux and a decrease of magnetic flux.

The control system implements a phase locked loop control and/or a frequency locked loop control.

The magnetic flux control method may receive an optical control signal and/or a photonic control signal, and may produce an optical output signal and/or a photonic output signal.

A microwave signal may be detected with a heterodyne detector or a homodyne detector.

A phase-sensitive amplifier may be provided for amplifying a microwave signal which interacts with at least one qubit. A Josephson parametric amplifier may be provided for amplifying signals associated with at least one qubit. The microwave signal may be an output of a qubit, have a characteristic dependent on the qubit. In some cases, a plurality of qubits are coupled, and an output signal derived from one qubit may be used to influence another qubit.

A quadrature microwave signal may be generated with a quadrature oscillator. A microwave signal may be demodulated with a quadrature signal demodulator.

Within a decoherence time of a qubit, a first magnetic flux associated with the qubit may be maintained, and subsequently a second magnetic flux associated with the qubit maintained, wherein the first magnetic flux and the second magnetic flux are different.

The magnetic flux control method may further comprise coupling the integrated magnetic flux with a quantum computing circuit comprising at least one qubit circuit having a physical property tunable dependent on at least the magnetic flux, and within a decoherence time of the at least one qubit maintaining a first state of the physical property of the at least one qubit, and subsequently maintaining a second state of the physical property of the at least one qubit, wherein the first state and the second state are different.

The physical property may comprise a microwave resonance.

The superconducting inductor may couple the integrated magnetic flux with a quantum computing circuit comprising a transmon qubit circuit having a microwave resonance tunable dependent on at least the magnetic flux, further comprising, within a quantum calculation period of the transmon qubit: defining a first microwave resonant frequency of the transmon qubit, and subsequently defining a second microwave resonant frequency of the transmon qubit, wherein the first microwave resonant frequency and the second microwave resonant frequency are different.

A magnetometer sensor may be provided to measure the integrated magnetic flux. The magnetometer may comprise a superconducting quantum interference detector (SQUID) magnetometer. The magnetometer may comprise a superconducting quantum interference filter (SQIF) magnetometer. A control system input signal dependent on an output of the magnetometer may be provided.

The magnetic flux control method may further comprise comparing a reference frequency signal, and a microwave resonance signal, and controlling the magnetic flux to increase or decrease in dependence on the comparing.

The magnetic flux control method may further comprise receiving control signals comprising a reference frequency signal, and a microwave resonance signal; comparing the reference frequency signal, and a microwave resonance signal to produce a comparing output; and controlling the magnetic flux to increase or decrease in dependence on the comparing output.

The magnetic flux control method may further comprise receiving at least one control signal selectively dependent on a signal from a qubit during a quantum computing calculation representing a calculation state of the qubit during a phase of quantum computing; and controlling the magnetic flux selectively dependent on the calculation state of the qubit during a subsequent phase of quantum computing.

The magnetic flux control method may further comprise storing a calibration value in a memory, register or analog storage; and producing the sequence of single-flux-quantum pulses dependent on the persistently stored calibration value. The calibration value may be received from an external input. The calibration value may be determined within the control system.

The integrated magnetic flux may be reset to a predetermine value. The integrated magnetic flux may be reset by causing at least one superconducting element associated with the superconducting inductor to become temporarily resistive while a portion of the superconducting inductor remains superconductive. The at least one superconducting element may comprise a superconducting quantum interference device (SQUID) which is induced to enter into a non-superconducting state by exceeding a critical current.

At least two types of the sequence of single-flux-quantum pulses may be produced, comprising a first type having a first number of single-flux-quantum pulses to change the magnetic flux by a first amount, and second type having a second number of single-flux-quantum pulses to change the integrated magnetic flux by a second amount, the first number being different from the second number.

At least two types of the sequence of single-flux-quantum pulses may be produced, comprising a first type which changes the integrated magnetic flux by a first amount, and second type which changes the integrated magnetic flux by a second amount, the first amount and the second amount being different.

At least four types of the sequence of single-flux-quantum pulses may be produced, comprising a first type having a first number of single-flux-quantum pulses to increase the integrated magnetic flux by a first amount, second type having a second number of single-flux-quantum pulses to increase the integrated magnetic flux by a second amount, a third type having a third number of single-flux-quantum pulses to decrease the integrated magnetic flux by a third amount, and fourth type having a fourth number of single-flux-quantum pulses to decrease the integrated magnetic flux by a second amount, the first number being different from the second number; and the third number being different from the fourth number.

At least four types of the sequence of single-flux-quantum pulses may be produced, a first type which increases the integrated magnetic flux by a first amount, second type which increases the integrated magnetic flux by a second amount, a third type which decreases the integrated magnetic flux by a third amount, and fourth type which decreases the integrated magnetic flux by a fourth amount, the first amount and the second amount being different, and the third amount and the fourth amount being different.

The magnetic flux control method may further comprise producing at least three respectively different types of the sequence of single-flux-quantum pulses, a first type which changes the integrated magnetic flux by a first amount, a second type which changes the integrated magnetic flux by a second amount, and a third type which changes the integrated magnetic flux by a third amount. The method may further comprise receiving at least one control signal representing an amount of change of the integrated magnetic flux, and the control system may be configured to produce at least the first type, the second type, and the third type selectively dependent on the at least one control signal representing an amount of change of the integrated magnetic flux.

The magnetic flux control method may further comprise producing at least two different types of the sequence of single-flux-quantum pulses for increasing the integrated magnetic flux, a first type which produces a single single-flux-quantum pulse and a second type which produces a plurality of single-flux-quantum pulses. The method may further comprise producing at least two different types of the sequence of single-flux-quantum pulses for decreasing the integrated magnetic flux, a third type which produces a single single-flux-quantum pulse and a fourth type which produces a plurality of single-flux-quantum pulses.

The magnetic flux control method may further comprise producing at least three different types of the sequence of single-flux-quantum pulses for increasing the integrated magnetic flux, a first type which produces a single single-flux-quantum pulse, a second type which produces a plurality of single-flux-quantum pulses comprising a first range, and a third type which produces a plurality of single-flux-quantum pulses comprising a second range. The first range and the second range may be different. At least three additional different types of the sequence of single-flux-quantum pulses for decreasing the integrated magnetic flux may be produced, a fourth type which produces a single single-flux-quantum pulse, a fifth type which produces a plurality of single-flux-quantum pulses comprising a third range, and a sixth type which produces a plurality of single-flux-quantum pulses comprising a fourth range. The first range and the second range may be different, and the third range and the fourth range may be different.

The magnetic flux from the sequence of single-flux-quantum pulses may be integrated by the superconducting inductor, such that successive single-flux-quantum pulses cause a change in a current in the superconducting inductor by a quantized amount.

The control system may selectively produce single-flux-quantum pulses representing different polarities.

The control system may selectively produce single-flux-quantum pulses of a first type and single-flux-quantum pulses of a second type, wherein the single-flux-quantum pulse of the first type causes an increase in a current in the superconducting inductor, and the single-flux-quantum pulse of the second type causes a decrease in the current in the superconducting inductor. The superconducting circuit may comprise a superconducting transformer primary inductor, coupled to the superconducting inductor as a superconducting transformer secondary inductor. The superconducting transformer primary inductor may have a first terminal and a second terminal, wherein the single-flux-quantum pulse of the first type enters the superconducting transformer primary inductor at the first terminal, and the single-flux-quantum pulse of the second type enters the superconducting transformer primary inductor at the second terminal, such that the single-flux-quantum pulse of the first type acts with opposite polarity with respect to the single-flux-quantum pulse of the first type with respect to changes in the magnetic flux.

The control system may be configured to receive a target value for the magnetic flux, the system further comprising a counter configured to count the single-flux-quantum pulses and cease the sequence of single-flux-quantum pulses when the counter value corresponds to the target value.

The control system may be configured to receive a feedback signal for the magnetic flux, the system further comprising a gate configured to cease the sequence of single-flux-quantum pulses (or their effect on the integrated magnetic flux) when the feedback signal indicates a sufficient correction in the magnetic flux.

The control system may receive a feedback signal and in dependence thereon selectively produce a continuous series of single-flux-quantum pulses of a first type or selectively produce a continuous series of single-flux-quantum pulses of a second type, wherein the single-flux-quantum pulse of the first type causes an increase in a current in the superconducting inductor, and the single-flux-quantum pulse of the second type causes a decrease in the current in the superconducting inductor.

The control system may receive a target value and in dependence thereon selectively produce and count a continuous series of single-flux-quantum pulses of a first type or of a second type, until the count corresponds to the target value, wherein the single-flux-quantum pulse of the first type causes an increase in a current in the superconducting inductor, and the single-flux-quantum pulse of the second type causes a decrease in the current in the superconducting inductor. The counter acts as a numerical integrator for the pulses. Since the pulses are quantized, their cumulative effect correlates with their numerosity.

The control system may receive a feedback signal and in dependence thereon selectively produce: a continuous series of single-flux-quantum pulses of a first type; or a continuous series of single-flux-quantum pulses of a second type; or an output representing no net single-flux-quantum pulses; wherein the single-flux-quantum pulse of the first type causes an increase in a current in the superconducting inductor, the single-flux-quantum pulse of the second type causes a decrease in the current in the superconducting inductor, and the output representing no net single-flux-quantum pulses produces no net change in the current in the superconducting inductor. The output representing no net single-flux-quantum pulses may comprise no single-flux-quantum pulses. The output may represent no net single-flux-quantum pulses may comprise offsetting single-flux-quantum pulses of the first type and single-flux-quantum pulses of the second type.

The control system may receive a target value and in dependence thereon selectively: increment a counter based on a continuous series of single-flux-quantum pulses of a first type until the count increases to the target value; decrement the counter based on a continuous series of single-flux-quantum pulses of a second type until the count decreases to the target value; or suppress net single-flux-quantum pulses while the counter corresponds to an error margin of the target value, wherein the single-flux-quantum pulse of the first type causes an increase in a current in the superconducting inductor, and the single-flux-quantum pulse of the second type causes a decrease in the current in the superconducting inductor. The suppressed net single-flux-quantum pulses may comprise no single-flux-quantum pulses and/or offsetting single-flux-quantum pulses of the first type and single-flux-quantum pulses of the second type.

The system may further comprise a sensor configured to measure the magnetic flux, a sensor configured to measure the physical properties, and/or an input configured to receive a feedback signal dependent on a performance of the plurality of qubits.

The at least one qubit may comprise a plurality of qubits and couplers between the plurality of qubits, having physical properties tunable dependent on the magnetic flux. The qubits may be superconducting qubits.

The control system may selectively produce single-flux-quantum pulses of a first type and single-flux-quantum pulses of a second type, wherein the single-flux-quantum pulse of the first type cause a change in current in the superconducting inductor of a first amplitude, and the single-flux-quantum pulse of the second type causes a change in current in the superconducting inductor of a second amplitude, and wherein the single-flux-quantum pulse of the first type is produced independently of the single-flux-quantum pulse of the second type. The single-flux-quantum pulse of the first type may cause a change in the current in the superconducting inductor which has an absolute value smaller than the change in the current in the superconducting inductor caused by the single-flux-quantum pulse of the second type.

A reset may be provided, configured to establish the magnetic flux at a predetermined value, e.g., zero. The reset may comprise a reset inductor coupled to a superconducting quantum interference device (SQUID) in series with the superconducting inductor, wherein a current in the reset inductor is sufficient to drive the SQUID above its critical current and become resistive and therefore dissipative of energy stored in the superconducting inductor.

It is also an object to provide a flux bias control method, comprising generating a sequence of single-flux-quantum pulses with a control system comprising a plurality of Josephson junctions; converting the sequence of single-flux-quantum pulses into a magnetic flux; coupling the magnetic flux with a quantum computing circuit comprising at least one qubit circuit with a superconducting inductor; and tuning physical properties of the qubit dependent on the magnetic flux.

The magnetic flux from the sequence of single-flux-quantum pulses may be integrated by the superconducting inductor, such that successive single-flux-quantum pulses cause a change in a current in the superconducting inductor by a quantized amount.

The generating may comprise selectively producing single-flux-quantum pulses representing different polarities with a control system.

Single-flux-quantum pulses of a first type and single-flux-quantum pulses of a second type may be selectively produced, wherein the single-flux-quantum pulse of the first type causes an increase in a current in the superconducting inductor, and the single-flux-quantum pulse of the second type causes a decrease in the current in the superconducting inductor.

The sequence of single-flux-quantum pulses may be converted into a magnetic flux by a superconducting circuit comprising a superconducting transformer primary inductor, coupled to the superconducting inductor as a superconducting transformer secondary inductor.

The superconducting transformer primary inductor may have a first terminal and a second terminal, wherein the single-flux-quantum pulse of the first type enters the superconducting transformer primary inductor at the first terminal, and the single-flux-quantum pulse of the second type enters the superconducting transformer primary inductor at the second terminal, such that the single-flux-quantum pulse of the first type acts with opposite polarity with respect to the single-flux-quantum pulse of the first type with respect to changes in the magnetic flux.

The method may further comprise receiving a target value for the magnetic flux; counting the sequence of single-flux-quantum pulses; and ceasing the single-flux-quantum pulses after the counter value corresponds to the target value.

The method may further comprise receiving a feedback signal for the magnetic flux dependent on a required correction of the magnetic flux; and gating the sequence of single-flux-quantum pulses when the feedback signal indicates a sufficient correction of the magnetic flux.

The method may further comprise receiving a feedback signal; and producing a continuous series of single-flux-quantum pulses of a first type or a second type selectively dependent on the feedback signal, wherein the single-flux-quantum pulse of the first type causes an increase in a current in the superconducting inductor, and the single-flux-quantum pulse of the second type causes a decrease in the current in the superconducting inductor.

The method may further comprise receiving a target value; and counting a continuous series of single-flux-quantum pulses of a first type or a second type, until the count corresponds to the target value; wherein the single-flux-quantum pulse of the first type causes an increase in a current in the superconducting inductor, and the single-flux-quantum pulse of the second type causes a decrease in the current in the superconducting inductor.

The method may further comprise receiving a feedback signal; and selectively producing a continuous series of single-flux-quantum pulses of a first type or of a second type or an output representing no net single-flux-quantum pulses, selectively dependent on the feedback signal; wherein the single-flux-quantum pulse of the first type causes an increase in a current in the superconducting inductor, the single-flux-quantum pulse of the second type causes a decrease in the current in the superconducting inductor, and the output representing no net single-flux-quantum pulses produces no net change in the current in the superconducting inductor.

The output representing no net single-flux-quantum pulses may comprise no single-flux-quantum pulses and/or offsetting single-flux-quantum pulses of the first type and single-flux-quantum pulses of the second type.

The method may further comprise receiving a target value; selectively incrementing a counter based on a continuous series of single-flux-quantum pulses of a first type if the count is below the target value; selectively decrementing the counter based on a continuous series of single-flux-quantum pulses of a second type if the count is above the target value; and selectively suppressing net single-flux-quantum pulses if the count corresponds to an error margin of the target value, wherein the single-flux-quantum pulse of the first type causes an increase in a current in the superconducting inductor, and the single-flux-quantum pulse of the second type causes a decrease in the current in the superconducting inductor. The suppressed net single-flux-quantum pulses may comprise no single-flux-quantum pulses and/or offsetting single-flux-quantum pulses of the first type and single-flux-quantum pulses of the second type.

The method may further comprise measuring the magnetic flux or integrated magnetic flux with a sensor, and/or measuring the physical properties with a sensor, and/or receiving a feedback signal dependent on a performance of the plurality of qubits.

The at least one qubit may comprise a plurality of qubits and couplers between the plurality of qubits, having physical properties tunable dependent on the magnetic flux. The qubits may be superconducting qubits.

The method may further comprise selectively producing single-flux-quantum pulses of a first type and selectively producing single-flux-quantum pulses of a second type, wherein the single-flux-quantum pulses of the first type cause an change in current in the superconducting inductor of a first amplitude, and the single-flux-quantum pulses of the second type cause a change in current in the superconducting inductor of a second amplitude, and wherein the single-flux-quantum pulse of the first type is produced independently of the single-flux-quantum pulse of the second type. The single-flux-quantum pulse of the first type may cause a change in the current in the superconducting inductor which has an absolute value smaller than the change in the current in the superconducting inductor caused by the single-flux-quantum pulse of the second type.

The method may further comprise resetting the magnetic flux to a predetermined value. The resetting may comprise passing a pulse through a reset inductor coupled to a superconducting quantum interference device (SQUID) in series with the superconducting inductor, wherein a pulse-induced current in the reset inductor is sufficient to drive the SQUID above its critical current and become resistive and therefore dissipative of energy stored in the superconducting inductor.

### BRIEF DESCRIPTION OF THE DRAWINGS

FIG. 1 shows a SFQ flux biasing circuit.

FIG. 2 shows a SFQ flux biasing using chain of JTLs.

FIG. 3 shows a flux biasing using parallel JTLs.

FIG. 4 shows a simulation of flux biasing by adding or removing magnetic fluxons.

FIG. 5 shows an arbitrary-shape time-varying flux-biasing.

FIG. 6 shows a circuit for coarse flux biasing using flux pump.

FIG. 7 shows a combining coarse and fine tune biasing.

FIG. 8 shows a circuit to reset flux stored in the flux biasing circuit.

FIG. 9A shows a block diagram for single-qubit gate operation with time-variable flux biasing.

FIG. 9B shows a block diagram for single-qubit gate operation with time-and pulse rate-variable flux biasing.

FIG. 10A shows a block diagram for multi-qubit gate operation with time-variable flux biasing of qubits and couplers.

FIG. 10B shows a block diagram for multi-qubit gate operation with time-and pulse-rate-variable flux biasing of qubits and couplers.

FIG. 11 shows a single qubit operation combining SFQ pulses for single qubit control and flux biasing.

FIG. 12A shows a block diagram of a prototype SFQ flux bias circuit employing a counter.

FIG. 12B shows a block diagram of a prototype SFQ flux bias circuit employing feedback.

FIG. 12C shows a block diagram of a prototype SFQ flux bias circuit to produce net-zero flux bias pulses for fluxonium control.

FIG. 12D shows a block diagram of a prototype low-hardware-overhead SFQ flux bias circuit to produce net-zero flux bias pulses for fluxonium control.

FIG. 13 shows a schematic of an amplifying JTL.

FIGS. 14A-14B show a block diagram and circuit schematic of a relaxation oscillator flux pump.

FIG. 14C shows a graph of a simulation of operation of the relaxation oscillator where the dotted curve shows the voltage output, and the solid curve represents the total flux output.

FIG. 15 shows a block diagram of a programmable pulse counter.

FIG. 16A shows a top-level schematic of a prototype SFQ flux bias circuit.

FIG. 16B shows a schematic of the flux generating circuit from FIG. 16A.

FIG. 16C shows a schematic of the switch from FIG. 16B.

FIG. 16D shows a schematic of the synchronizer component of the switch from FIG. 16C.

FIG. 17 shows a circuit layout of a prototype SFQ flux bias circuit.

FIG. 18 shows a simulation of operation of the prototype SFQ flux bias circuit.

FIG. 19 shows experimental measurements of the prototype SFQ bias circuit.

### DETAILED DESCRIPTION OF THE PREFERRED EMBODIMENTS

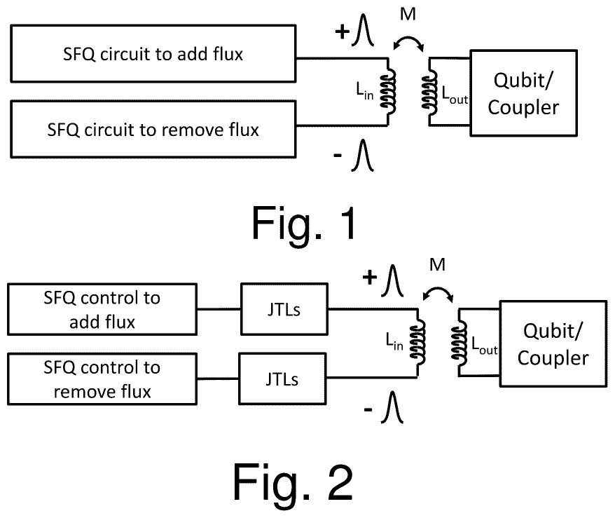

FIG. 1 shows a conceptual diagram of a preferred embodiment of a flux biasing circuit. This diagram comprises the flux biasing circuit itself, which generates a time-variable magnetic flux, inductively coupled to a superconducting qubit, or a superconducting coupler between two qubits (Qubit/Coupler). The inductive coupling comprises a transformer, generally without a magnetic core, with a primary inductance Lin, a secondary inductance Lout, and a mutual inductance M. The transformer lines preferably comprise a superconducting material, such as niobium or aluminum, at the cryogenic temperature of operation, so that they are essentially lossless with magnetic flux that is quantized as a multiple of the fluxon Po. Both the flux-biasing circuit and the qubit/coupler comprise a plurality of Josephson junctions. The flux biasing circuit and the qubit/coupler may be integrated circuits, which may be fabricated on the same chip, or alternatively they may be fabricated on separate chips that are coupled inductively in a flip-chip geometry.

FIG. 1 also comprises two digital SFQ generating circuits, which may be nominally identical, but which are connected to the primary inductance Lin with opposite polarities, so as to correspond to magnetic flux of opposite signs.

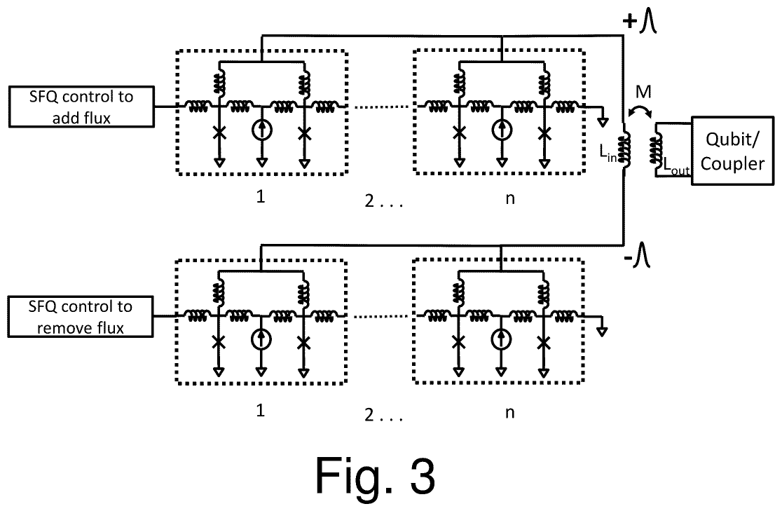

This conceptual diagram is further refined in FIG. 2 to include Josephson Transmission Lines (JTLs) in each of the two channels. The JTLs are used to transport and shape the SFQ pulses, and may also be configured in parallel to achieve current gain, as shown in FIG. 3. While the JTL itself propagates an SFQ pulse in series, the parallel output configuration functions as a digital pulse multiplier, increasing the total flux by a factor of n of the parallel unit cells.

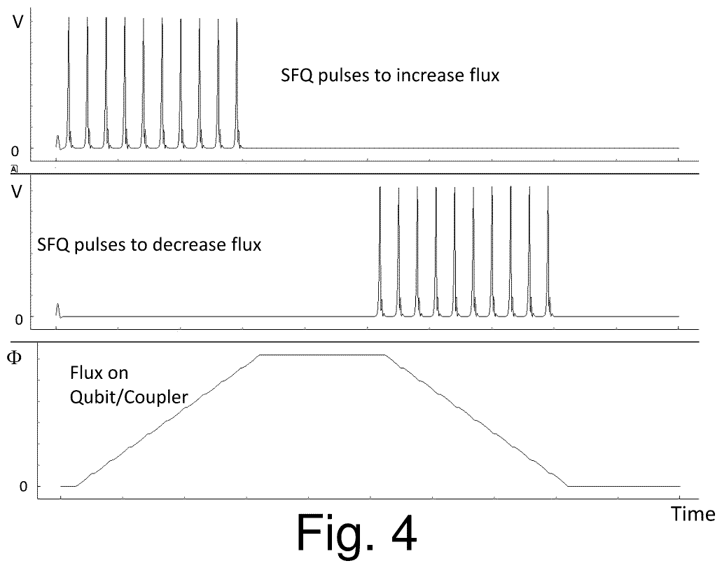

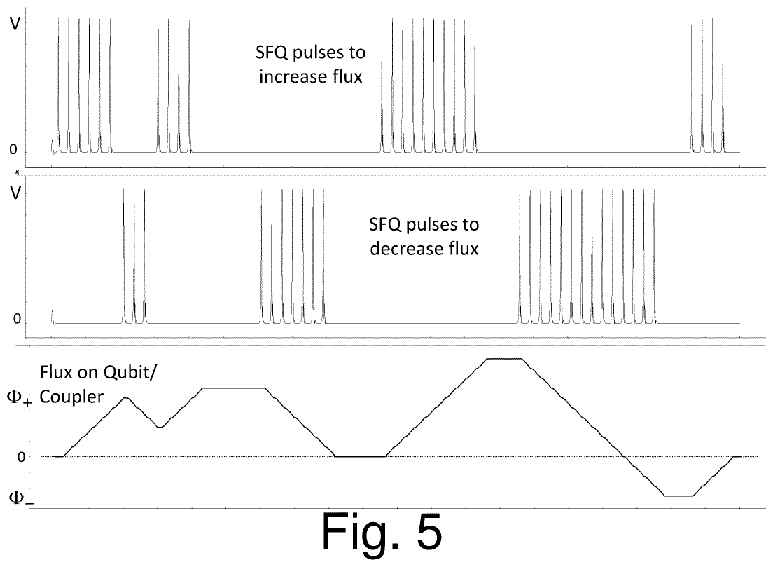

FIGS. 4 and 5 show two examples of time-varying flux profiles that may be generated by such positive and negative fluxon generators. FIG. 4 shows a simple profile that rises linearly, remains constant, and then ramps down again, while FIG. 5 represents an arbitrary variation in time. The time axis is not specified in either case, but the characteristic ramp time can be anywhere from 10 ps to 1 ns or longer, since the individual SFQ pulses have intrinsic pulsewidth of order 1-2 ps. This may be compared to the period of a qubit resonance, which may be of order 100 ps. So, the flux bias variation may occur either within a single resonance period, or over a plurality of resonance periods. Note also that while the SFQ pulses comprise very high frequency components, the circuits can be configured to filter out the highest frequency components to yield a smooth flux profile. Such a smooth flux profile will also not excite quasiparticles in the quantum portion of the circuit, which would tend to reduce quantum coherence times.

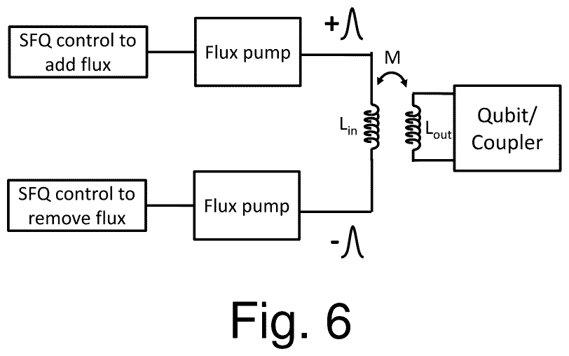

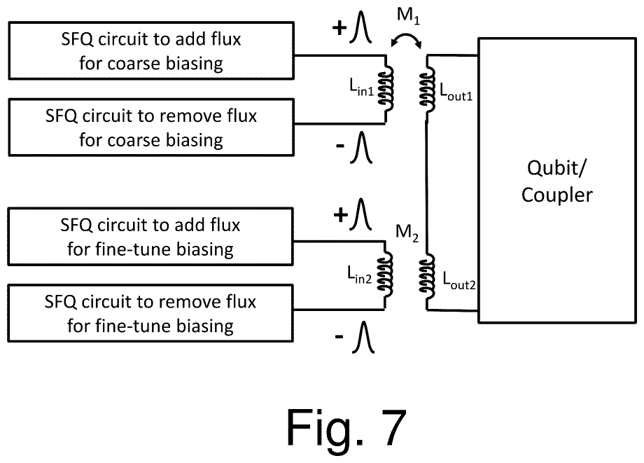

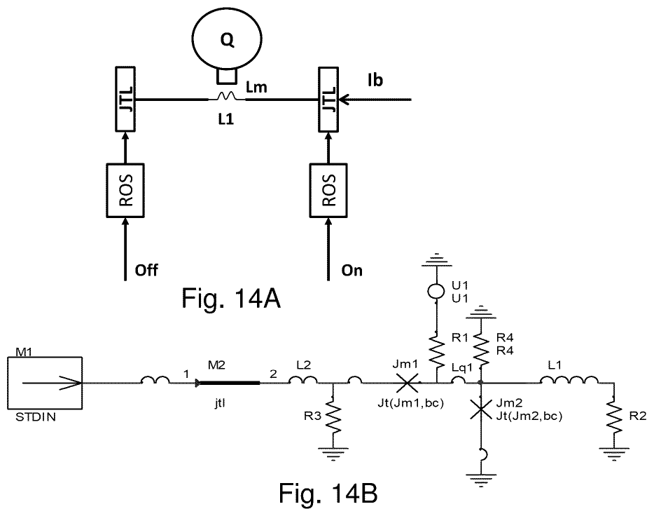

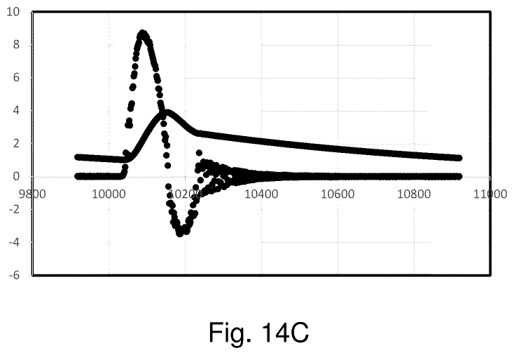

A further embodiment of the flux biasing circuit is shown in FIGS. 6 and 7, and comprises a two-stage coarse and fine control. The coarse control may comprise a flux pump that multiplies the flux by a known factor. One embodiment of a flux pump is a SQUID relaxation oscillator, shown in FIGS. 14A-14C and described further below. The two-stage flux bias control permits high precision, high speed, and large dynamic range.

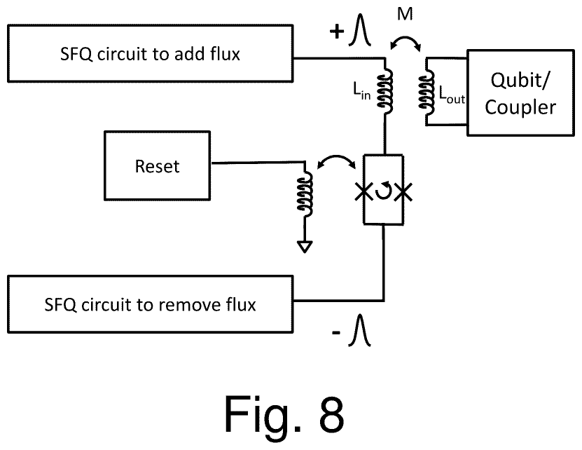

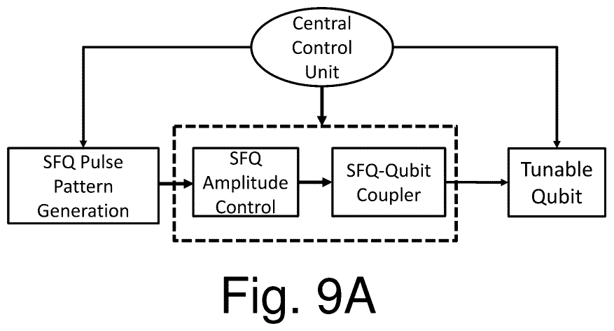

A further refinement is shown in FIG. 8, which resets the flux in the control loop to zero. This is achieved using a SQUID in series with the inductive storage loop. When a control SFQ pulse drives the SQUID above its critical current into its normal state, the loop becomes resistive, and the stored flux of either sign quickly escapes the loop.

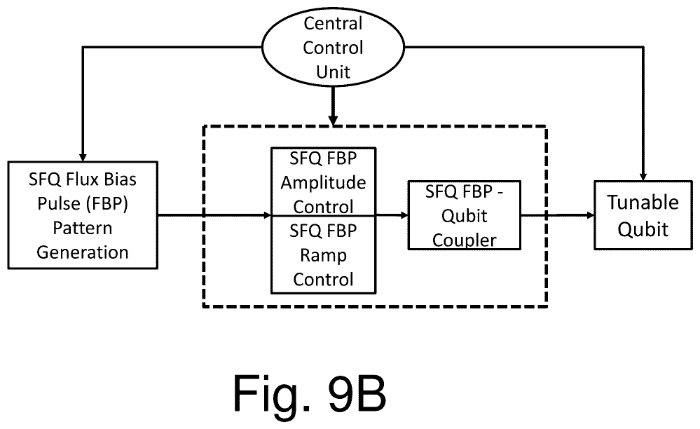

The block diagram in FIG. 9A shows the various ways that SFQ digital control may be applied to qubit control. In a preferred embodiment, all of these blocks comprise superconducting circuits located at cryogenic temperatures. The block on the top is the Central Control Unit, which provides the centralized source for clock pulses for synchronization and sequential timing. These clock pulses are also SFQ pulses. SFQ control signals include flux bias for the qubit, but also include other SFQ pulse sequences that can be used to induce quantum transitions, for example. These include the blocks labeled “SFQ Pattern Generation”, “SFQ Amplitude Control”, and “SFQ-Qubit Coupler”. These are similar to prior-art circuits for SFQ control, but here they may be properly synchronized with the flux biasing circuits for improved control.

The block diagram on FIG. 9B shows another embodiment, in which the qubit is controlled exclusively using flux bias pulses (FBP). The shape of the pulses is controlled using blocks “SFQ FBP Amplitude Control” and “SFQ FBP Ramp Control”. Specific control functions for these blocks are generated by “SFQ Flux Bias (FBP) Pattern Generation” block.

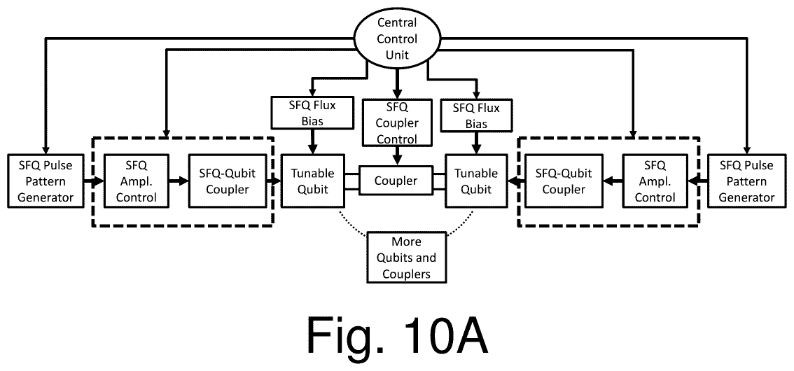

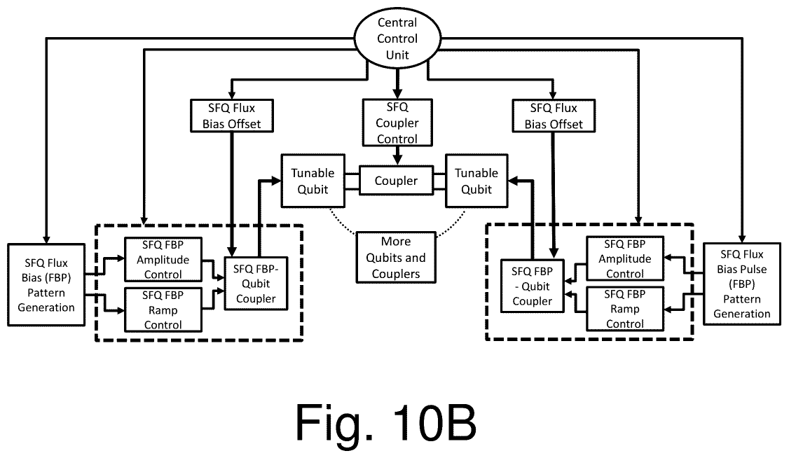

FIGS. 10A and 10B take this one step further for two coupled qubits and beyond. The two tunable qubits linked by a coupler, shown in the center of the figure, comprise the superconducting quantum circuit itself. These may be linked to other qubits and couplers, as indicated on the bottom. The completely synchronized digital control at all levels enables new opportunities for precision control while minimizing decoherence of the quantum operation.

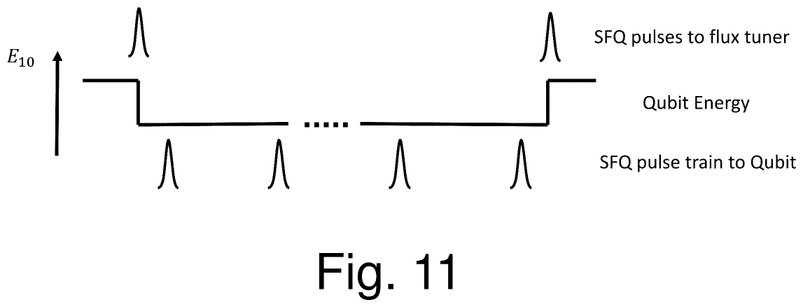

An illustrative example of these two types of SFQ control is shown in FIG. 11. The pulses at the bottom (corresponding to opposite polarities) provide a flux bias that first tunes, then detunes, the energy of the qubit, shown in the middle. The pulses on top represent the resonant pulse train coupled to induce a transition of the qubit, during the time that its energy is properly tuned.

In addition to presenting the concept and method of superconducting digital flux bias of qubits, portions of a preferred embodiment have been designed, simulated, fabricated, and demonstrated experimentally.

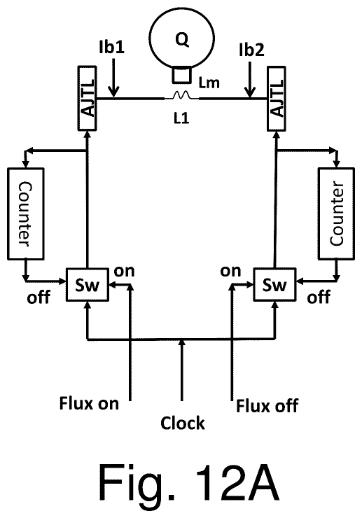

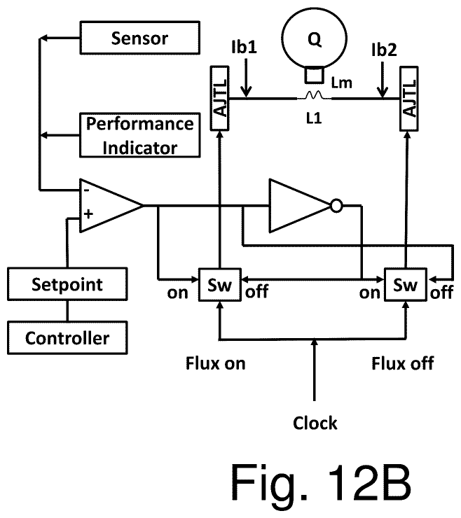

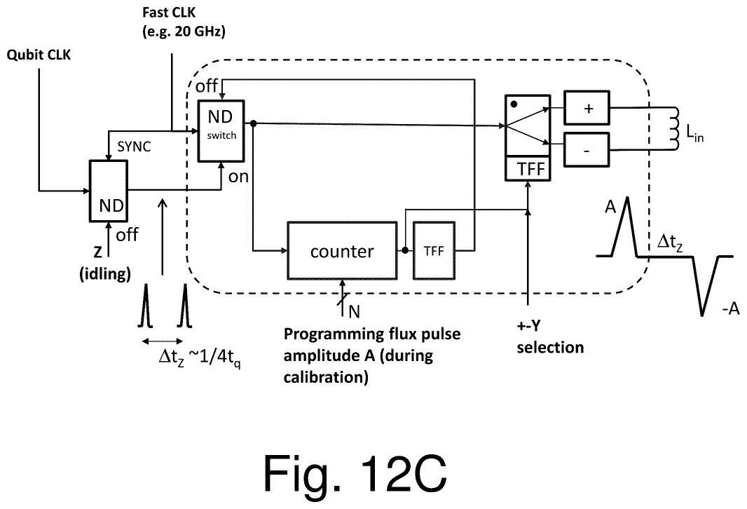

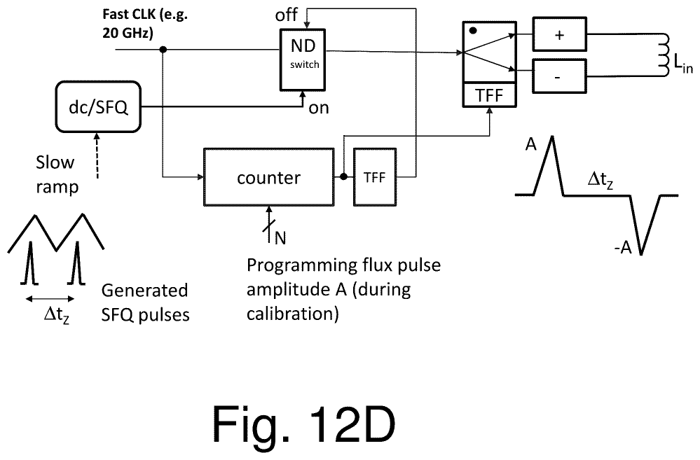

FIG. 12A shows a block diagram of a flux bias control circuit similar to that shown in FIG. 3. This circuit includes positive and negative flux generating circuits, each with an amplifying JTL (AJTL), a switch, and a counter. This also includes a single coupling inductor L1 that couples magnetic flux to a qubit or coupler, labeled Q, and a superconducting clock source that sets the generation rate of SFQ pulses.

Alternately, as shown in FIG. 12B, a flux bias control circuit similar to that shown in FIG. 3 is provided with a feedback input, based on a sensor measurement or a performance indicator dependent on the output of the qubit. This circuit also includes positive and negative flux generating circuits, each with an amplifying JTL (AJTL), a switch, a comparator for determining whether the magnetic flux is above or below the target value or setpoint, supplied by a controller, and an inverter for driving the opposite phase (Flux on vs. Flux off). The comparator may also have intrinsic complementary outputs. This also includes the single coupling inductor L1 that couples magnetic flux to the qubit or coupler, labeled Q, and a superconducting clock source that sets the generation rate of SFQ pulses. Not shown in 12B is an option for suppressing all pulses, for example when the sensor output or performance indicator demonstrates a sufficient proximity to the target that tuning is not required. Typically, this is produced by a digital control, a deadband control circuit, or hysteresis circuit, which advantageously may be implemented by adjusting the setpoint. The null tuning zone may be implemented by suppression of pulses or by presence of both Flux on and Flux off pulses. The former case reduces power dissipation. Typically, the comparator is implemented in digital logic, though an analog implementation is possible, so long as power dissipation is maintained at a low level. The comparator may be digital in amplitude and analog in time, and operate on phase relationships. For example, if the comparator is clocked, the output may be selectively dependent on whether one input precedes the clock and the other succeeds the clock. If both precede or succeed, then the comparator may produce a null output.

FIG. 12C shows an example of an SFQ circuit to produce net-zero flux bias pulse which can be used for fluxonium control within a single qubit cycle (Larmor period). The net-zero pulse consists of two opposite polarity triangular flux bias pulses applied to the qubit with interval Δt_{Z}. The amplitude of each pulse is programmed using an SFQ counter, the carry signal of this counter triggers the polarity switch implemented using the toggle flip-flop (TFF). Nondestructive readout switches (ND) are used to control the beginning and completion of pulse generation.

FIG. 12D shows an example of a simplified SFQ circuit to produce net-zero flux bias pulse similar to one described in FIG. 12C. The complexity reduction is achieved by using a dc/SFQ converter which generates control SFQ pulses to set the interval ∛t_{Z} between the opposite polarity flux bias pulses. Although this scheme is simpler on the SFQ side, it requires a control signal for the dc/SFQ converter which can be generated by cryoCMOS or conventional room-temperature electronics.

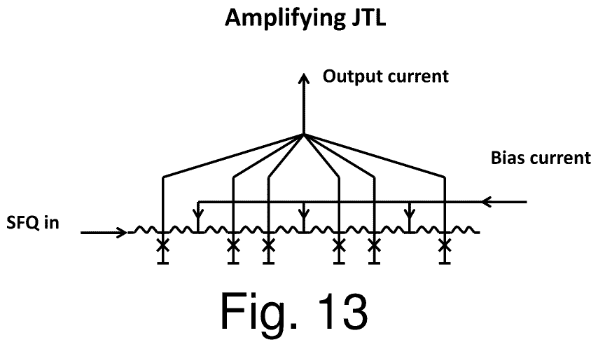

The AJTL can be a parallel JTL with 6 JTL stages in parallel, as shown in FIG. 13. Alternatively, a flux pump based on a relaxation oscillator (ROS) could be used, as shown in FIGS. 14A-14C. FIG. 14A shows the block diagram of the full flux bias circuit with two ROS circuits for both positive and negative flux. FIG. 14B shows the schematic of ROS, built around a hysteretic Josephson junction Jm2. When this junction switches, it remains in the voltage stage for an extended period of time, typically generating hundreds of fluxons or more. A simulation of operation of the ROS is shown in FIG. 14C, where the oscillating dotted curve shows the voltage output, and the solid curve with a long tail represents the total flux output. This ROS flux bias circuit would be particularly useful for the coarse channel of a two-stage flux bias circuit, as suggested in FIGS. 6 and 7.

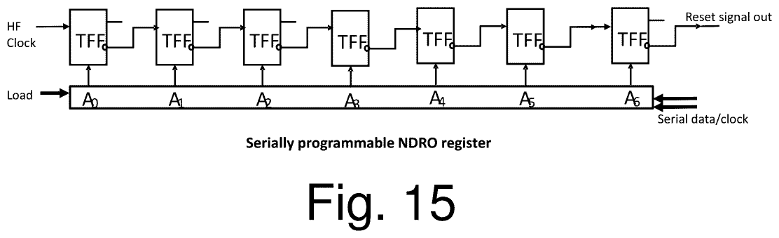

The counter can be a fixed frequency divider, based on a simple chain of N T-flip-flops (TFFs), well known in the prior art, which generates 2^{N} SFQ pulses. Alternatively, a programmable counter such as that in FIG. 15 can be used, which can generate an arbitrary programmable number of SFQ pulses up to 2^{N}. This also comprises a series of N TFFs (where N=6 in FIG. 14C), linked to a serially programmable non-destructive readout (NDRO) register.

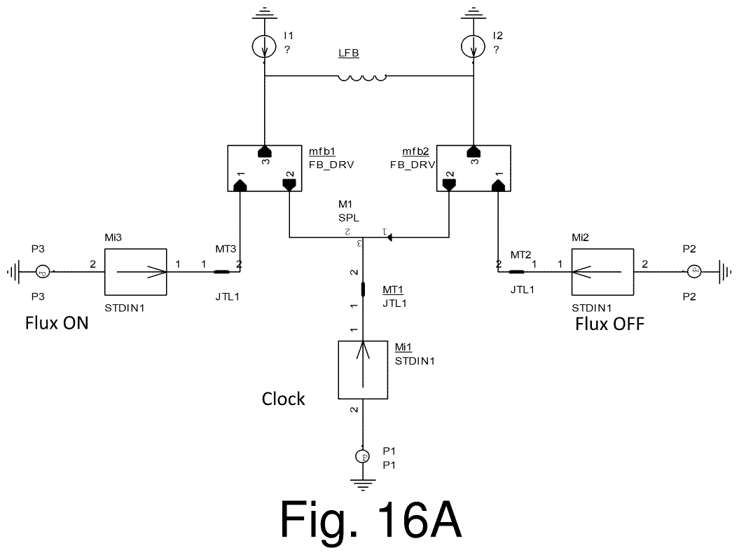

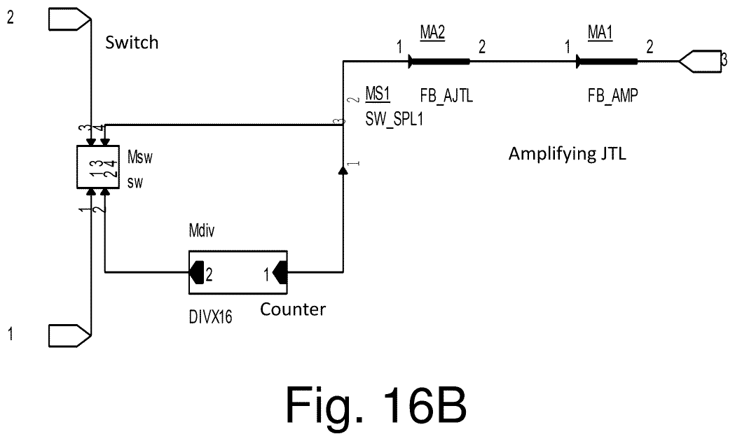

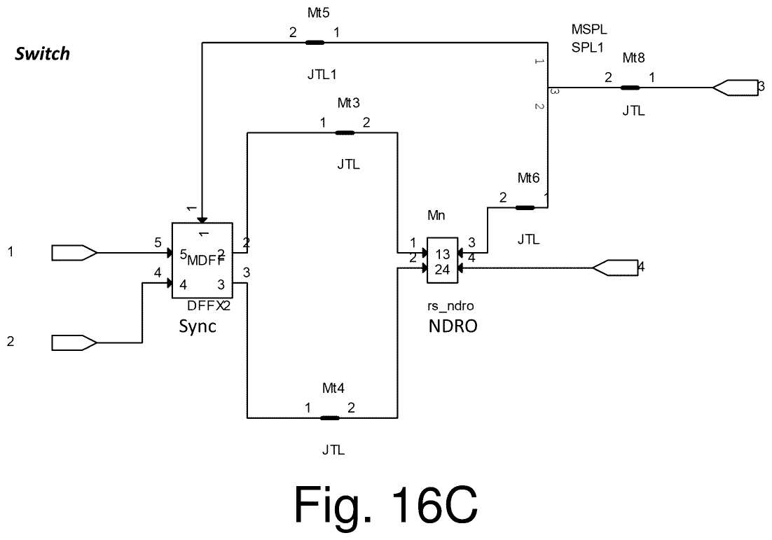

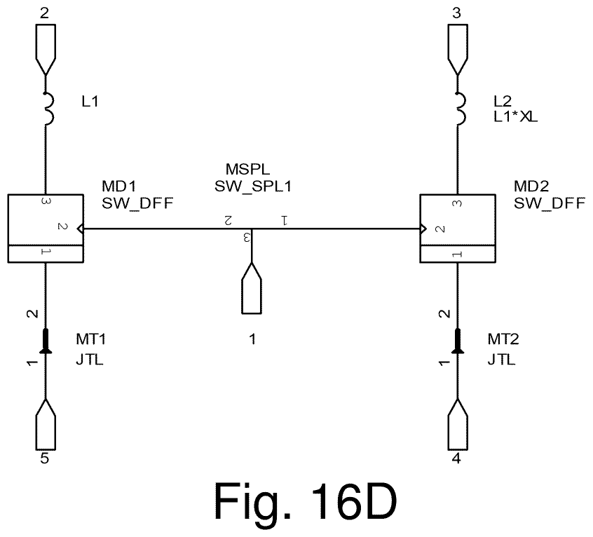

Portions of the schematic hierarchy for a prototype flux bias control circuit based on FIGS. 12A-12D are shown in FIGS. 16A, 16B, 16C, and 16D. FIG. 16A shows the components of the overall bipolar flux control circuit, including the positive and negative flux channels (Flux ON and Flux OFF), two identical flux bias drivers (FB_DRV), a synchronizing clock generator with a splitter for clock distribution, and an output flux bias inductor LFB. This output inductor would couple flux to a qubit or coupler, but the quantum circuit is not included in this prototype demonstration circuit.

FIG. 16B provides a more detailed schematic of the flux bias driver FB_DRV, including a switch, a 16-bit counter, and an amplifying JTL, as shown in the blocks in FIG. 11. The switch is further expanded in FIG. 16C, comprising a synchronizer circuit SYNC and a storage register NDRO. Finally in FIG. 16D, the SYNC circuit is shown to comprise two D-flip-flops (DFF) that are well known in the prior art.

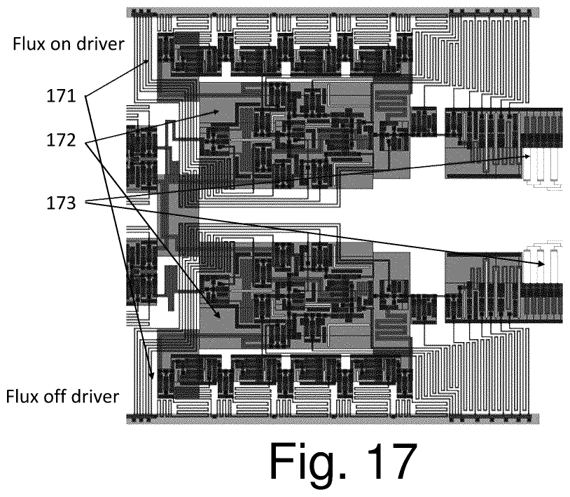

The circuits of FIGS. 16A-16D were laid out on chip using a standard integrated circuit design tool, and parts of this chip layout are shown in FIG. 17. This includes the Flux on and Flux off Bias Drivers, with components counter 171 (x16), switch 172, and JTL current amplifier 173.

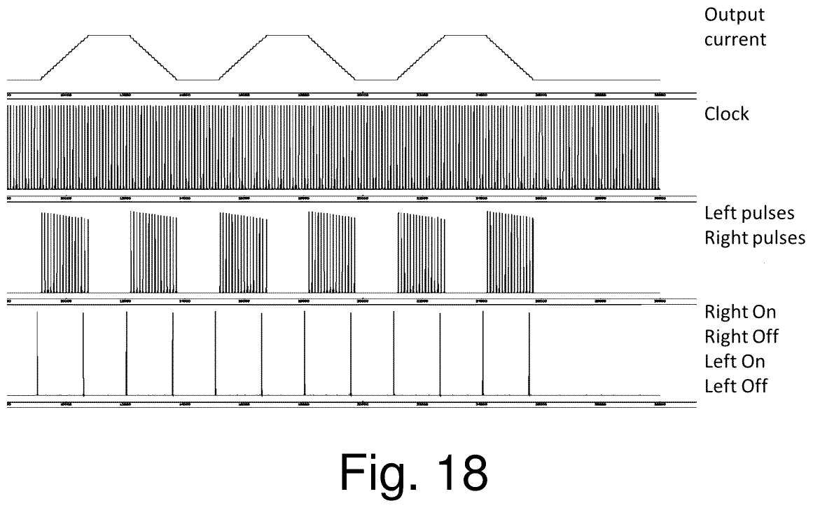

The operation of the circuit in FIGS. 16A-16D was simulated, and several inputs and outputs are shown in FIG. 18. The plot on top shows several periods of the output current (and hence the flux bias) being ramped up and down. Below this is the clock signal, the alternating flux pulses from the left and right sides (positive and negative flux), and the trigger pulses for the two sides.

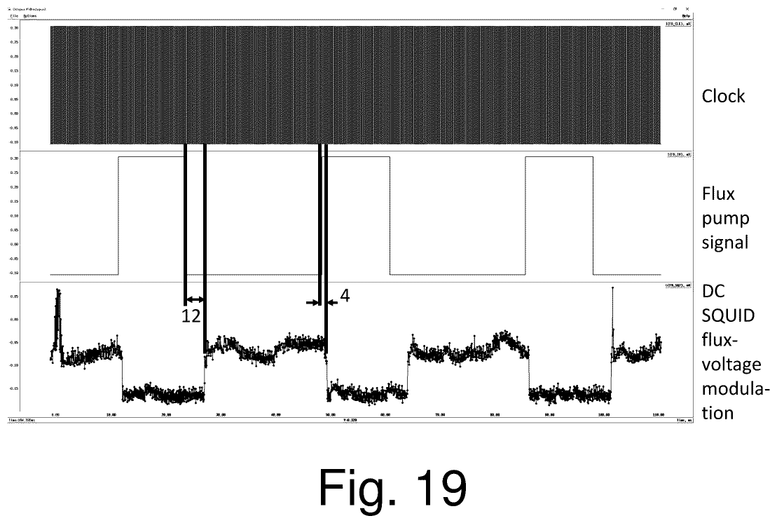

A chip based on the layout of FIG. 17 was fabricated using niobium Josephson junction technology, cooled to about 4 K, below the superconducting critical temperature, and tested. Preliminary results are shown in FIG. 19, which shows the clock inputs, the flux pump inputs, and a magnetic flux output as measured by a DC SQUID. Although this was a preliminary low-frequency test, the circuit demonstrated the expected functionality.

Similar superconducting circuits would be expected to exhibit similar performance at high speed, at reduced cryogenic temperatures in the mK range, with flux bias linked to a superconducting qubit or inter-qubit coupler.

1. A system for controlling a qubit having a qubit energy, comprising:
a first circuit configured to receive at least one control signal, to generate at least one sequence of single-flux-quantum pulses, and to selectively integrate the sequence of single-flux-quantum pulses into an integrated magnetic flux in a loop in dependence on the at least one control signal; and
a second circuit configured to determine at least one of the integrated magnetic flux, and a performance metric of a qubit coupled to the integrated magnetic flux, having an output.

2. The circuit according to claim 1, further comprising a third circuit configured to receive the output of the second circuit and to generate the at least one control signal.

3. The system according to claim 1, wherein the first circuit is a superconducting circuit configured to generate the at least one sequence of single flux quantum pulses from a Josephson junction at cryogenic temperatures.

4. The system according to claim 1, wherein the first circuit comprises a plurality of Josephson junctions, configured as to increase the integrated magnetic flux in the loop with a flux-on circuit, and to decrease the integrated magnetic flux in the loop with a flux-off circuit.

5. The system according to claim 1, wherein the first circuit comprises a pair of output ports configured to produce a first signal configured to increase the integrated magnetic flux and a second signal adapted to decrease the integrated magnetic flux.

6. The system according to claim 1, further comprising a qubit, whose state is represented by a phase and an amplitude a Bloch sphere, coupled to the integrated magnetic flux, wherein the phase and amplitude of the Bloch sphere are responsive to the integrated magnetic flux.

7. The system according to claim 5, wherein at least one of a microwave resonance, an energy, and a phase of the qubit is dependent on the integrated magnetic flux.

8. The system according to claim 1, further comprising a tunable qubit coupler for a qubit having at least one physical property tunable dependent on at least the integrated magnetic flux, wherein the integrated magnetic flux is coupled with the tunable qubit coupler to alter a property of the qubit.

9. The system according to claim 1, further comprising a switched qubit coupler configured to selectively control a presence and an absence of an interaction of a plurality of qubits.

10. The system according to claim 1, further comprising a frequency mixer and detector configured to receive an output of at least one qubit and to control the first circuit.

11. The system according to claim 1, wherein the qubit comprises a transmon qubit, and the first circuit is configured to, within a quantum calculation period of the qubit, define a first microwave resonant frequency of the qubit with the integrated magnetic flux, and subsequently define a second microwave resonant frequency of the qubit by changing the integrated magnetic flux, wherein the first microwave resonant frequency and the second microwave resonant frequency are different.

12. The system according to claim 1, wherein the first circuit further comprises a first input port configured to receive a reference frequency signal, a second input port configured to receive a microwave resonance signal from the qubit, and a comparing circuit configured to produce a comparison output configured to control the integrated magnetic flux to selectively change the integrated magnetic flux in response to the comparison output.

13. The system according to claim 1, wherein the first circuit is further configured to receive a signal representing a calculation state of the qubit, and control the first circuit dependent on the calculation state of the qubit.

14. The system according to claim 1, wherein the at least one sequence of single-flux-quantum pulses comprises a first sequence of single-flux-quantum pulses having a first amplitude, and a second sequence of single-flux-quantum pulses having a second amplitude.

15. The system according to claim 1, further comprising a superconducting digital circuit counter comprising Josephson junctions and being configured to count single-flux-quantum pulses and to determine whether a number of single-flux-quantum pulses has reached a target value representing a target integrated magnetic flux.

16. The system according to claim 1, further comprising a comparator configured to determine a relationship of the integrated magnetic flux to a target integrated magnetic flux.

17. The system according to claim 1, wherein the first circuit is configured to implement at least one of a frequency locked loop control with a detector configured to determine a relationship between a microwave frequency associated with the qubit and a reference microwave frequency.

18. A method for controlling a qubit having a qubit energy, comprising:
generating at least one control signal dependent on at least one of an integrated magnetic flux, and a performance metric of a qubit coupled to the integrated magnetic flux; and
integrating at least one sequence of single-flux-quantum pulses into the integrated magnetic flux in a loop selectively dependent on the at least one control signal.

19. The method according to claim 18, wherein a state of a qubit is represented by a phase and an amplitude a Bloch sphere, the qubit being coupled to the integrated magnetic flux, further comprising changing the phase and amplitude of the Bloch sphere responsive to changes of the integrated magnetic flux.

20. A control system for a transmon qubit, comprising:
an inductive loop configured to integrate a series of single-flux-quantum pulses into an integrated magnetic flux;
a coupling circuit configured to couple the integrated magnetic flux with the transmon qubit;
a sensor configured to determine a resonance frequency of the transmon qubit;
a control configured to control a value of the integrated magnetic flux dependent on the sensor output.
